(19) United States
(12) Patent Application Publication
(10) Pub. No.: US 2013/0325491 A1
(43) Pub. Date: Dec. 5, 2013

(54) Therapy Tracking And Management System

(71) Applicant: Wee Talk Tracker Pro, LLC, Venice, CA (US)

(72) Inventor: Lauren Marcoccio Ferrari, Venice, CA (US)

(73) Assignee: Wee Talk Tracker Pro, LLC., Venice, CA (US)

(21) Appl. No.: 13/668,303

(22) Filed: Nov. 4, 2012

Related U.S. Application Data
(60) Provisional application No. 61/555,497, filed on Nov. 4, 2011.

(51) Int. Cl. G06Q 50/22

(52) U.S. Cl. 705/2

(57) ABSTRACT

A computer implemented method and system for tracking and managing therapy sessions using a therapy management application (TMA) is provided. The TMA is accessible by an electronic device in multiple access modes. The TMA schedules therapy sessions with multiple clients and generates one or more goals for each of the clients based on an evaluation of the clients in the therapy sessions. The TMA categorizes the generated goals for each of the clients into one or more goal categories and defines one or more goal measurements for each of the generated goals within each of the goal categories. The TMA collects and tracks data acquired from the scheduled therapy sessions of each of the clients for the defined goal measurements via a graphical user interface. The TMA generates progress reports based on performance of each of the clients for each of the generated goals using the collected and tracked data.

### CROSS REFERENCE TO RELATED APPLICATIONS

This application claims the benefit of provisional patent application No. 61/555,497 titled “Therapy Tracking And Management System”, filed on Nov. 4, 2011 in the United States Patent and Trademark Office.

The specification of the above referenced patent application is incorporated herein by reference in its entirety.

### BACKGROUND

For years, a major complaint of therapists, for example, speech-language pathologists, teachers, occupational therapists, physical therapists, behaviorists, etc., has been the large amount of paperwork needed to maintain and track data associated with the therapy of their clients to comply with state standards. Currently, the data is tracked manually, which is tedious, time consuming, and often difficult to perform accurately when a therapist or a teacher is dealing with more than one patient in a therapy session. Paperwork and old-school data tracking using a paper and a pencil costs therapists or teachers precious time, which could be better utilized in providing therapy to patients and students. These facts, combined with the increasing number of patients who qualify for special services, for example, speech and language therapy, have imposed a burden on practicing therapists such as speech-language pathologists, occupational therapists, physical therapists, teachers, etc. As a result, lawsuits against schools and therapists for practices that are not in compliance with state standards have also increased. Hence, there is a need for a computer implemented method and system that enables a therapist to easily and accurately track data associated with each patient during each therapy session and to present the tracked data to lawyers or education officials in the event of lawsuits.

Currently, therapists who provide therapy service in public schools are required to present each individual student's progress reports at annual meetings. Due to the archaic way the data associated with each student's progress during each therapy session is currently tracked, reports from the therapists are not as accurate as they could be and are subjective. Moreover, because there is no standard way of tracking the data associated with each student's progress, the reports provided by the therapists are far from standardized, which is confusing and frustrating for parents and school officials. Hence, there is a need for a computer implemented method and system that allows therapists to generate standardized progress reports.

Hence, there is a long felt but unresolved need for a computer implemented method and system that tracks and manages therapy sessions provided to multiple clients, and their associated data, and generates progress reports for each of the clients.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein address the above stated needs for tracking and managing therapy sessions provided to multiple clients, and their associated data, and generating progress reports for each of the clients. As used herein, the term “therapy” refers to a treatment of a disease or a disorder, for example, by a remedial, rehabilitating, or curative process. The computer implemented method and system disclosed herein provides a therapy management application executable by at least one processor configured to track and manage therapy sessions. The therapy management application is accessible by an electronic device, for example, a computing device such as a tablet computer, a personal computer, a mobile communication device, a laptop computer, a personal digital assistant, etc., in multiple access modes. As used herein, the term, “access modes” refers to different modes for accessing the therapy management application. The access modes for accessing the therapy management application comprise, for example, a wireless access mode, a wired access mode, an online access mode, an offline access mode, etc. The therapy management application can be accessed in an offline access mode, for example, without a connection to a network such as the internet, or in an online access mode, for example, with a connection to a network such as the internet. In an embodiment, the therapy management application is configured as a web based software application downloadable on an electronic device of an evaluator. In another embodiment, the therapy management application is configured as a web based platform, for example, a website hosted on a server or a network of servers. As used herein, the term “evaluator” refers to an individual or an entity, for example, an occupational therapist, a physical therapist, a speech language pathologist, a teacher, a behaviorist, a medical practitioner, etc., skilled or trained in the use of physical methods such as exercises, medical treatments, therapies, etc., or in psychological methods for evaluating, diagnosing, treating, rehabilitating, or counseling the sick or wounded, or for providing assistance to patients to overcome physical defects, mental disorders, psychological problems, etc. The therapy management application registers an evaluator via a graphical user interface (GUI) provided by the therapy management application.

The therapy management application schedules therapy sessions with multiple clients. As used herein, the term “client” refers to a patient, a student, a follower, a customer, an applicant, etc., who requires evaluation, professional advice, therapy, counseling, diagnosis, treatment, etc., from an evaluator such as a therapist. The therapy management application generates one or more goals for each of the clients based on an evaluation of each of the clients in the scheduled therapy sessions. As used herein, the term “goals” refers to areas of deficit for a client that the client needs to improve upon, as determined by an evaluator based on the evaluation of the client in each of the therapy sessions. The therapy management application categorizes the generated goals for each of the clients into one or more of multiple goal categories. As used herein, the term “goal categories” refers to classifications for goals to be reached by clients. In an embodiment, the therapy management application is configured to define the goal categories based on goals in a field of therapy. Furthermore, the therapy management application defines one or more goal measurements for each of the generated goals within each of the goal categories. As used herein, the term “goal measurement” refers to an item or a component that the therapy management application has chosen to measure in order to determine a client's progress towards achieving a particular goal. Moreover, the therapy management application defines multiple performance indicators for tracking the performance of each of the clients for each of the generated goals. As used herein, the term “performance indicator” refers to a key, a benchmark, a symbol, or a scale using which, the performance of a client in achieving a goal can be measured or indicated.

The therapy management application collects and tracks data acquired from the scheduled therapy sessions of each of the clients for each of the defined goal measurements via the GUI of the therapy management application. In an embodiment, the therapy management application provides one or more customization interfaces configured to acquire inputs from an evaluator, for example, for addition of one or more goal categories, addition of one or more goal measurements within the goal categories, customization of one or more performance indicators, collection of data associated with the scheduled therapy sessions, etc. The therapy management application generates progress reports based on performance of each of the clients for each of the generated goals using the collected and tracked data. The progress report is, for example, a score sheet or an evaluation report, a graphical representation, etc., that shows a client's performance in the therapy sessions with respect to the goals to be achieved. In an embodiment, the therapy management application is configured to generate the progress reports in one or more of multiple graphical representations based on time criteria. The evaluator selects the time criteria via the GUI.

The computer implemented method and system disclosed herein provides a database network in communication with the therapy management application. The database network is configured to store and dynamically update the data acquired from the scheduled therapy sessions and the generated progress reports of each of the clients for each of the generated goals based on a preconfigured time interval. The evaluator configures a time interval for the period for which the collected data is to be stored in the database network. In an embodiment, the therapy management application restores the data acquired from the scheduled therapy sessions of each of the clients for a preconfigured time interval, on receiving an indication from the evaluator via the GUI.

In an embodiment, the therapy management application selectively shares profile information of one or more clients, the generated goals of one or more clients, the collected and tracked data acquired from the scheduled therapy sessions of one or more clients for each of the defined goal measurements, and the generated progress reports of one or more clients among evaluators. In another embodiment, the therapy management application controls access to the collected and tracked data acquired from the scheduled therapy sessions of each of the clients for each of the defined goal measurements, thereby allowing members of a therapy management team to have limited access or full access to the collected and tracked data of the clients. The therapy management application securely transfers one or more of the profile information of one or more clients, the generated goals of one or more clients, the collected and tracked data acquired from the scheduled therapy sessions of one or more clients for each of the defined goal measurements, and the generated progress reports of one or more of the clients for each of the generated goals, to one or more evaluators via a network for subsequent evaluation of the clients based on transfer criteria. The therapy management application shares and transfers profile information of the clients, the generated goals, and the generated progress reports with a therapy management team of evaluators, for example, other treating therapists. In an embodiment, the therapy management application automatically synchronizes the collected and tracked data acquired from the scheduled therapy sessions of each of the clients for each of the defined goal measurements in an offline access mode, with the collected and tracked data acquired from the scheduled therapy sessions of each of the clients for each of the defined goal measurements in an online access mode.

In an embodiment, the web-based therapy management application is maintained, for example, by two secure, central database networks with advanced encryption standard (AES) 256-bit encryption, regular backups, and firewall protection, in compliance with the Health Insurance Portability and Accountability Act (HIPAA) of 1996.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for managing and tracking therapy sessions.

FIGS. 2A-2D exemplarily illustrate a logic flow diagram of options provided by a therapy management application for tracking and managing therapy sessions.

FIGS. 3A-3E exemplarily illustrate screenshots of a graphical user interface of the therapy management application for registering and logging a therapist into the therapy management application.

FIGS. 4A-4L exemplarily illustrate screenshots of a graphical user interface of the therapy management application for configuring member settings and managing a membership of a therapist.

FIGS. 5A-5H exemplarily illustrate screenshots of a graphical user interface of the therapy management application for adding clients, providing information associated with the clients, and for managing the clients.

FIGS. 6A-6S exemplarily illustrate screenshots of a calendar interface of the therapy management application for scheduling therapy sessions and enabling a therapist to record appointments with one or more clients.

FIGS. 7A-7H exemplarily illustrate screenshots of a graphical user interface of the therapy management application for acquiring data from scheduled therapy sessions of a client for goal measurements defined by the therapy management application for goals to be achieved by the client.

FIGS. 8A-8O exemplarily illustrate screenshots of a graphical user interface of the therapy management application for assigning goals, editing goals, and adding new goals based on therapy sessions scheduled and conducted for clients.

FIGS. 9A-9G exemplarily illustrate screenshots of a graphical user interface of the therapy management application, showing generation and display of progress reports.

FIGS. 10A-10L exemplarily illustrate screenshots of a graphical user interface of the therapy management application for backing up and restoring collected and tracked data acquired from scheduled therapy sessions.

FIG. 11 exemplarily illustrates a computer implemented system for managing and tracking therapy sessions.

FIG. 12 exemplarily illustrates the architecture of a computer system employed by the therapy management application for managing and tracking therapy sessions.

### DETAILED DESCRIPTION OF THE INVENTION

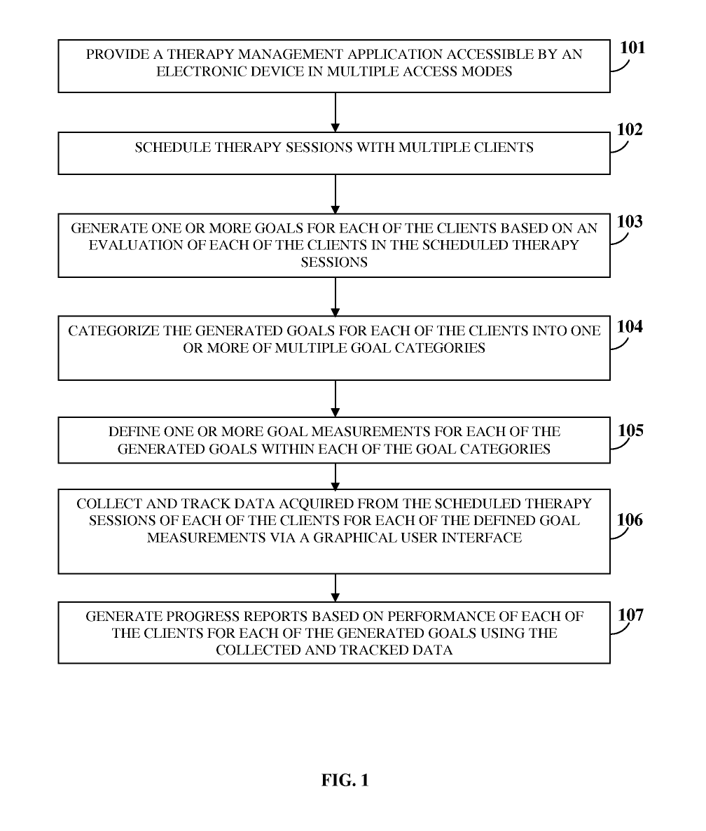

FIG. 1 illustrates a computer implemented method for managing and tracking therapy sessions. The therapy session is, for example, an individual therapy session, a group therapy session, etc., where an evaluator meets with clients who require therapy, for example, speech therapy. As used herein, the term “evaluator” refers to an individual or an entity, for example, an occupational therapist, a physical therapist, a speech language pathologist, a teacher, a behaviorist, a medical practitioner, etc., skilled or trained in the use of physical methods such as exercises, medical treatments, therapies, etc., or in psychological methods for evaluating, diagnosing, treating, rehabilitating, or counseling the sick or wounded, or for providing assistance to patients to overcome physical defects, mental disorders, psychological problems, etc. Also, as used herein, the term “therapy” refers to a treatment of a disease or a disorder, for example, by a remedial, rehabilitating, or curative process.

The computer implemented method disclosed herein provides 101 a therapy management application executable by at least one processor configured to track and manage therapy sessions. The therapy management application is accessible by an electronic device, for example, a computing device such as a tablet computing device such as the iPhone®, the iPad®, etc., of Apple Inc., a laptop computer, a personal computer, a personal digital assistant, a communication device, a mobile medical device, a handheld device, other portable and non-portable communication devices, etc., a personal computer, a mobile communication device, etc., in multiple access modes. As used herein, the term “access modes” refers to different modes for accessing the therapy management application. The access modes for accessing the therapy management application comprise, for example, a wireless access mode, a wired access mode, an online access mode, an offline access mode, etc.

The therapy management application can be accessed in an offline access mode, for example, without a connection to a network such as the internet, or in an online access mode, for example, with a connection to a network such as the internet. In an example, if an evaluator such as a therapist is using a web based therapy management application on a tablet computing device such as the iPad®, the therapist can utilize the therapy management application in an offline access mode, for example, without a network connection such as an internet connection and automatically synchronize the data from the scheduled therapy sessions that is collected and tracked by the therapy management application when the therapist gains access to an internet connection or WiFi® of the Wireless Ethernet Compatibility Alliance, Inc. The therapy management application can be synchronized with any electronic device. The therapy management application is accessible, for example, through a wide spectrum of technologies and devices such as general packet radio service (GPRS), third generation (3G), fourth generation (4G), or other internet enabled cellular phones and tablet computing devices, computers with connection to the internet or other networks, etc.

In an embodiment, the therapy management application is configured as a web based software application downloadable on an electronic device of an evaluator. In another embodiment, the therapy management application is configured as a web based platform, for example, a website hosted on a server or a network of servers. The evaluator is, for example, a therapist or a speech-language pathologist who assesses, diagnoses, treats, and helps prevent disorders related to speech, language, cognitive-communication, voice, swallowing, fluency, etc., or a teacher. In an embodiment, the therapy management application registers the evaluator via a graphical user interface (GUI) provided by the therapy management application.

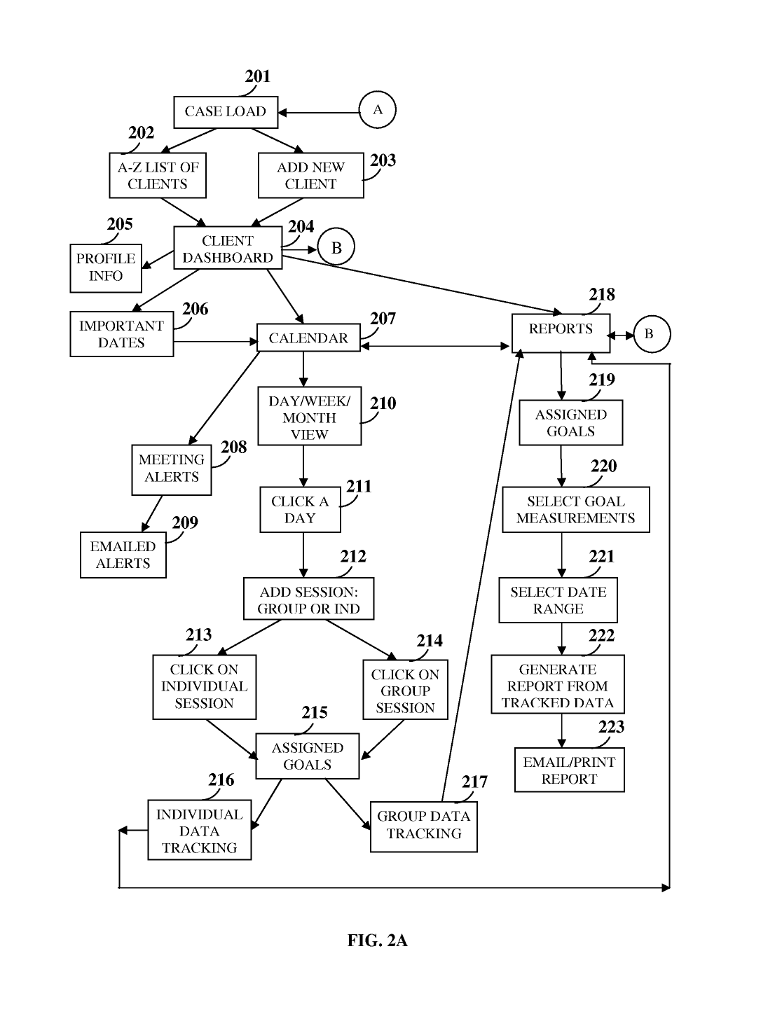

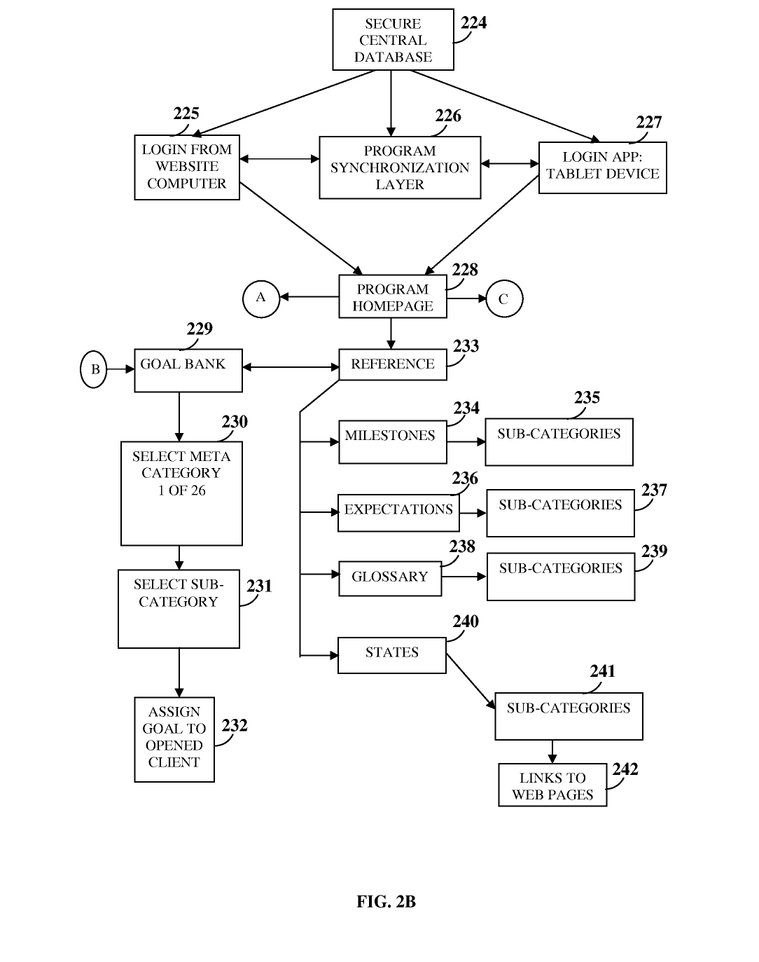

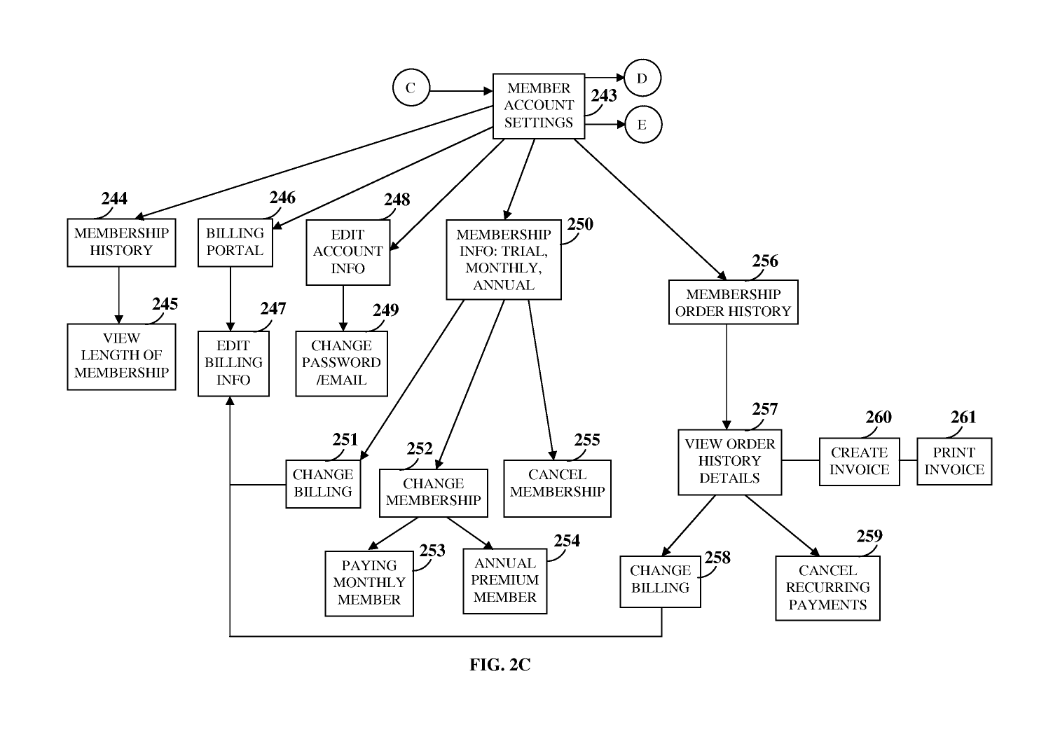

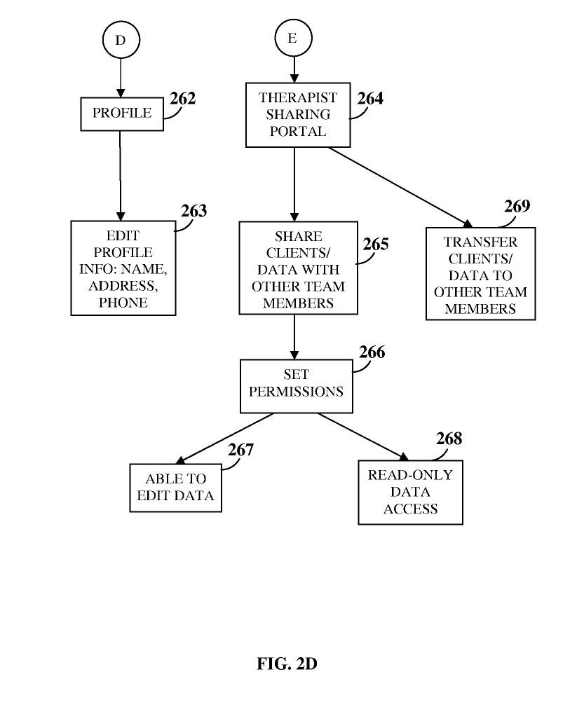

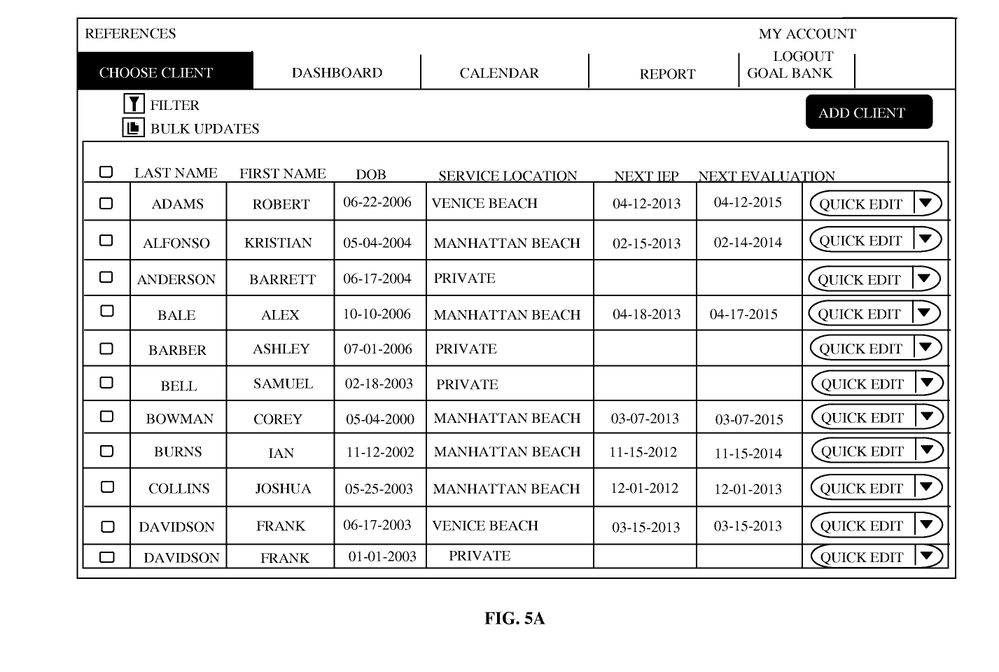

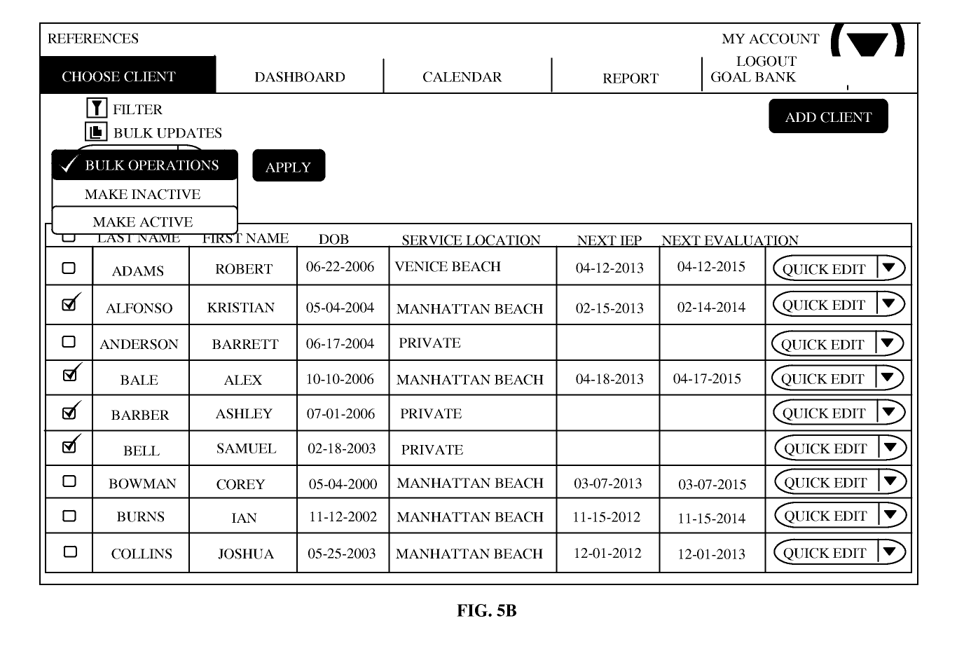

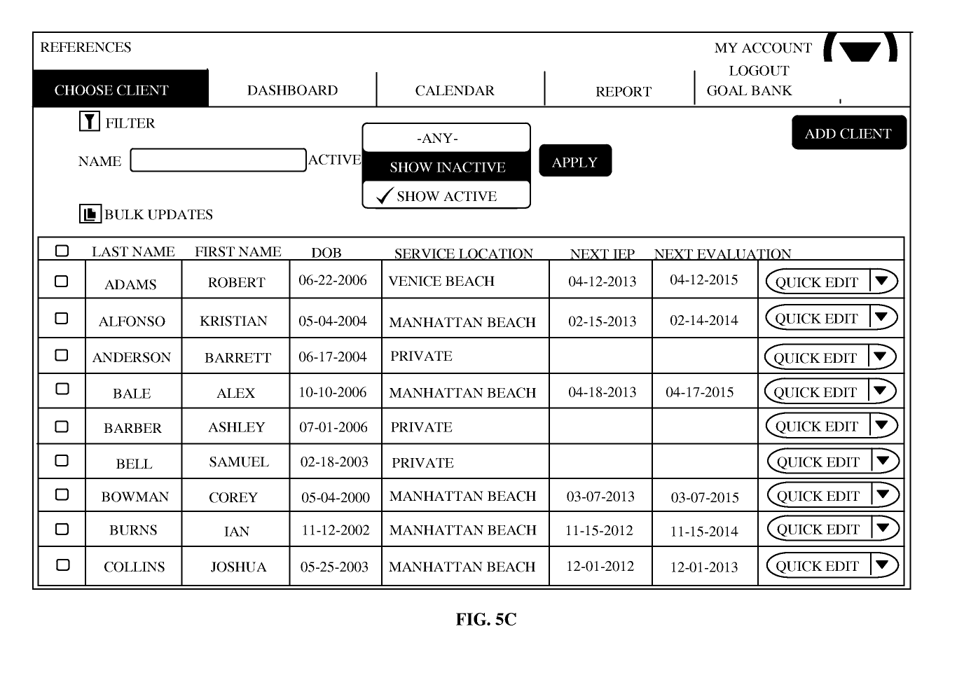

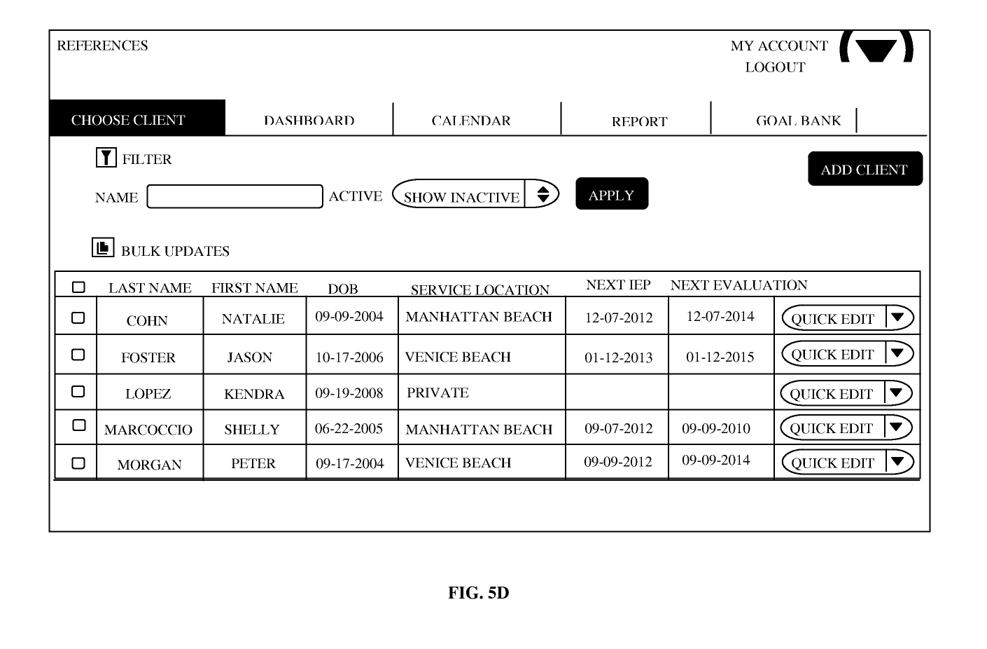

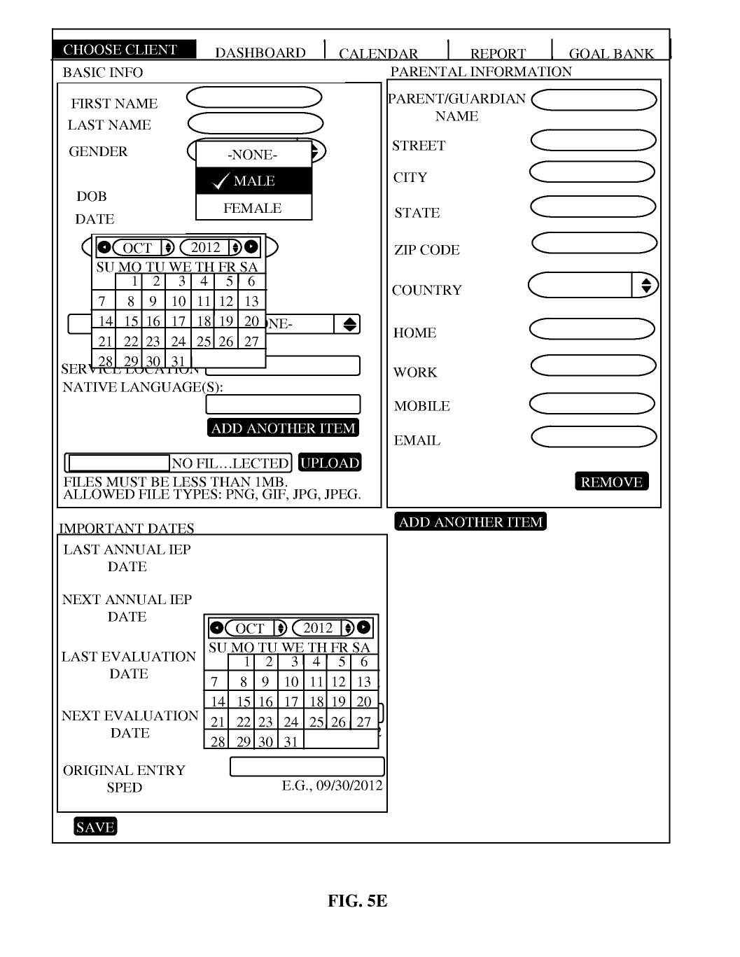

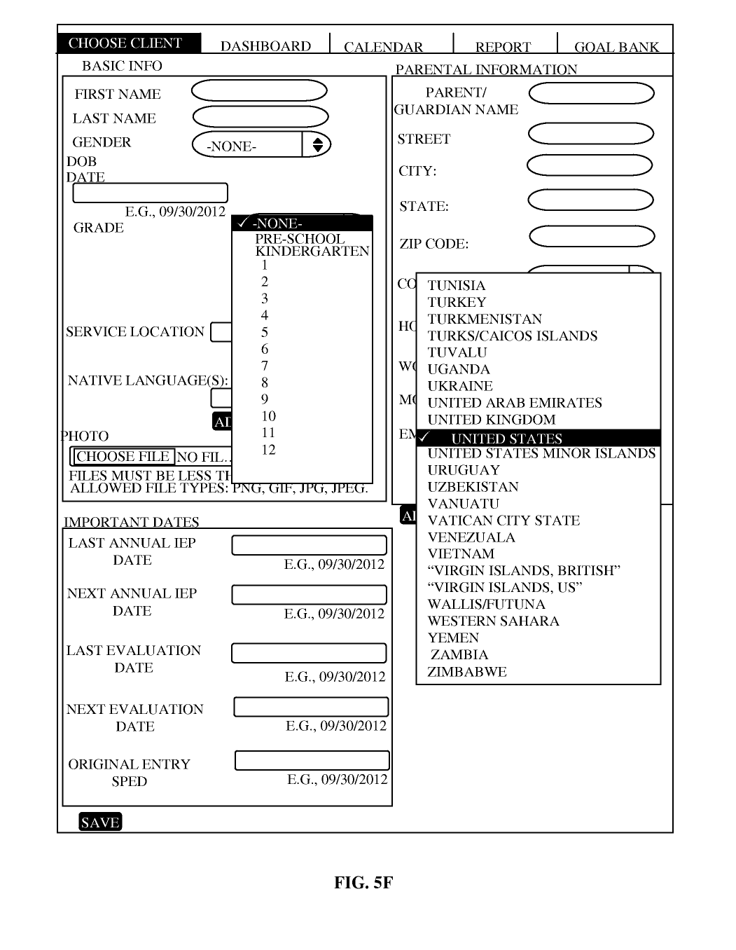

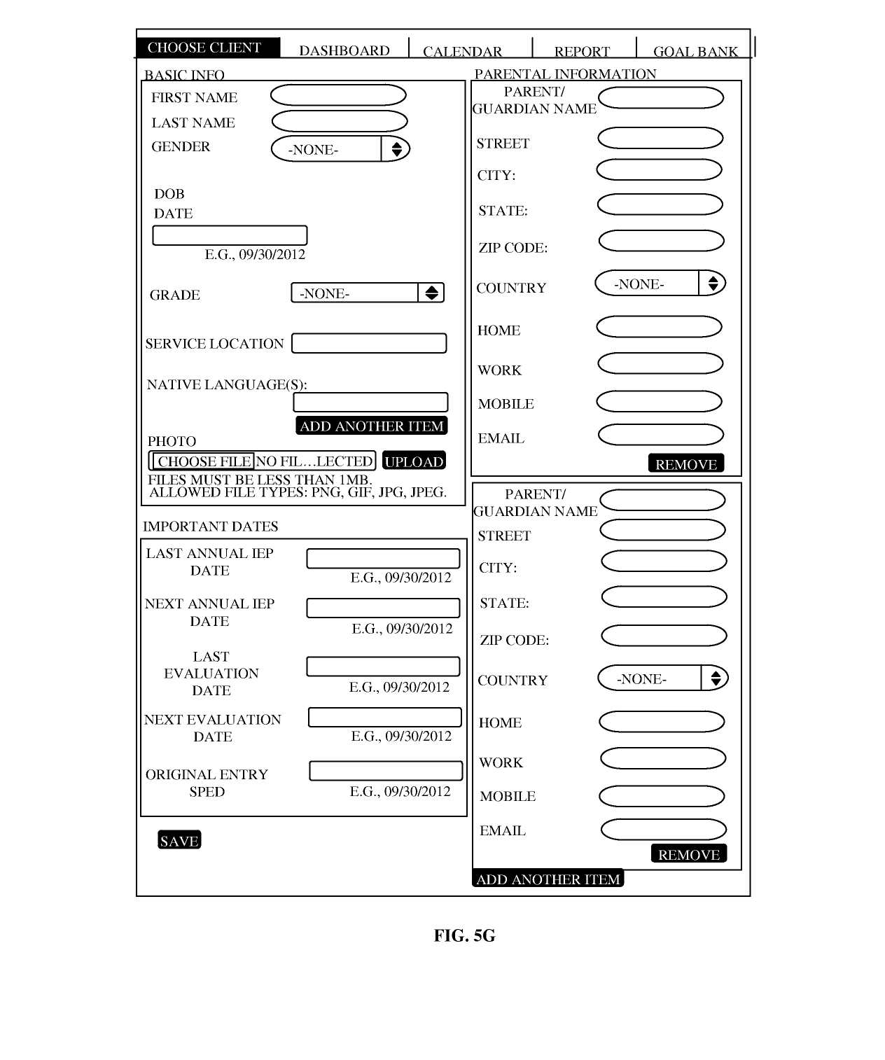

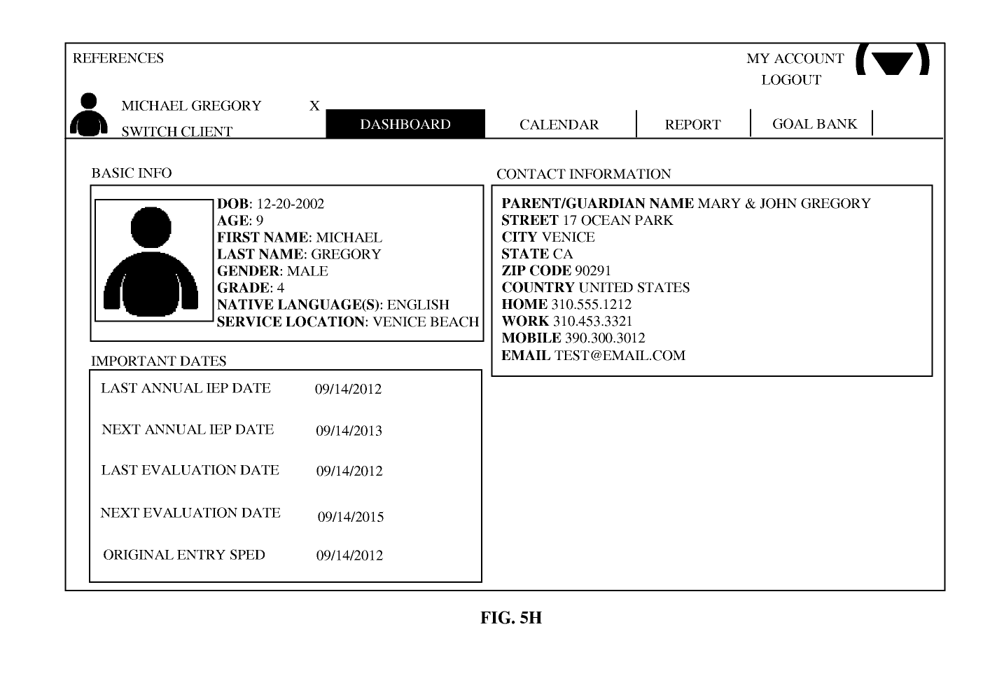

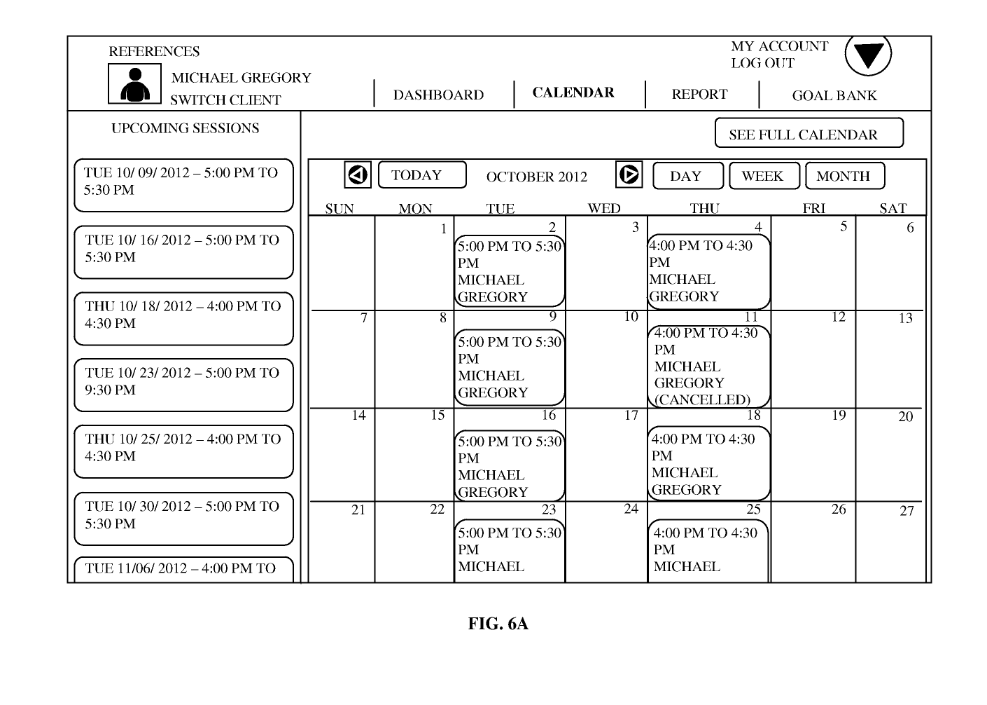

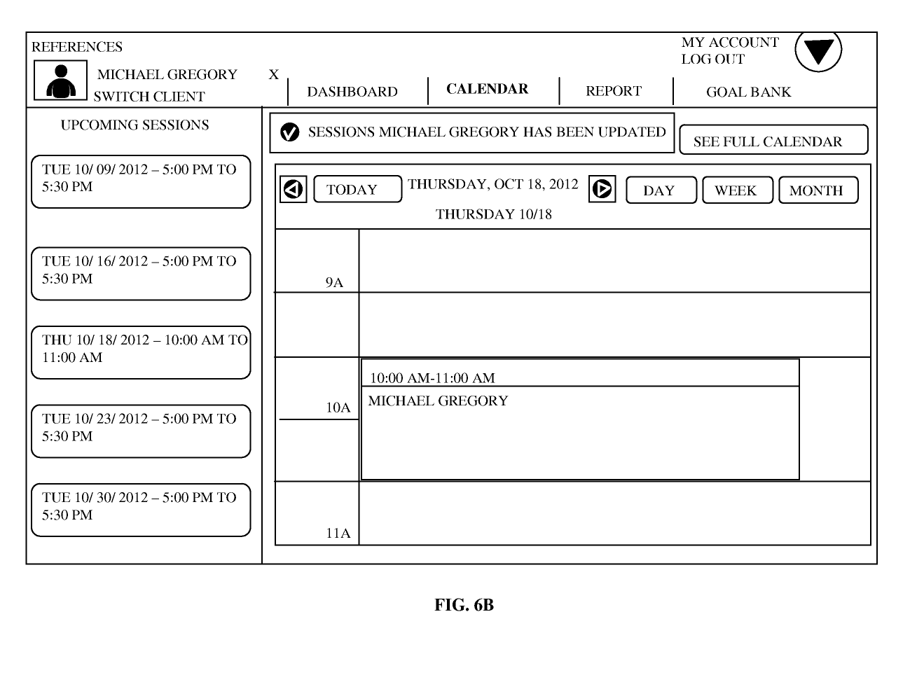

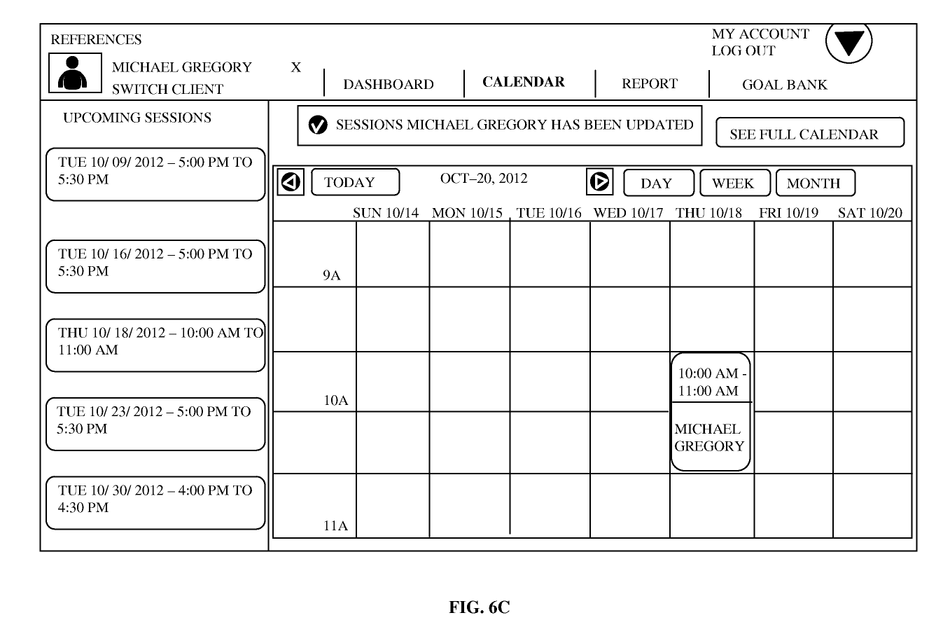

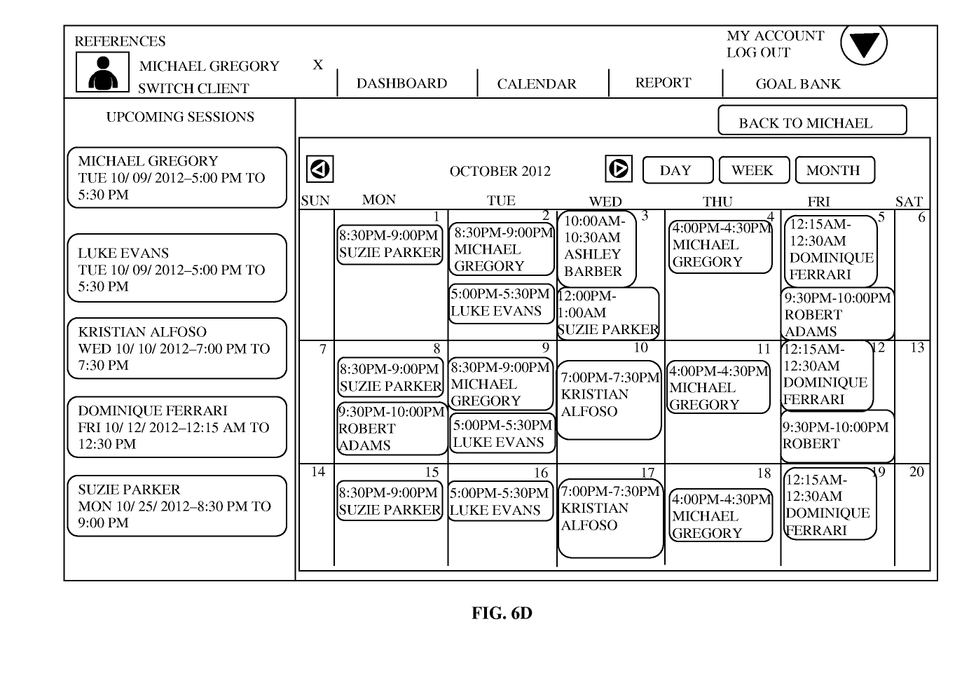

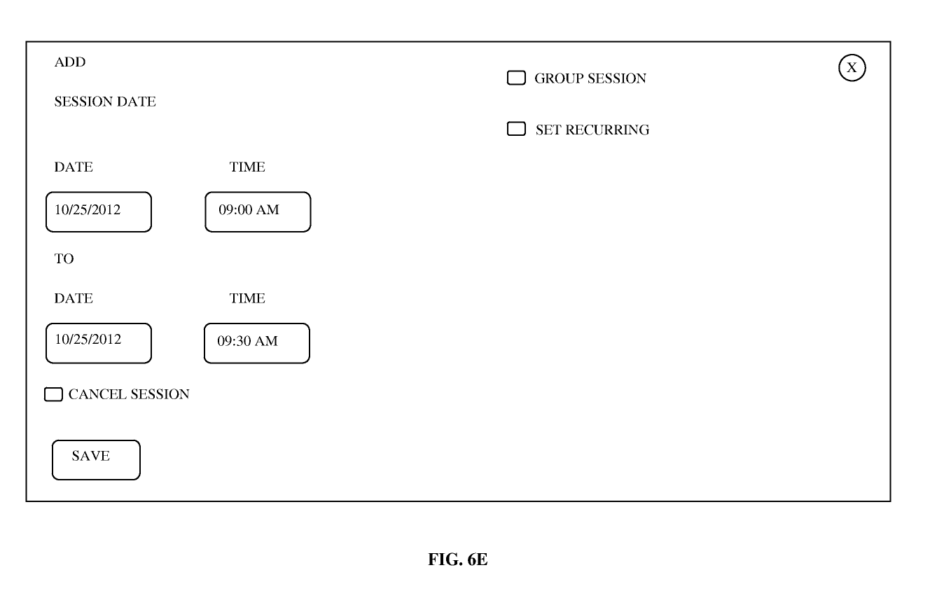

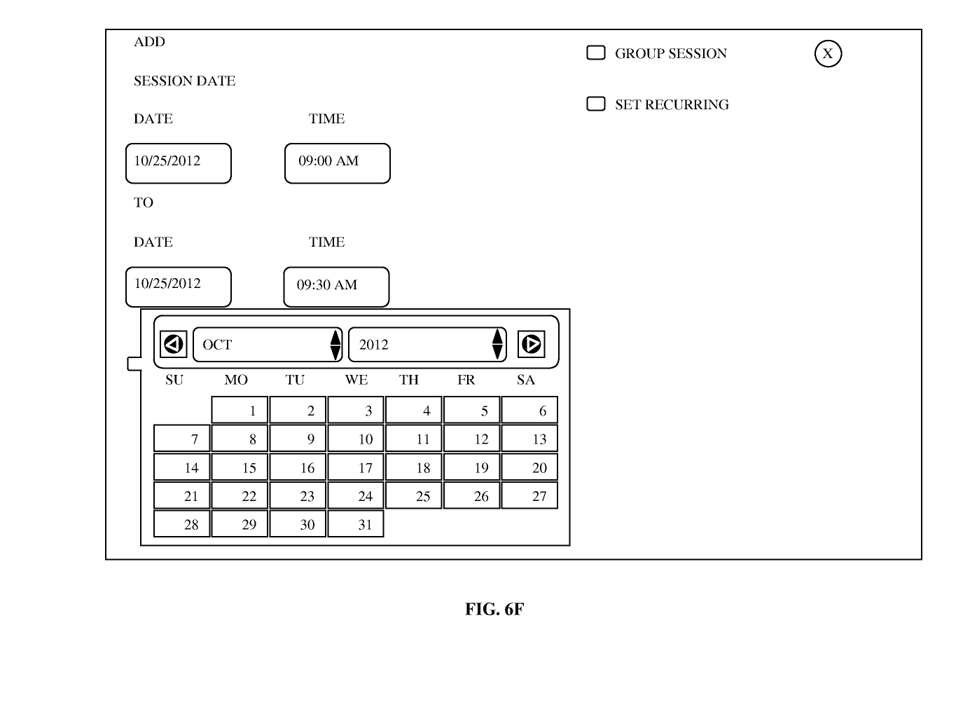

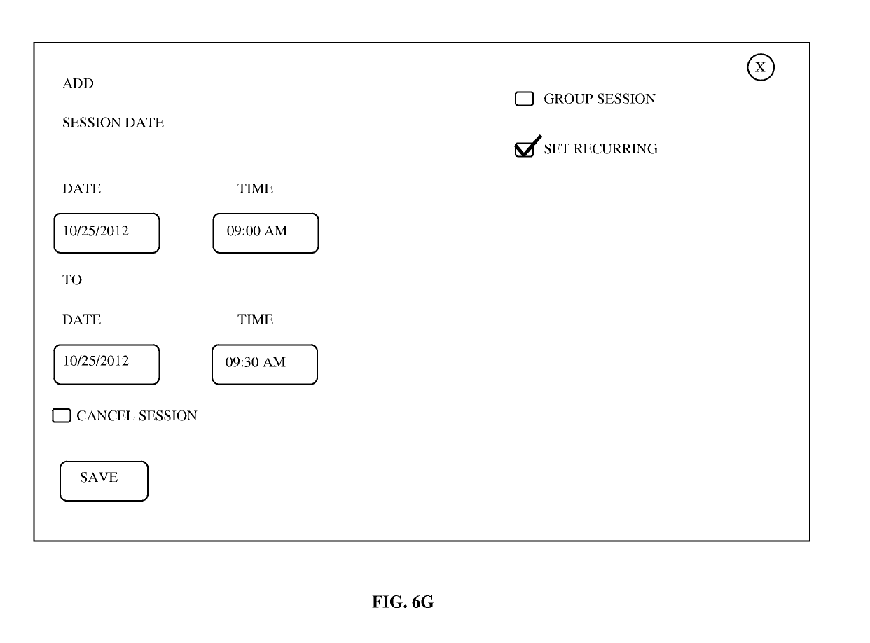

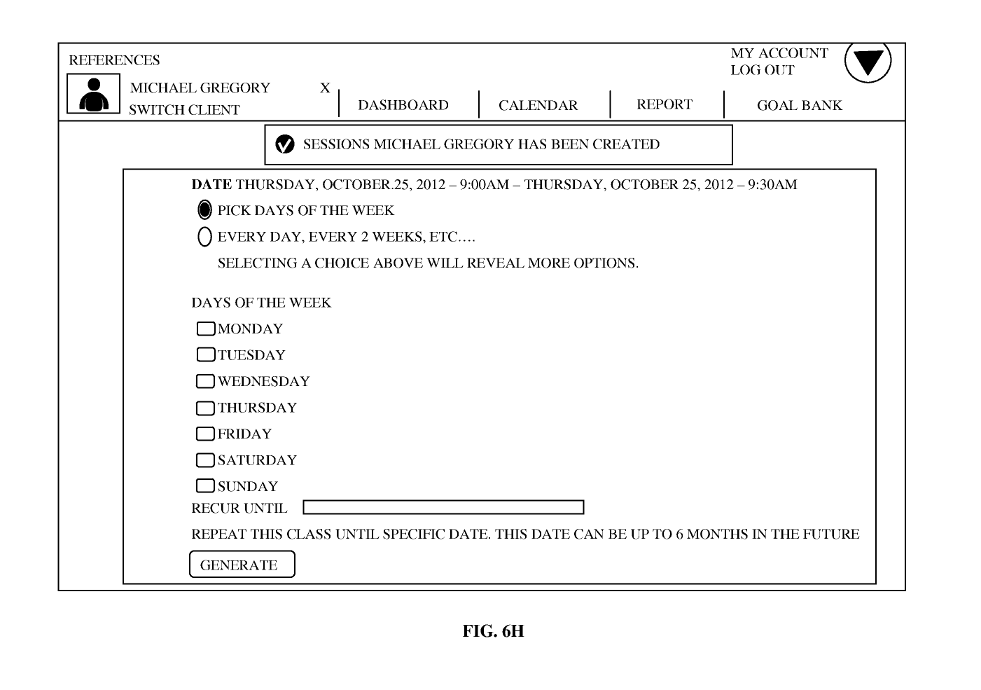

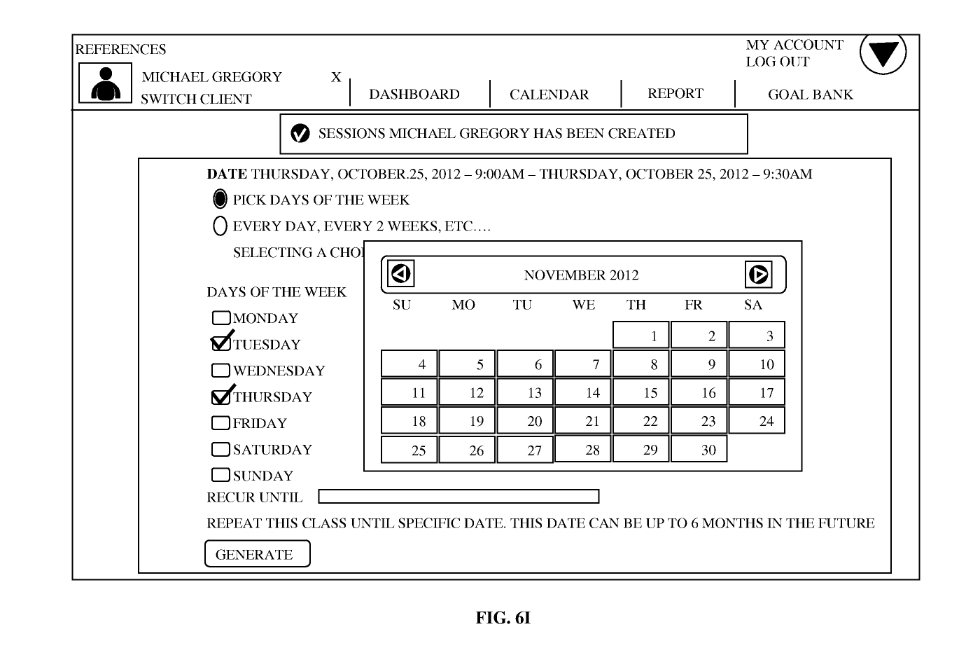

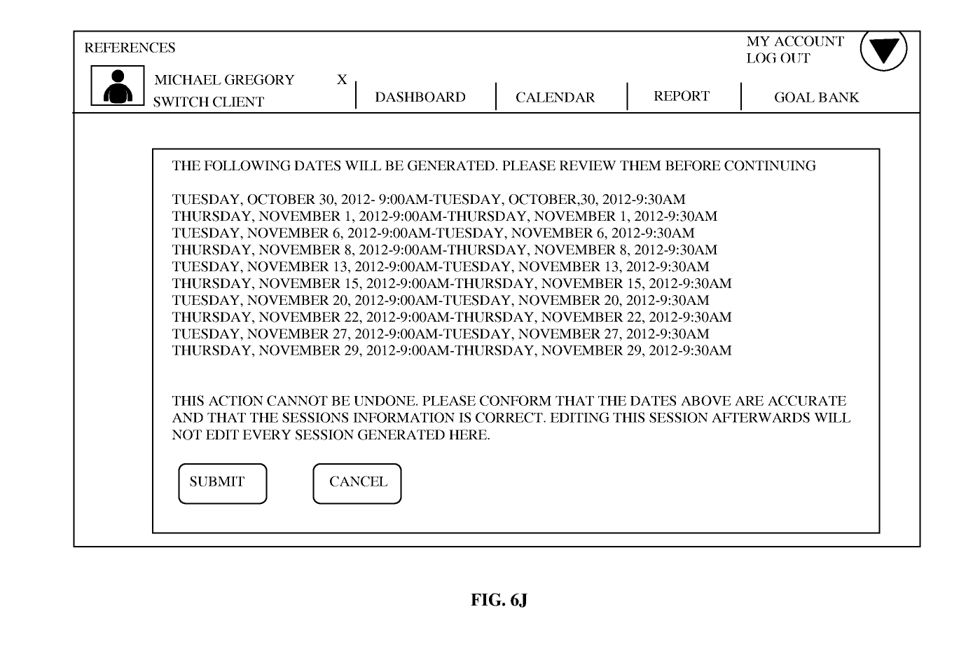

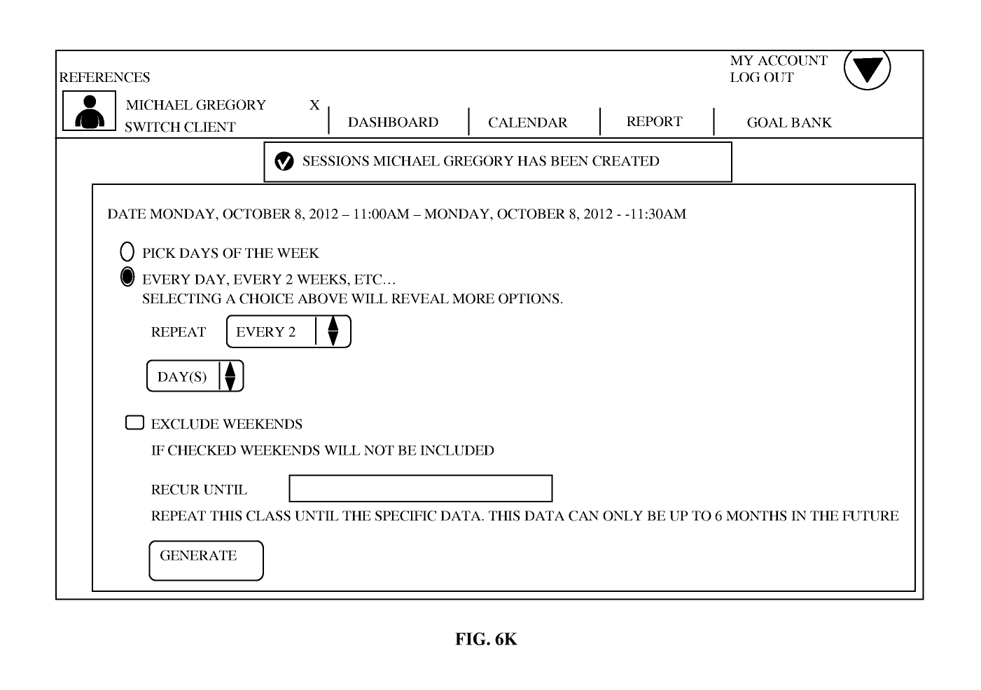

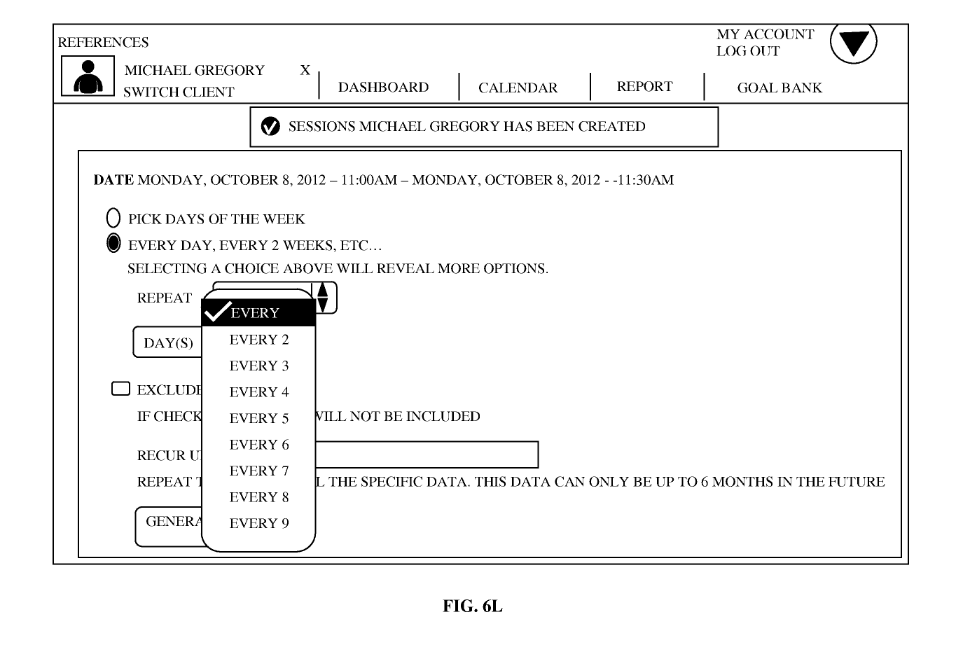

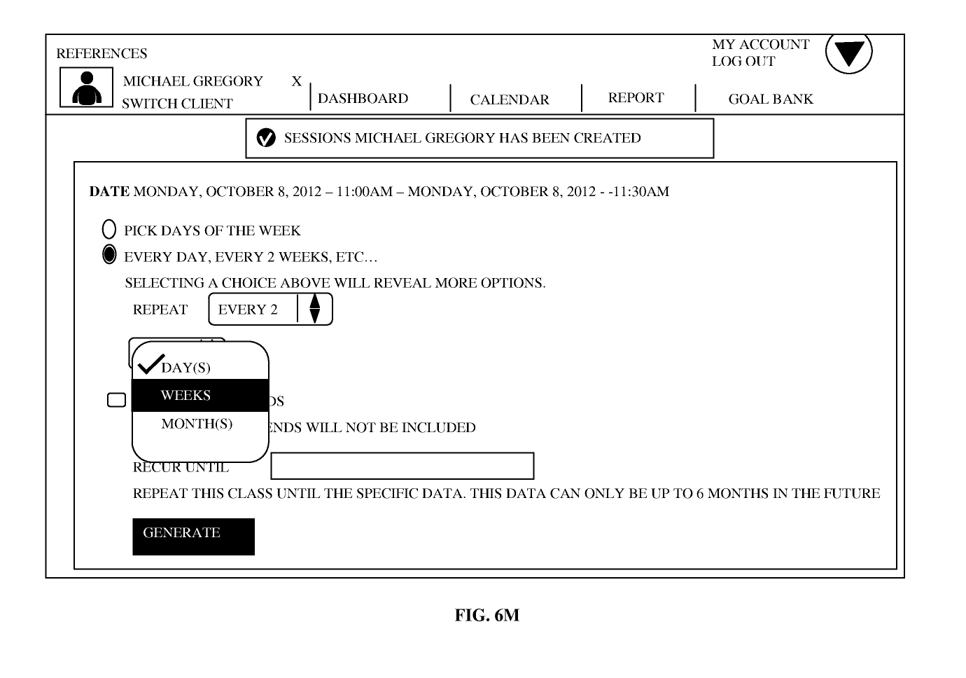

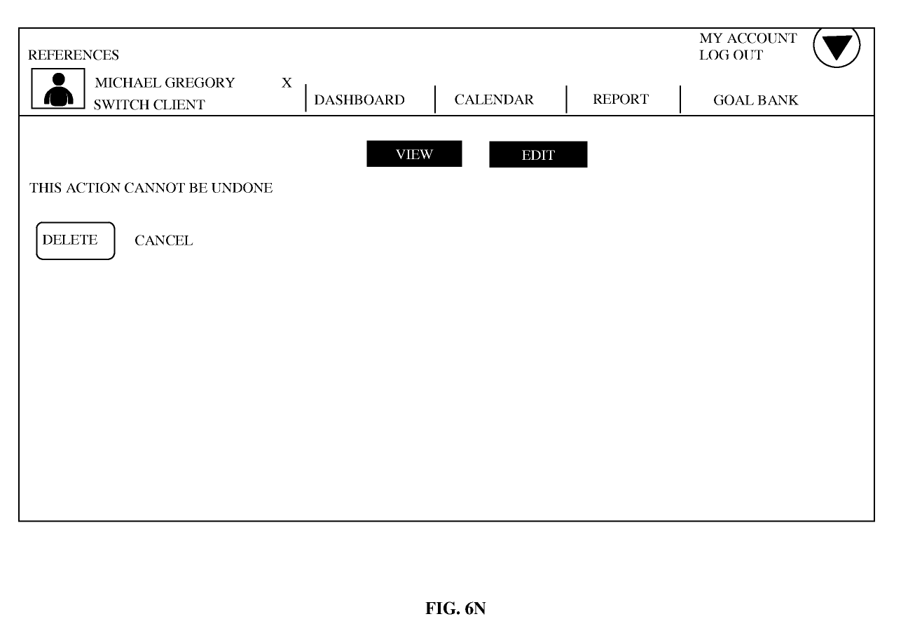

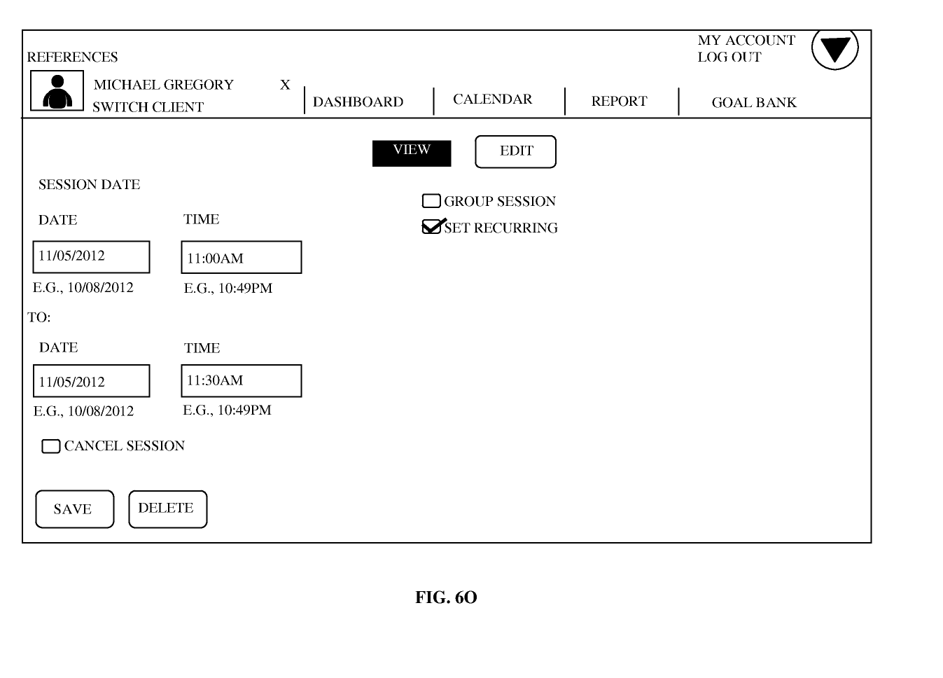

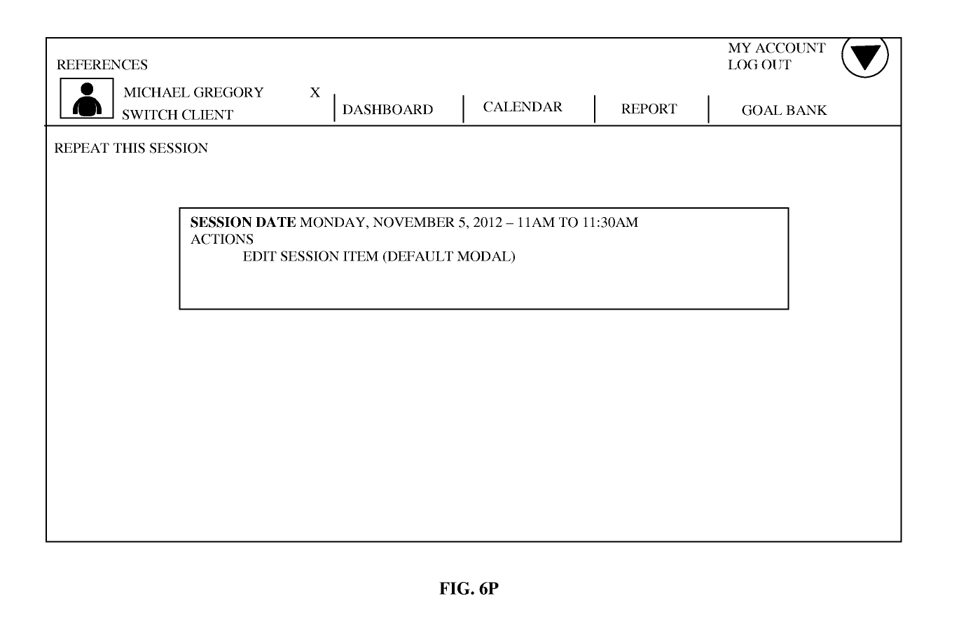

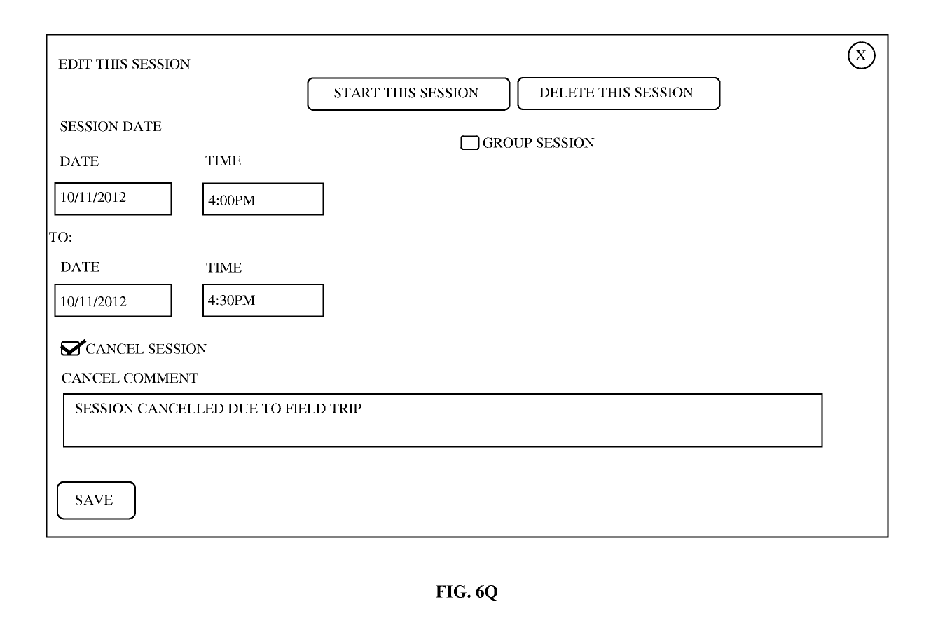

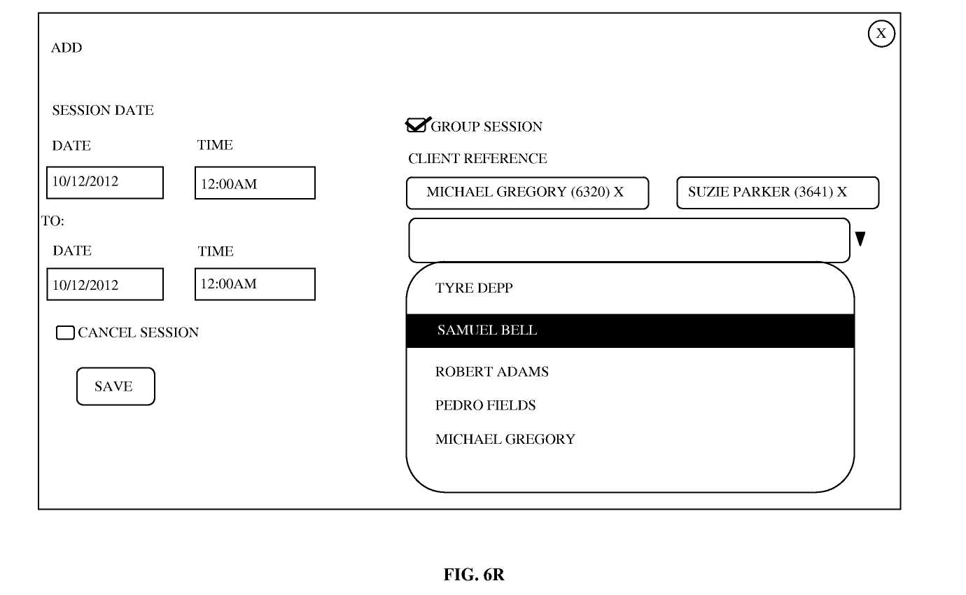

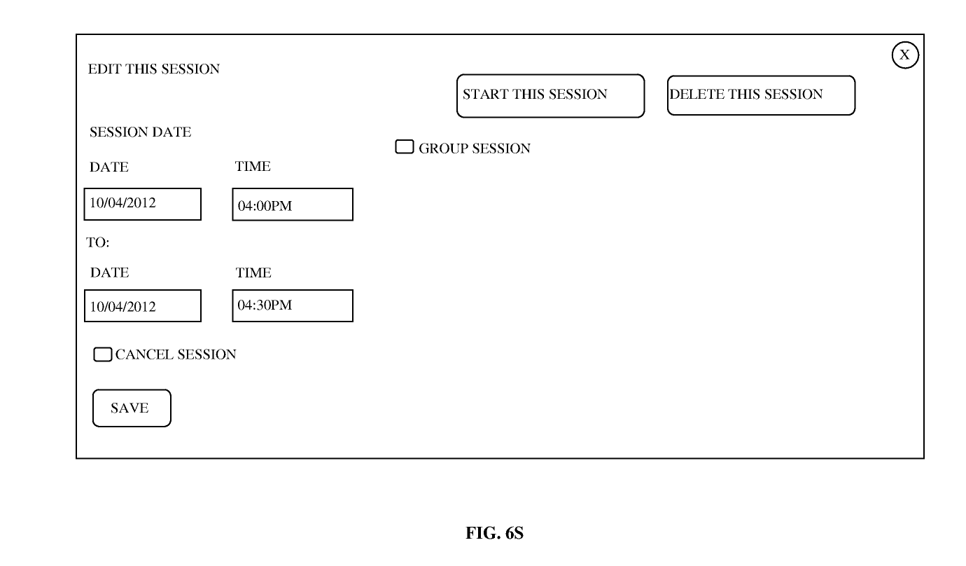

On registration, the therapy management application enables the evaluator to schedule therapy sessions for clients, define goals for the clients, define goal measurements, and track progress of the clients in achieving the goals during the scheduled therapy sessions. The therapy management application schedules 102 therapy sessions with multiple clients as disclosed in the detailed description of FIGS. 2A-2D and FIGS. 6A-6S. As used herein, the term “client” refers, for example, to a patient, a student, a follower, a customer, an applicant, etc., who requires evaluation, professional advice, diagnosis, therapy, treatment, counseling, etc., from an evaluator such as a therapist. For purposes of illustration, the detailed description refers to a therapist as an evaluator; however the scope of the computer implemented method and system disclosed herein is not limited to an evaluator that is, the therapist but may be extended to include any evaluator, for example, a speech language pathologist, a teacher, an occupational therapist, a physical therapist, a behaviorist, a medical practitioner, etc., who is skilled to provide therapy, treatment, counseling, etc. The therapy management application manages the therapist's appointments with multiple clients and creates schedules for individual therapy sessions and group therapy sessions. In an embodiment, the therapy management application enables the therapist to create a client profile for each client as disclosed in the detailed description of FIGS. 5A-5H. In an embodiment, the therapy management application displays multiple client profiles at once for group therapy sessions on the GUI.

On initiation of a therapy session with a client, the therapist assesses one or more deficient areas of the client. On determining the client's deficient areas, the therapist sets one or more goals for the client to help the client make gains in the deficient areas using the therapy management application. Goals are typically technical in nature and must be written in a specific and measurable format to keep the goals standardized and transferable, as required by a state law and healthcare policy. These goals comprise wording that is tedious and typically costs an average therapist significant time to write manually. An example of a goal written according to state standards is: “By October 2012, John Smith will increase overall intelligibility by producing /s/ sounds at the conversational speech level, in 4 out of 5 trials, with 80% accuracy with moderate cues, during structured activities, as measured by the therapist data collection”. The therapy management application generates 103 one or more goals for each of the clients based on an evaluation of each of the clients performed by the therapist in the scheduled therapy sessions. As used herein, the term “goals” refers to areas of deficit for a client that the client needs to improve upon, as determined by an evaluator based on the evaluation of the client in each of the therapy sessions. The goal is a purpose of an action, for example, the aim of undergoing therapy. The generated goals comprise common goals which are accepted, standard goals commonly assigned to clients by therapists. The therapy management application provides access to a large library of goals that can be assigned by the therapist to a client and customized based on the therapist's evaluation of the client in each of the therapy sessions.

The therapy management application allows the therapist to customize pre-formatted goals, for example, by plugging in variables or by selecting specific measurements from popup menus displayed on the GUI of the therapy management application, to generate individual goals written in accordance with the state standards for the clients. An example of a pre-formatted goal provided by the therapy management application is: “By [Date], [Name] will increase overall intelligibility by producing [Target sounds] at [Context] in [Minimum] out of [Maximum] trials, with [Accuracy %], with [Level of Cues], during [Setting] activities, as measured by the therapist data collection.” The therapist customizes the pre-formatted goals for each client by entering unique values, for example, date, name, target sounds, context, number of trials, percentage accuracy, level of cues needed, etc., in the pre-formatted goals displayed on the GUI of the therapy management application. The therapy management application then enables the therapist to assign the goals to the clients. In an embodiment, the therapy management application enables therapists to define their own goals that can be customized for each client. If a therapist is not satisfied with the library of pre-formatted goals and benchmarks provided, the therapy management application allows the therapist to create his/her own custom goals and benchmarks. An example of a custom goal template generated by the therapy management application is: “By [Date], [Name] [FREE TEXT FIELD].”

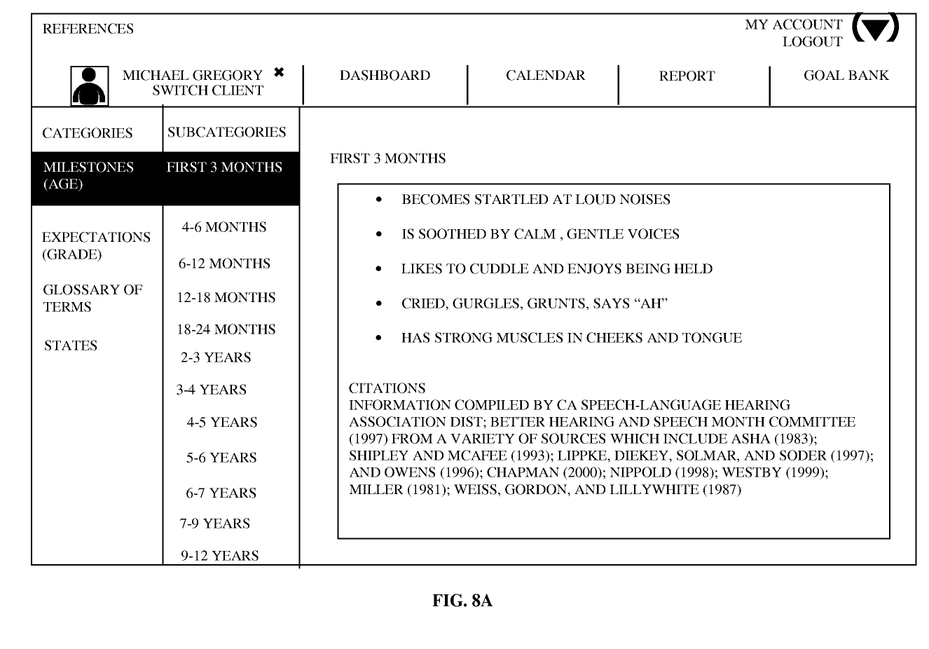

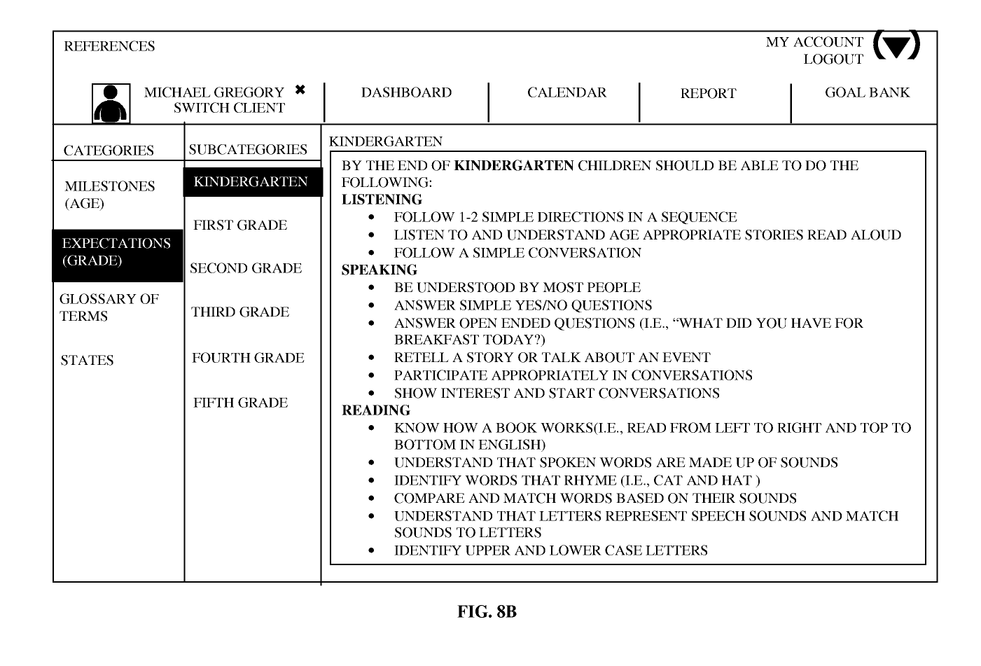

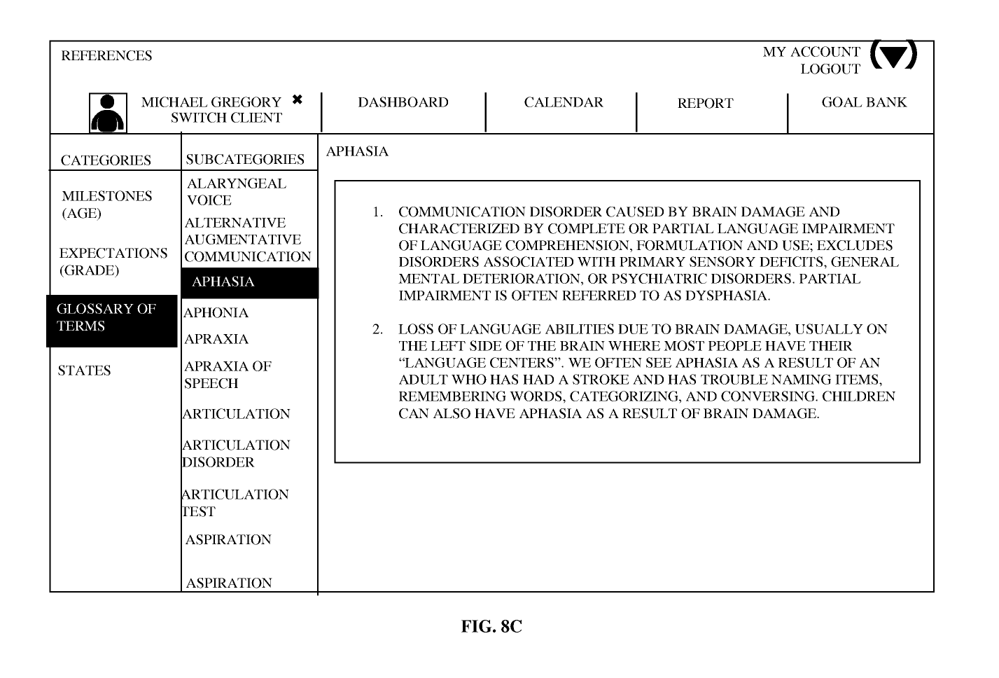

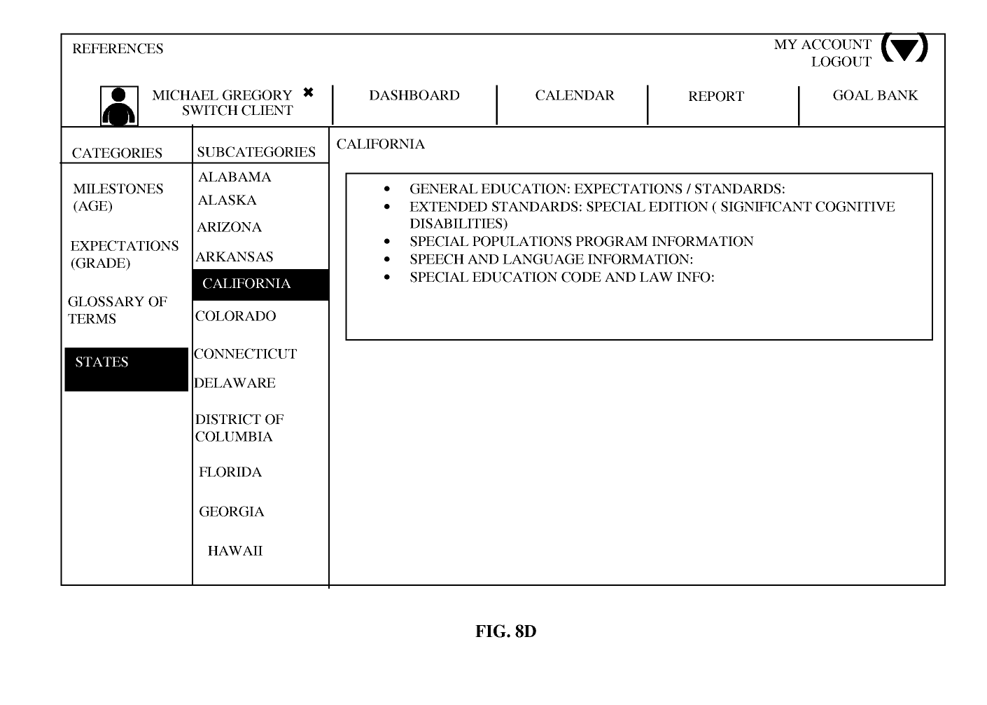

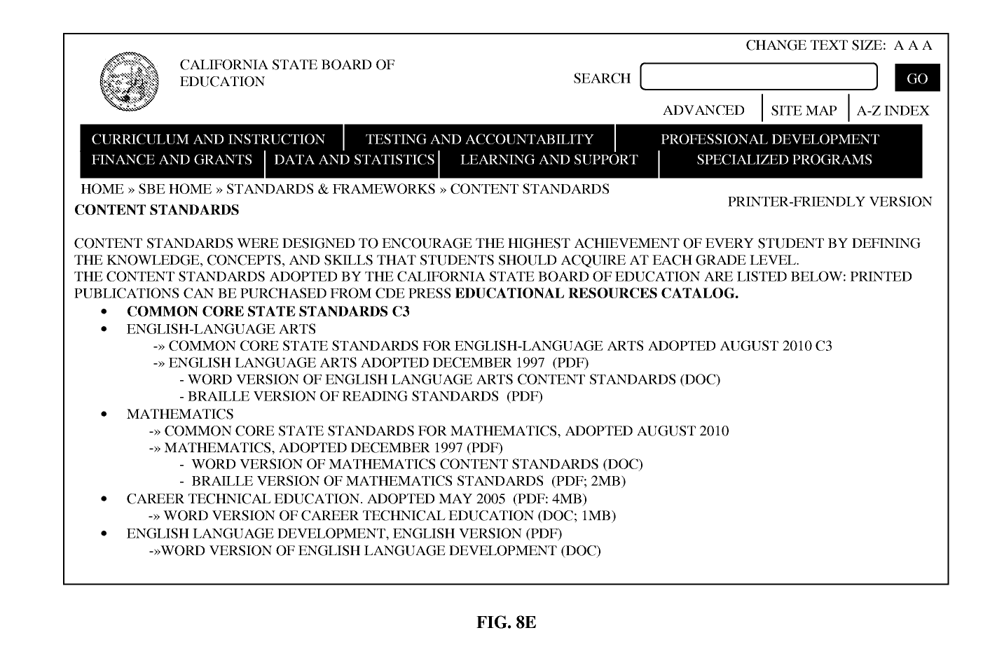

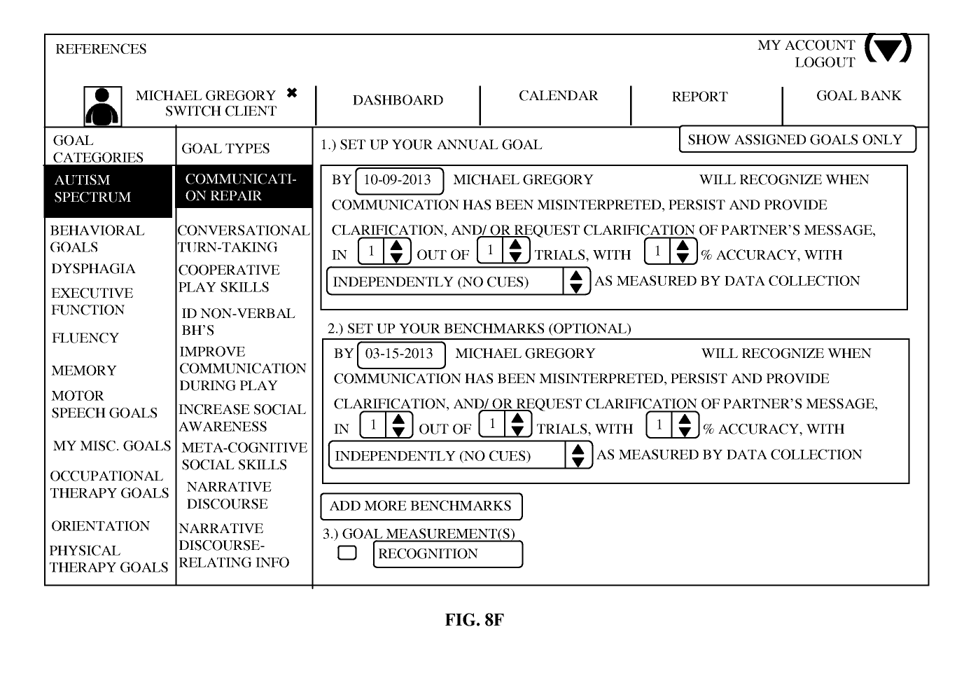

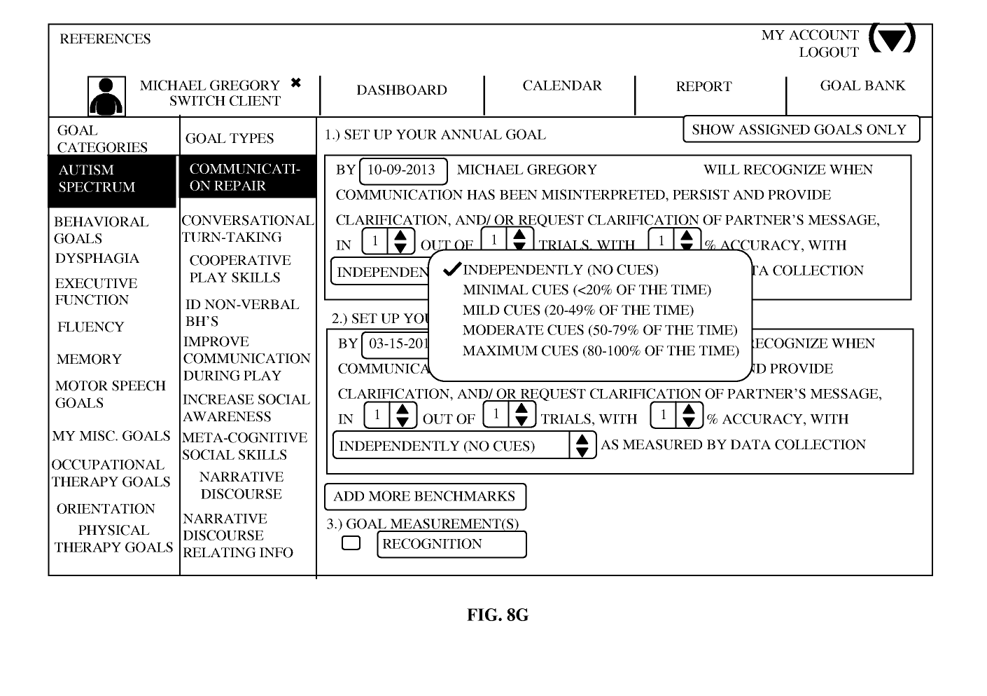

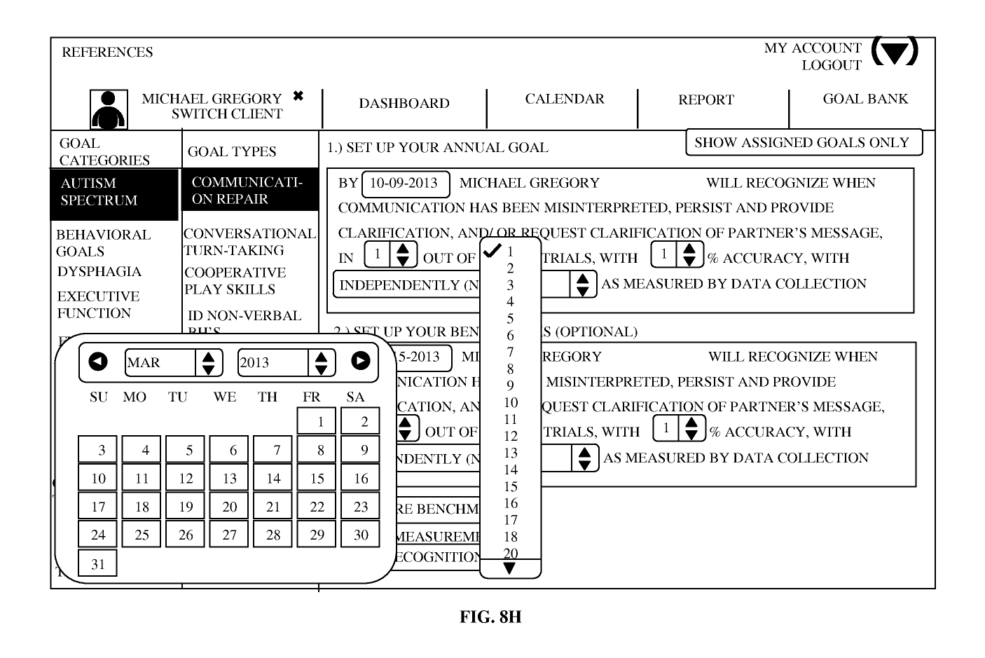

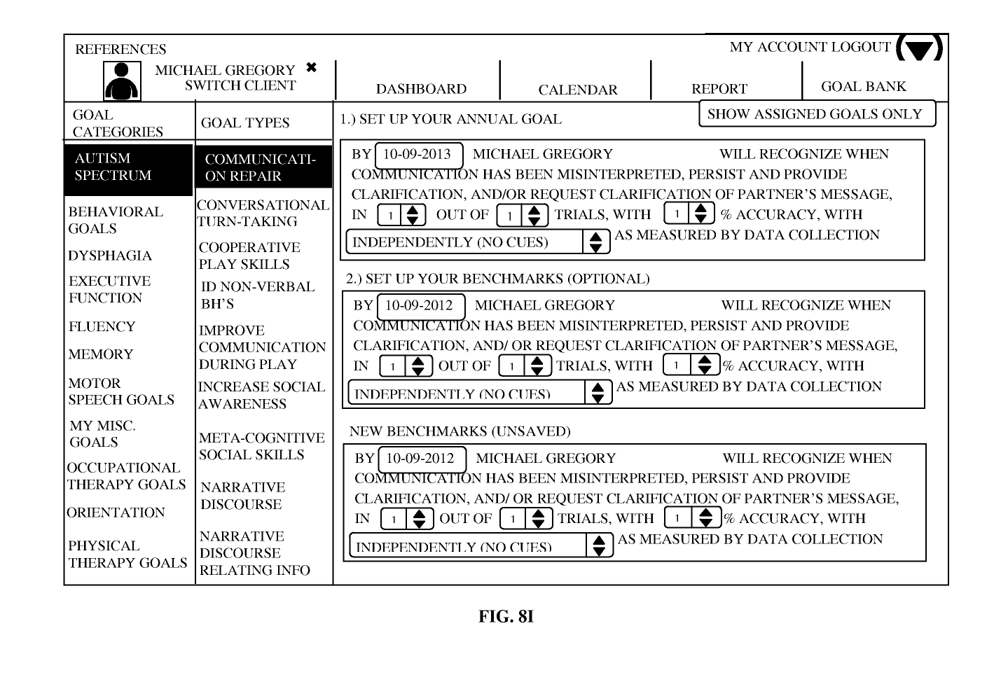

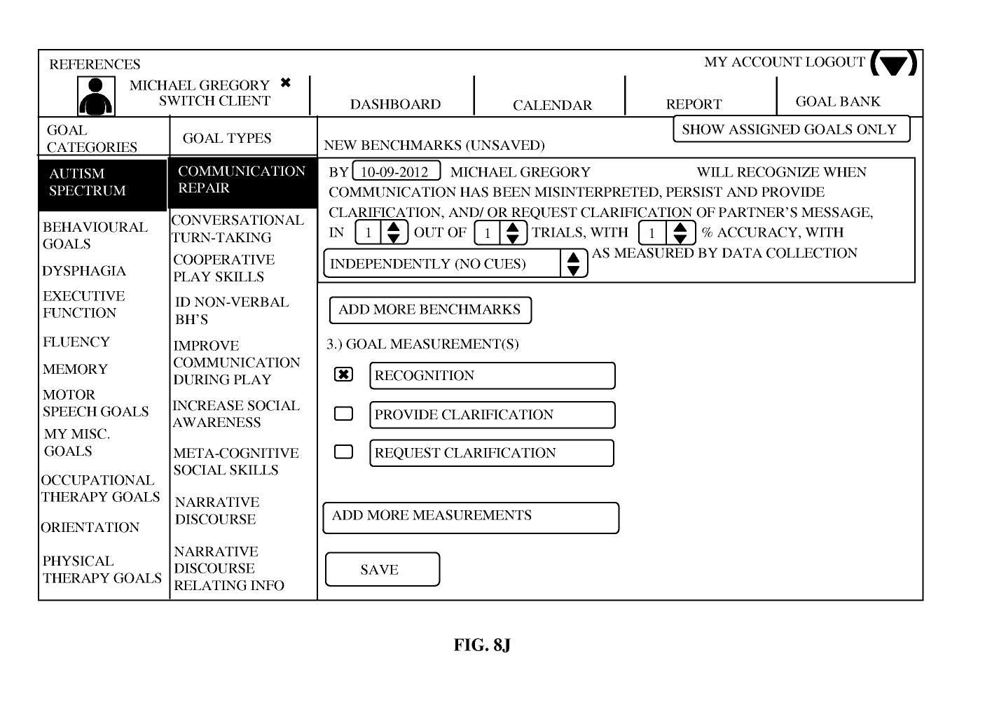

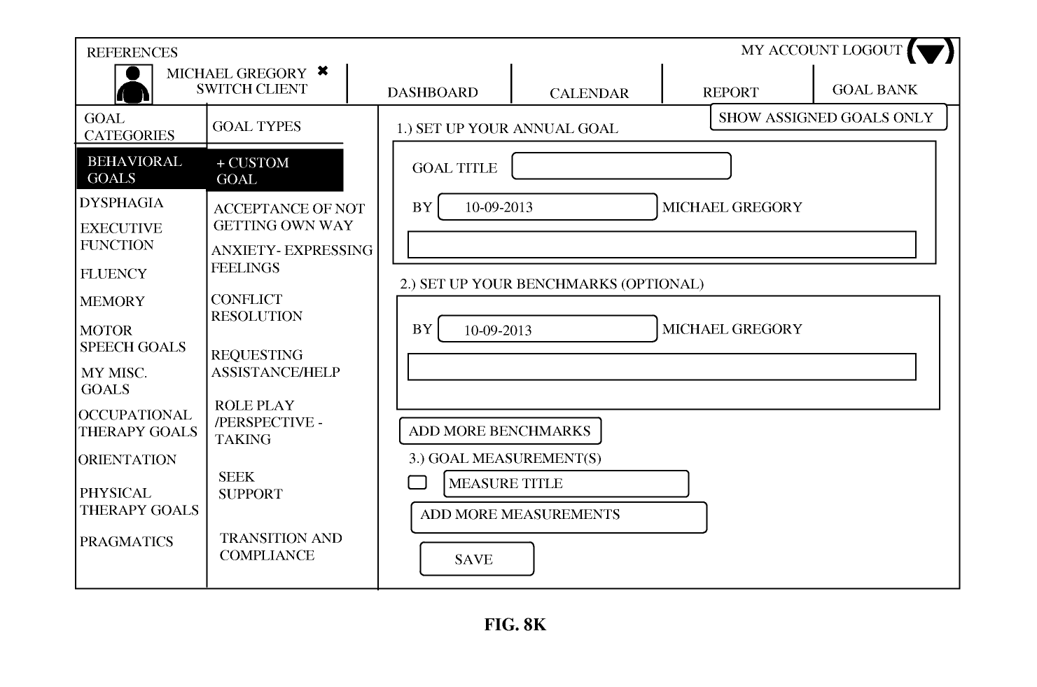

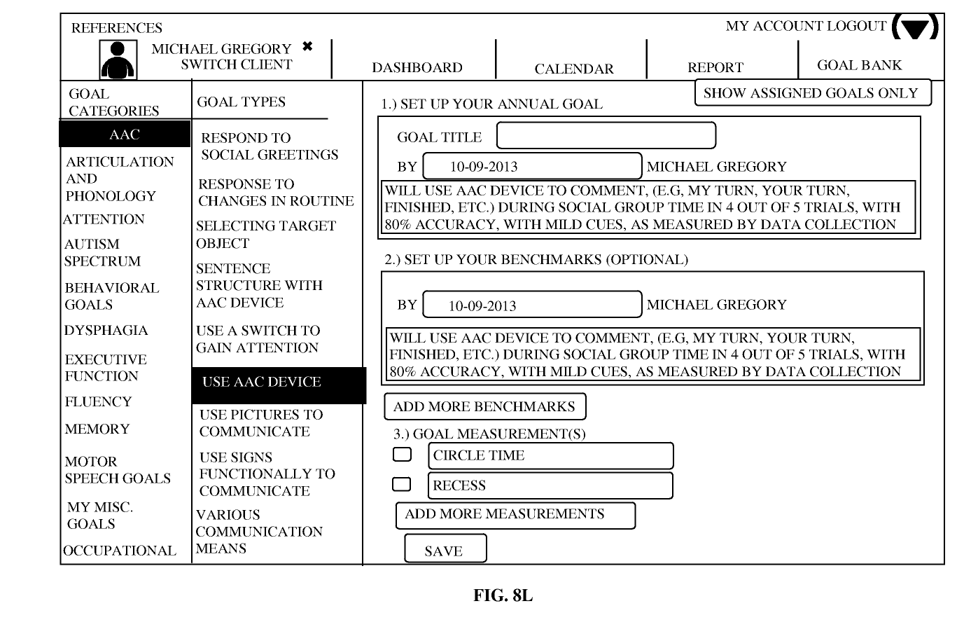

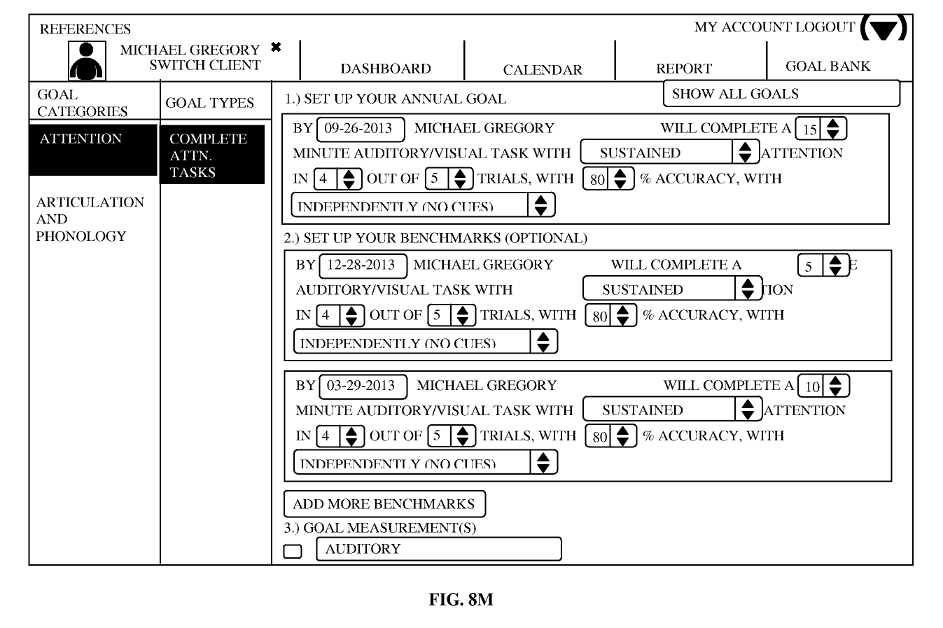

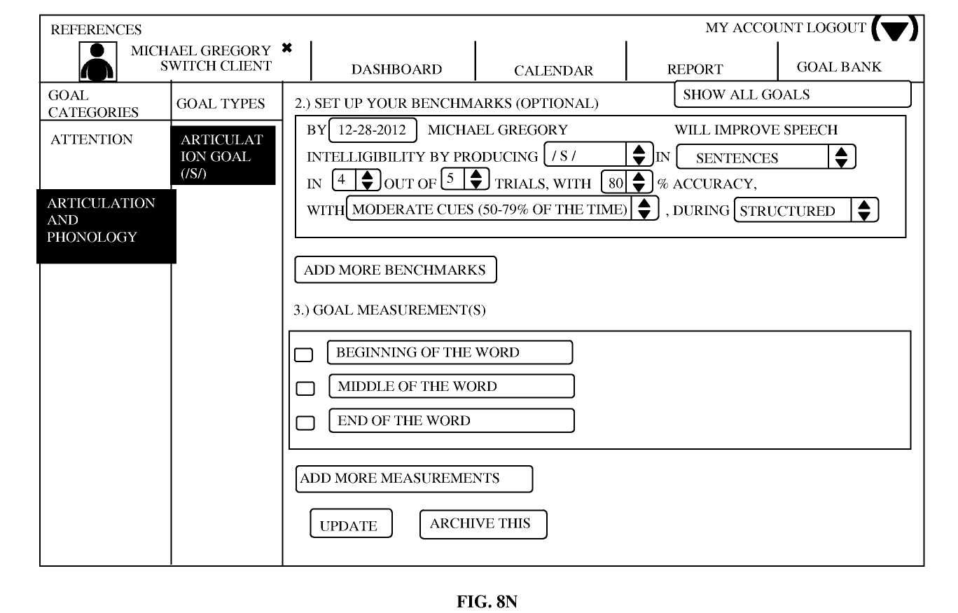

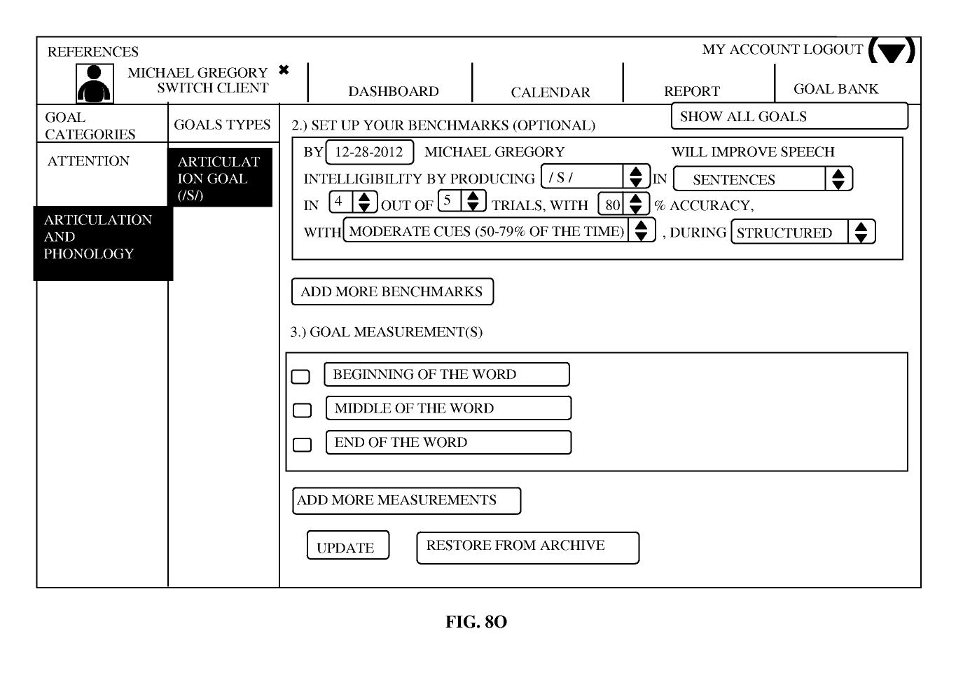

The therapy management application categorizes 104 the generated goals for each of the clients into one or more of multiple goal categories as exemplarily illustrated in FIGS. 8F-8O. As used herein, the term “goal categories” refers to classifications for goals to be reached by clients. In an embodiment, the therapy management application is configured to define the goal categories based on goals in a field of therapy. In an example, the therapy management application categorizes and organizes goals associated with speech and language therapy, occupational therapy, physical therapy, behavioral therapy, special education, etc., into twenty six goal categories commonly used in the field of speech and language therapy. The goal categories comprise meta-categories. The meta-categories are, for example, articulation and phonology, syntax and morphology, semantics, pragmatics, fluency, voice, preschool goals: expressive, preschool goals: receptive, attention, autism spectrum, orientation, dysphagia, problem solving, reading, motor speech, memory, occupational therapy, physical therapy, behavioral therapy, augmentative and alternative communication (AAC), executive function, social emotional, special education, etc. The therapy management application further provides sub-categories for each of the meta-categories. For example, if a meta-category is “semantics”, then “increasing vocabulary” is a sub-category within the area of semantics. The therapy management application organizes a multitude of goals, broken down by category, to allow the therapist to easily select and assign the goals to a client for tracking.

Furthermore, the therapy management application defines 105 one or more goal measurements for each of the generated goals within each of one or more goal categories. As used herein, the term “goal measurement” refers to an item or a component that the therapy management application has chosen to measure in order to determine a client's progress towards achieving a particular goal. Within each of the sub-categories, the therapy management application provides an infinite number of choices for goal measurements that the therapist can choose to track. In an example, the therapist may select the meta-category as “semantics”; the sub-category as “use new vocabulary words”; and the goal measurements as “body parts”, “household objects”, “animals”, “foods”, etc. The therapist tracks data based on the goal measurements to determine how the client is progressing within a given goal using the therapy management application. The therapy management application pre-populates each meta-category with the appropriate goal measurements for ready usage by the therapist. In an embodiment, the therapy management application enables the therapist to add new goal measurements and delete undesired goal measurements. The therapist can add a goal measurement to a goal type or sub-category by clicking on an “add more measurements” button provided, for example, on a “Goal Bank” interface on the GUI of the therapy management application as exemplarily illustrated in FIGS. 8J-8O.

The therapy management application collects and tracks 106 data acquired from the scheduled therapy sessions of each of the clients for each of the defined goal measurements via the GUI of the therapy management application. Once the goals are generated, categorized, and assigned to different clients of the therapist, the therapy management application initiates tracking of the data each of the goal measurements defined for each goal as the clients attempt to make progress in their areas of deficiency. In an embodiment, the therapy management application defines multiple performance indicators for tracking performance of each of the clients for each of the assigned goals. As used herein, the term “performance indicator” refers to a key, a benchmark, a symbol, or a scale using which, the performance of a client in achieving a goal can be measured or indicated. The performance indicators comprise, for example:

### +=Correct

### −=Incorrect

### M=Modeling

### G=Gestural Prompt/Cue

### O=Oral or Verbal Prompt/Cue

### V=Visual Prompt/Cue

### P=Physical Prompt/Cue

### NR=No Response

−M=Incorrect with Model
−G=Incorrect with Gesture
−O=Incorrect with Oral/Verbal Cue
−V=Incorrect with Visual Cue
−P=Incorrect with Physical Cue

The therapist may use these performance indicators in shorthand, that is, in an abbreviated symbolic writing method that increases speed or brevity of writing as compared to a normal method of writing a language via the GUI. The therapy management application also allows evaluators, for example, therapists, teachers, etc., to create their own performance indicators for tracking performance of each of the clients for each of the assigned goals. Instead of using a binary system, in which there are only two choices, namely, “correct” and “incorrect” presented to the therapist, the therapy management application creates a more nuanced and effective tracking system, for example, with about thirteen performance indicators. Success in education, especially in special education, cannot be viewed in black and white terms of “correct” and “incorrect”. The therapy management application therefore provides a more nuanced tracking system that allows the therapist to accurately determine how a client is progressing and helps the therapist to hone in on the specific kind of support the client needs if the client is not meeting the assigned goals independently. In an embodiment, as the therapist works with and evaluates the clients during the therapy sessions, the therapy management application collects and tracks the data from the therapy sessions and securely stores the tracked data and caseload information on a secure, central database network with advanced encryption standard (AES) 256-bit encryption, regular backups, and firewall protection, in compliance with the Health Insurance Portability and Accountability Act (HIPAA) of 1996, thereby allowing the therapist to track the progress of the clients over days, weeks, months and even years. In an embodiment, the therapy management application categorizes the collected and tracked data using the performance indicators.

In an embodiment, the therapy management application automatically places the goals into a chart system on generation and assignment of the goals for a client by the therapist. The chart system allows the therapist to begin tracking data for all the goals assigned to the therapist's clients. The chart system is user friendly and allows the therapist to easily and quickly track data in individual therapy sessions and group therapy sessions. Furthermore, in an embodiment, the therapy management application provides one or more customization interfaces configured to acquire inputs from an evaluator, for example, for addition of one or more goal categories, addition of one or more goal measurements within the goal categories, customization of one or more performance indicators, collection of data associated with the scheduled therapy sessions, etc.

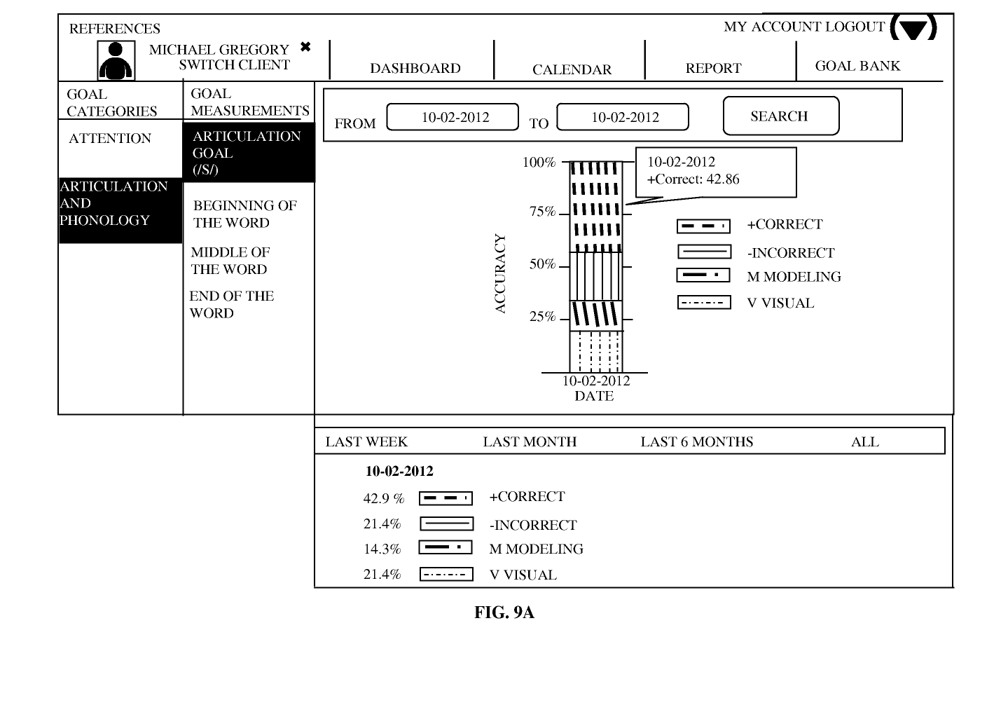

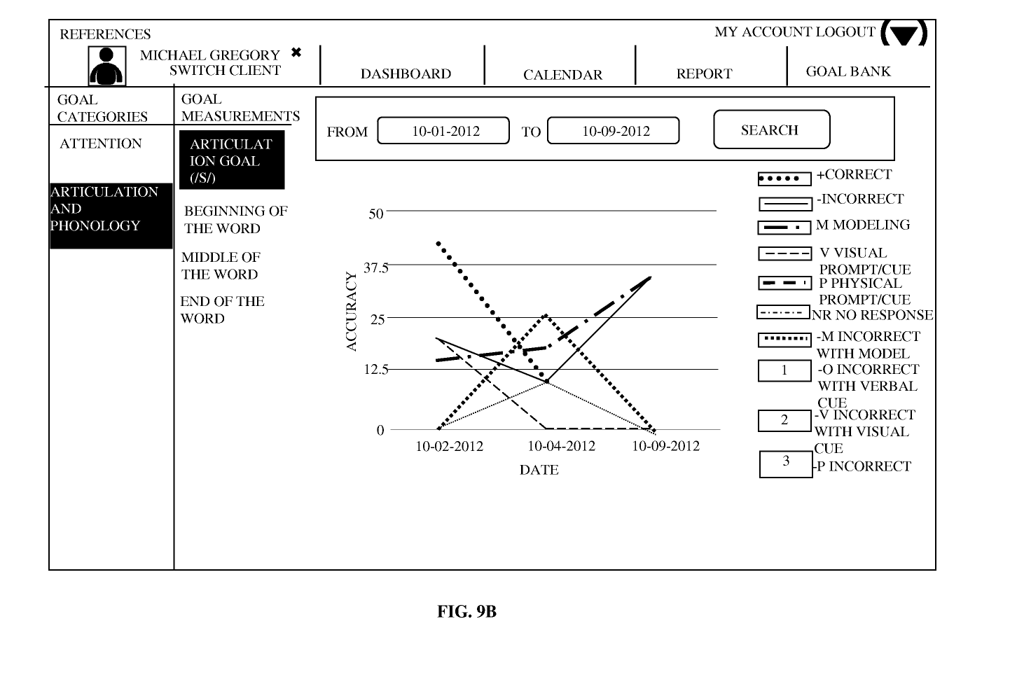

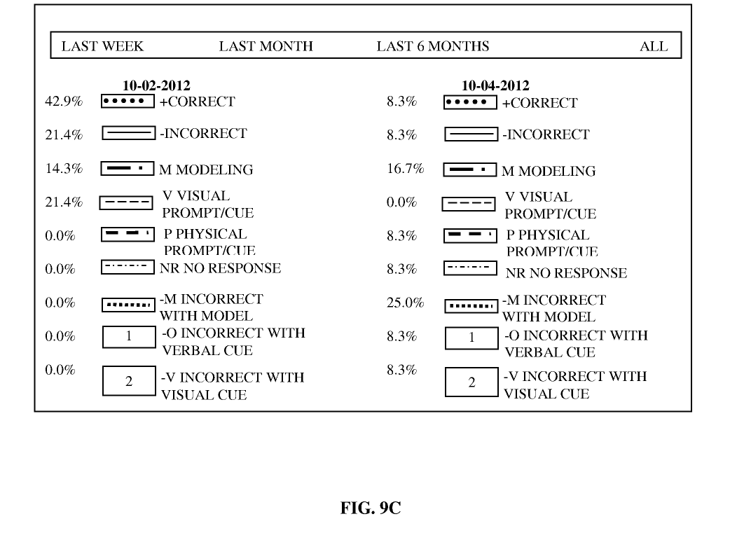

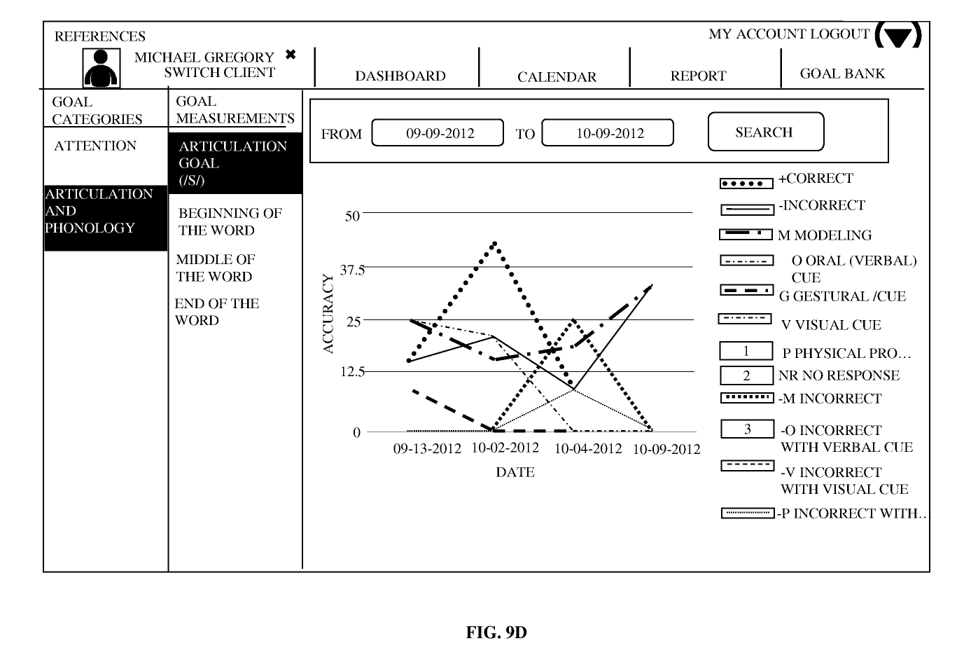

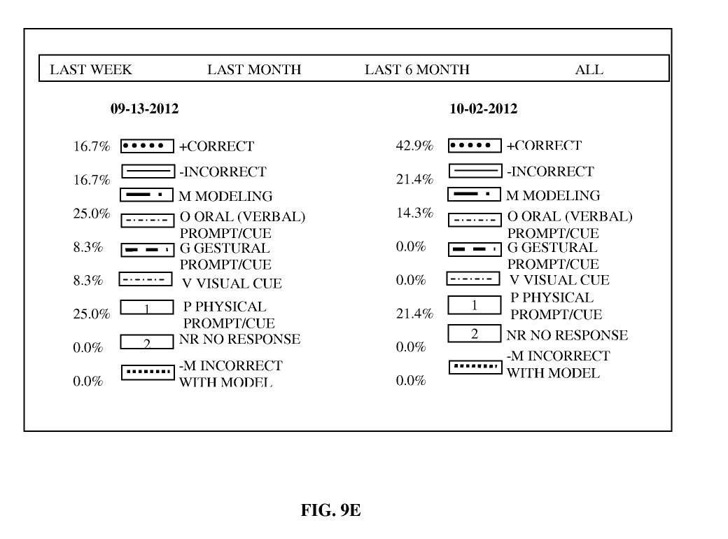

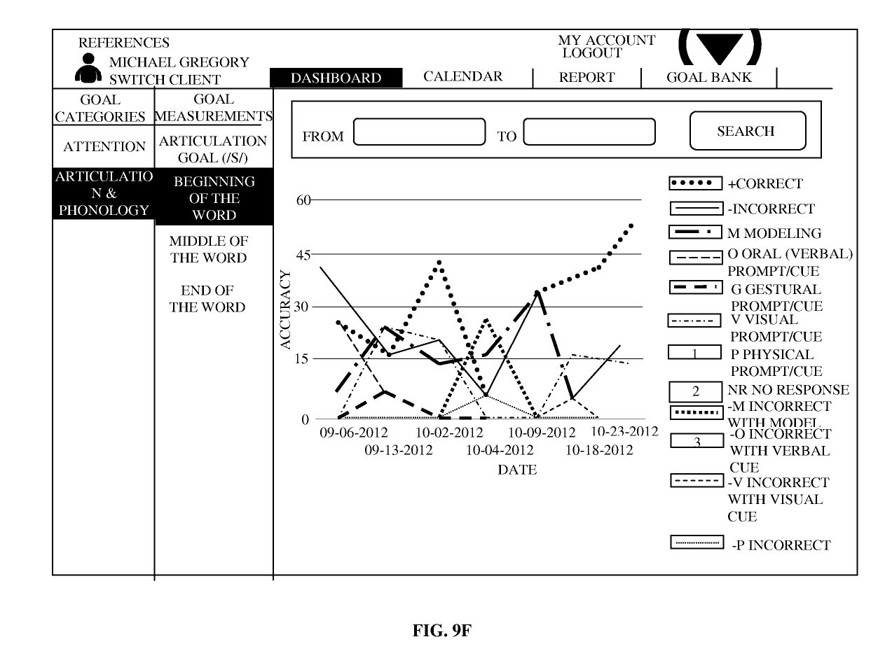

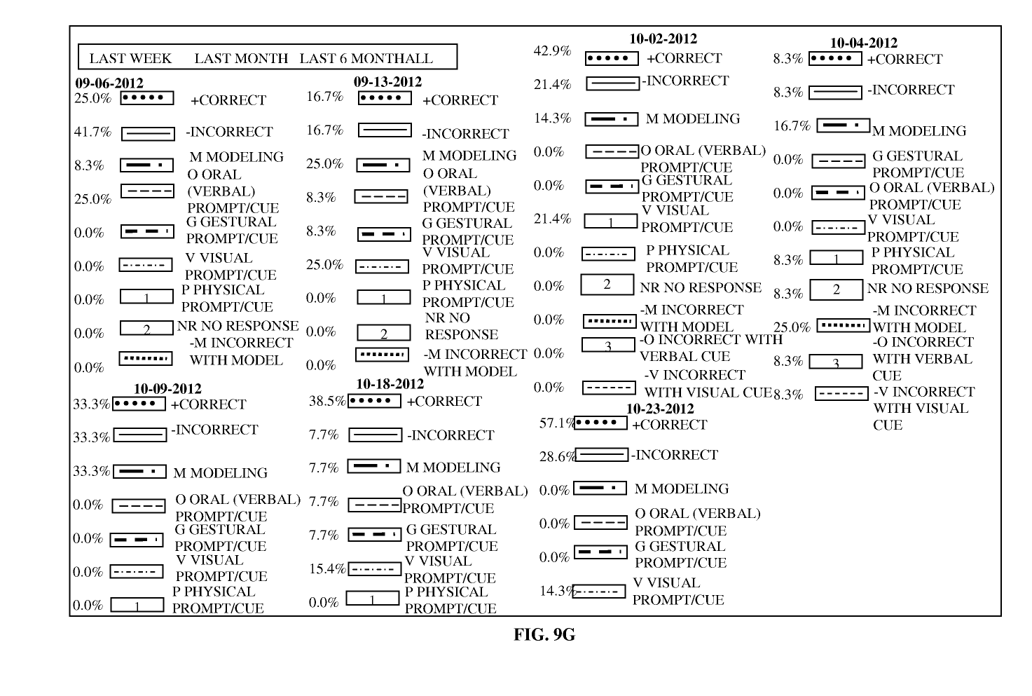

The therapy management application generates 107 progress reports based on performance of each of the clients for each of the generated goals using the collected and tracked data. Once the goals are generated and assigned and the data has been tracked for the assigned goals, the therapy management application correlates and renders the data in a progress report of a format that can be easily viewed and understood by a lay person, for example, a parent, a school administrator, a lawyer, etc. The progress report is, for example, a score sheet or an evaluation report, a graphical representation, etc., that shows a client's performance in the therapy sessions with respect to the goals to be achieved. In an embodiment, the therapy management application is configured to generate the progress reports in one or more of multiple graphical representations based on time criteria. An evaluator selects the time criteria via the GUI as exemplarily illustrated in FIGS. 9A-9G. The therapy management application enables the therapist to generate and print the progress reports, for example, in the form of charts, stacked bar graphs, itemized bar graphs, line graphs, etc., based on the tracked data. In an embodiment, the therapy management application collects, analyzes, and converts the data using the performance indicators, for example, into a color-coded, easy to read dynamic bar graph or line graph. In an embodiment, the therapy management application displays a calendar on the GUI. The therapy management application acquires an input from the therapist to view the progress report on a particular day via the GUI. If a therapist selects a single date on the calendar displayed on the GUI, the therapy management application generates a progress report with an easy to read interactive bar graph with data accuracies as exemplarily illustrated in FIG. 9A. If a therapist selects a range of dates from the calendar, for example, a period of time, the therapy management application generates a progress report with an easy to read and interactive line graph as exemplarily illustrated in FIG. 9B and FIG. 9D. Therapists are also able to select a range of time periods, for example, “Last Week”, “Last Month”, “Last Six Months”, and “All” data to be shown on an interactive progress report via the GUI. Furthermore, the therapy management application displays annual goals and benchmarks, and therapy session comments on the progress report in order to determine progress, and the goals and benchmarks that have been met.

In an embodiment, the therapy management application selectively shares profile information of one or more clients, the generated goals of one or more clients, the collected and tracked data acquired from the scheduled therapy sessions of one or more clients for each of the defined goal measurements, and generated progress reports of one or more clients among evaluators of a therapy management team, for example, a team of therapists. The evaluators in the therapy management team may access the shared information via the GUI of each of their therapy management applications. The therapy management application controls access to the collected and tracked data acquired from the scheduled therapy sessions of each of the clients for each of the defined goal measurements, thereby allowing members of the therapy management team to have limited access or full access to the collected and tracked data of each of the clients. The therapy management application allows every member of the therapy management team, working with a client, to stay informed of progress in all therapy related areas. A primary contact person for the therapy management team can set permissions for the other therapists or teachers to access the collected and tracked data. The therapy management application acquires the permissions for the collected and tracked data from the primary contact person for the therapy management team via the GUI. The allowable permissions are, for example, “read-only access to data”, “able to edit data”, etc. The “read-only access to data” permission provides another teacher or therapist access to data collected from the therapy management team without allowing the teacher or therapist to add, edit, or change the data. The “able to edit data” permission allows another teacher or therapist complete or full access to add, edit, or change the data.

The computer implemented method disclosed herein provides a database network in communication with the therapy management application. The database network is configured to store and dynamically update the data acquired from the scheduled therapy sessions and the generated progress reports of each of the clients for each of the generated goals based on a preconfigured time interval. In an example, the evaluator configures a time interval for the period for which the collected data is to be stored in the database network. In an embodiment, the therapy management application restores the data acquired from the scheduled therapy sessions of each of the clients for a preconfigured time interval, on receiving an indication from an evaluator, for example, a therapist via the GUI. Furthermore, in an embodiment, the therapy management application automatically synchronizes the collected and tracked data acquired from the scheduled therapy sessions of each of the clients for each of the defined goal measurements in an offline access mode, with the collected and tracked data acquired from the scheduled therapy sessions of each of the clients for each of the defined goal measurements in an online access mode. The synchronized collected and tracked data is stored in the database network for future reference or restoration.

In an embodiment, the therapy management application allows the therapist to save the progress reports on a secure encrypted network, print the progress reports using an output device, and send an electronic mail with the progress reports or export the progress reports via the GUI. In an embodiment where the therapist exports a progress report, the therapy management application generates a data file comprising the progress report and transmits the data file to other therapists or professionals in the field who may be servicing the same client, for example, via electronic mail (email). In an embodiment, the therapy management application enables the data file to be reloaded onto another therapy management application for a streamlined transfer of the data file. In another embodiment, the therapy management application enables the data file to be uploaded using programs, for example, Microsoft Excel® of Microsoft Corporation, Numbers® of Apple Inc., etc., thereby allowing other therapists who have no access to the therapy management application to access, read, and use the data collected by the therapy management application. The generation, transfer, and upload of the progress reports via a network prevents data and time from being lost when a client transfers between schools or between therapists.

In an embodiment, the therapy management application securely transfers one or more of the profile information of one or more clients, the generated goals of one or more clients, the collected and tracked data acquired from the scheduled therapy sessions of one or more clients for each of the defined goal measurements, and the generated progress reports of one or more clients for each of the generated goals, to one or more evaluators via a network for subsequent evaluation of those clients based on transfer criteria. The transfer criteria comprise, for example, relocation of a client to a different city, state, country, etc., unavailability of the client for subsequent therapy sessions, unavailability of a therapist for a long period of time, etc. In an example, the therapy management application allows therapists and teachers to transfer clients to the next treating therapist if the client changes facilities or locations. Specifically, for example, if a client is being treated by a therapist A and if the following year the same client moves or advances to another facility or location, therapist A can easily and securely transfer electronically the previously collected data and client information to therapist B who is the new treating therapist using the therapy management application, thereby preventing the data and time from being lost when a client transfers between schools or between therapists. Therefore, based on the transfer criteria, the therapy management application enables a secure transfer of the collected and tracked data acquired from the scheduled therapy sessions and the generated progress reports of one or more of the clients to one or more therapists via a network for the remaining subsequent therapy sessions. The therapy management application thereby tracks and manages the therapy sessions scheduled for each of the clients.

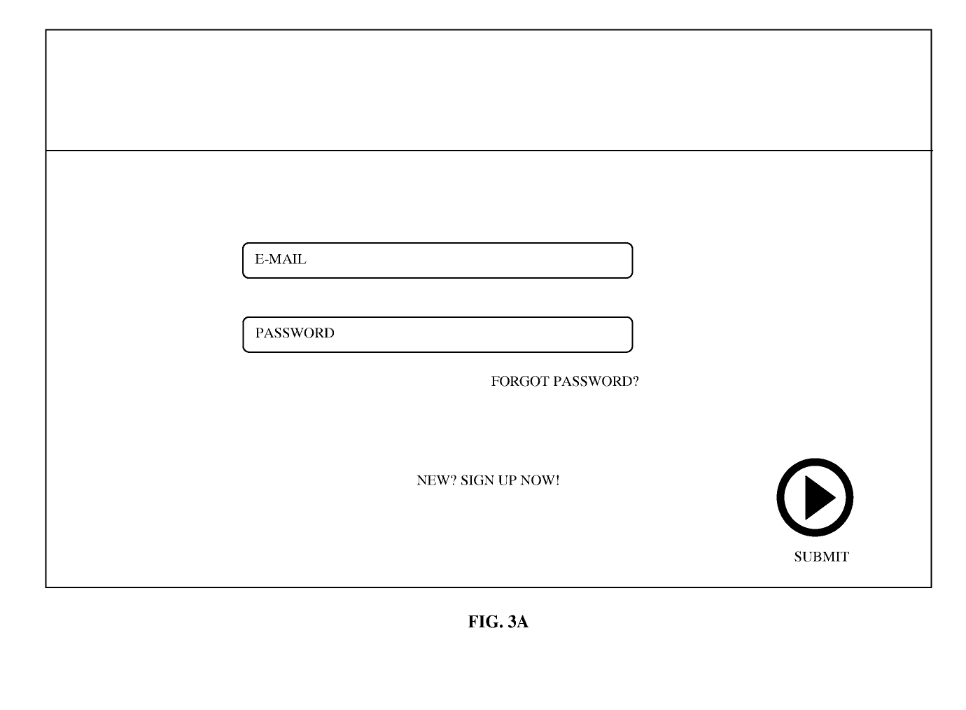

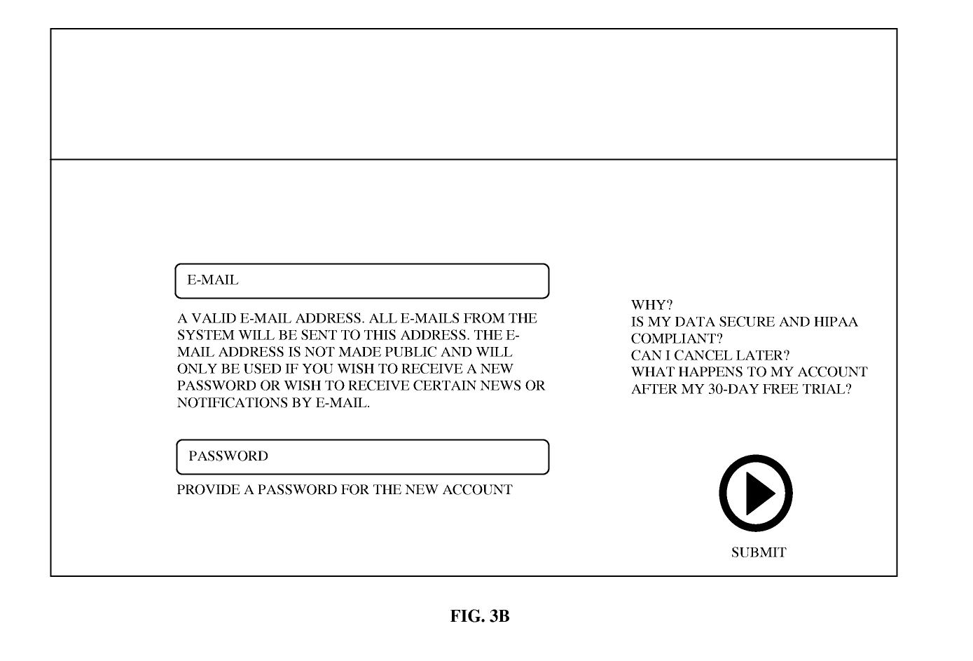

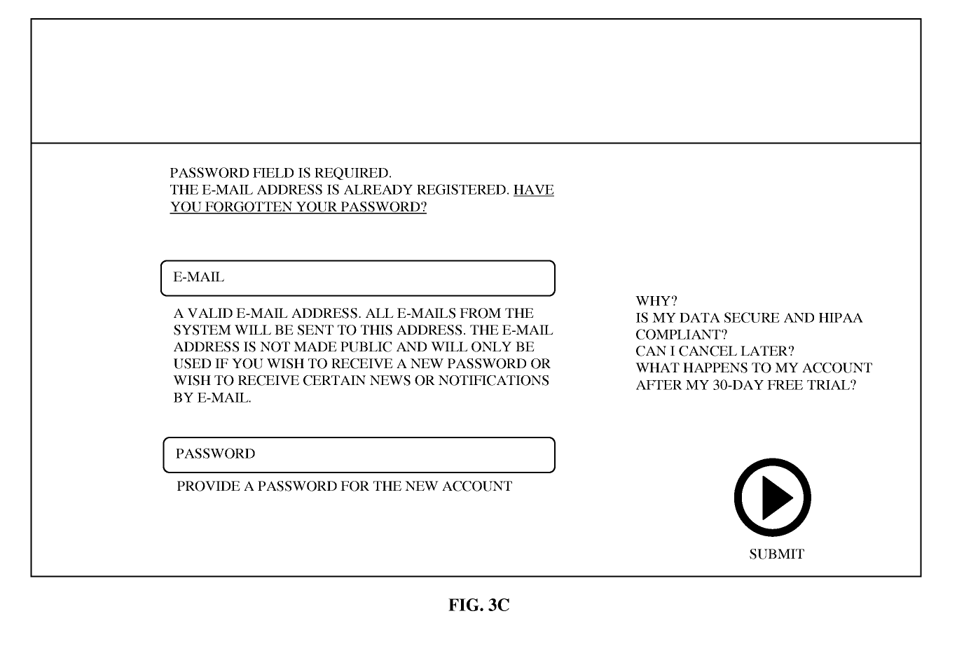

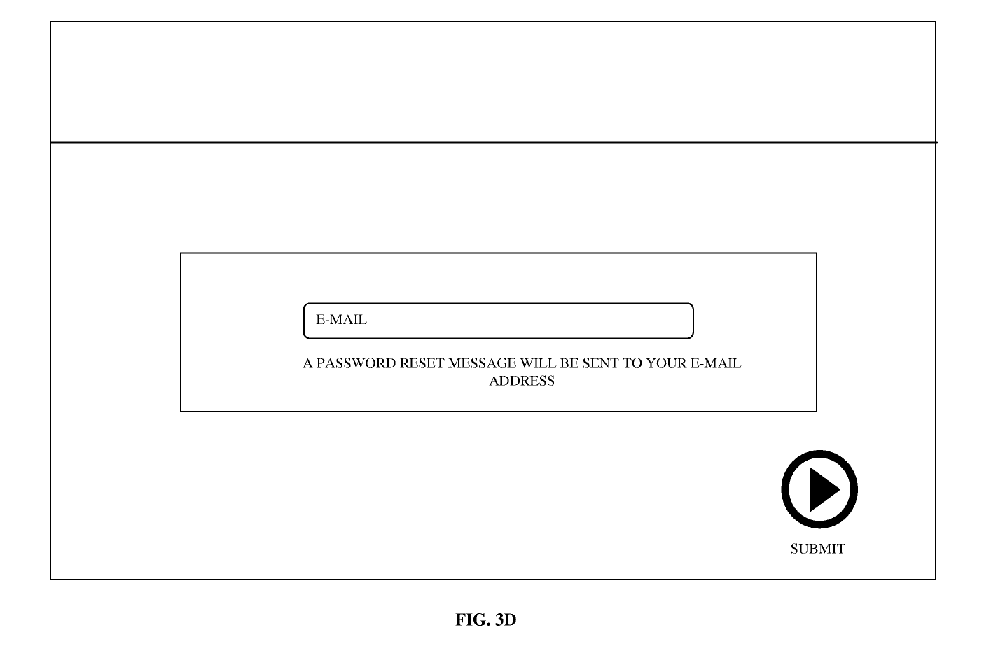

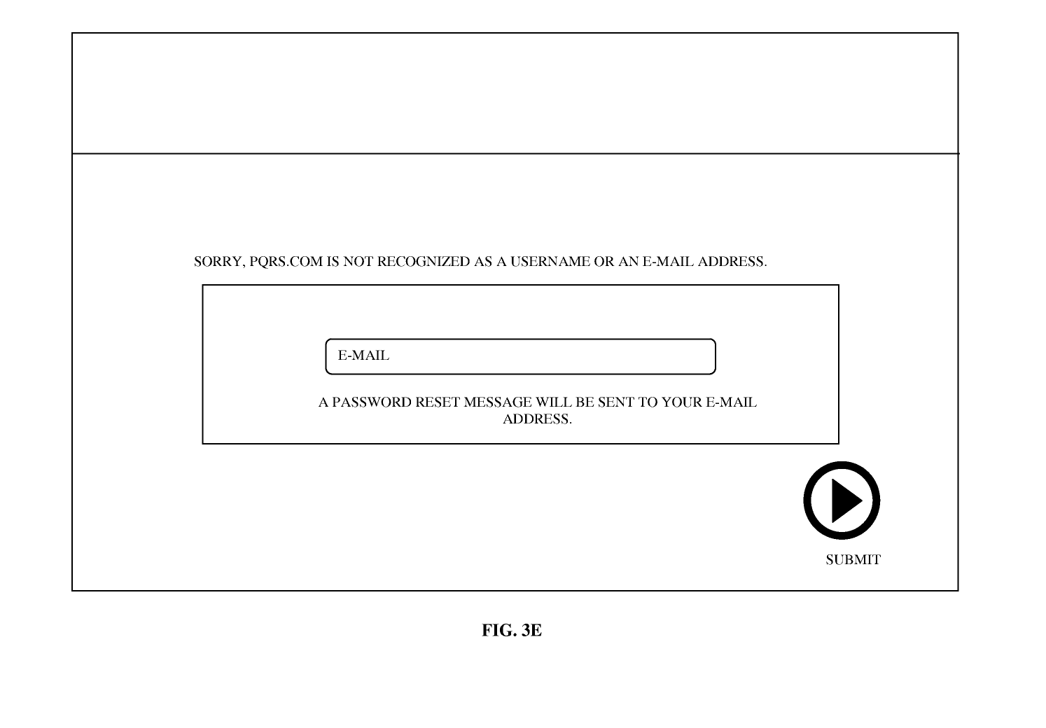

FIGS. 2A-2D exemplarily illustrate a logic flow diagram of options provided by the therapy management application for tracking and managing therapy sessions. FIGS. 2A-2D exemplarily illustrate different interfaces provided by the therapy management application. The therapy management application acquires an evaluator's login information via a “login” interface as exemplarily illustrated in FIGS. 3A-3B. The evaluator is herein referred to as a “therapist”. The login information comprises, for example, a unique login name, an electronic mail (email) address, a password, etc. The therapy management application requests an unregistered therapist to provide a unique name, an email address, and a password. The therapy management application utilizes the email address of the therapist to recover a password and transmit a new password to the therapist as exemplarily illustrated in FIGS. 3C-3E. The therapist can enter the unique login name and the password to access the therapist's data stored by the therapy management application. The therapy management application acquires the login information to authenticate the therapist prior to providing access to the data, as the data collected by the therapy management application during the therapy sessions is confidential and sensitive as per guidelines of the Health Insurance Portability and Accountability Act (HIPAA) of 1996. On successful login, the therapy management application directs the therapist to a page on a “caseload” interface 201 displayed on a graphical user interface (GUI) of the therapy management application as exemplarily illustrated in FIG. 2A and FIGS. 5A-5H.

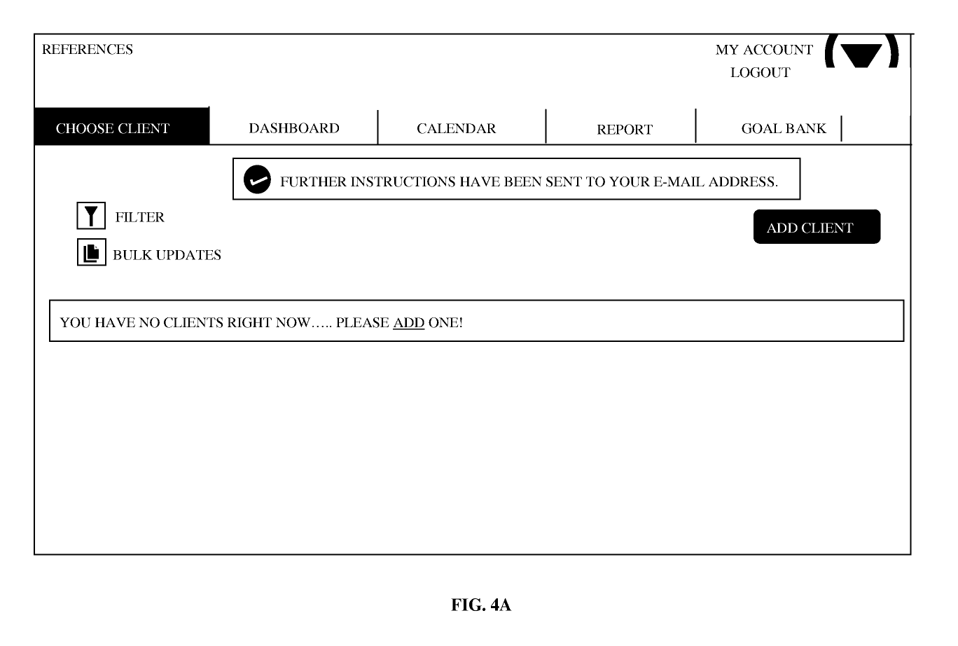

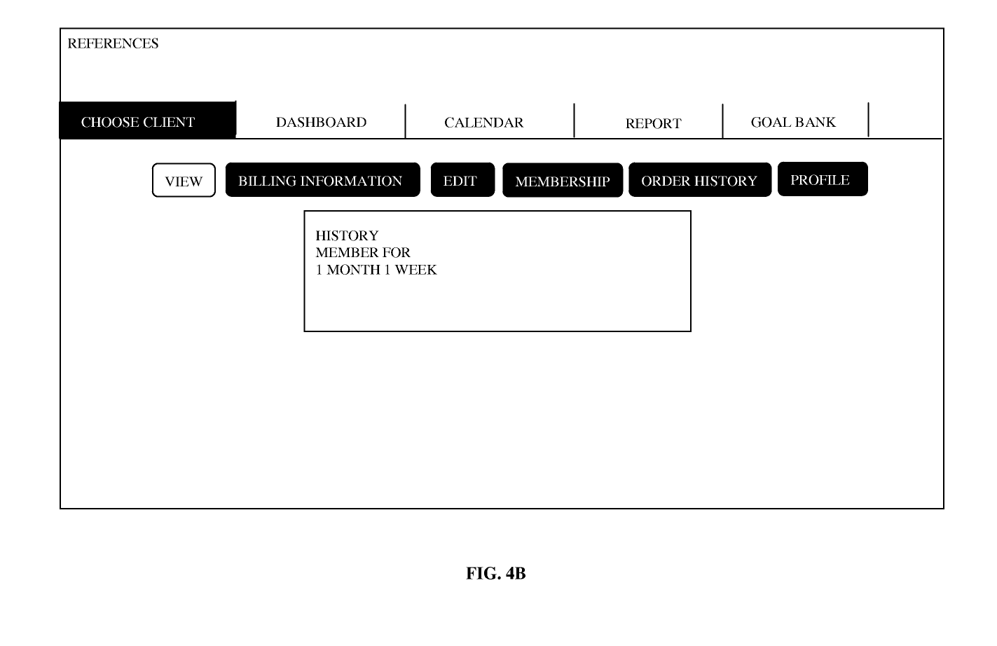

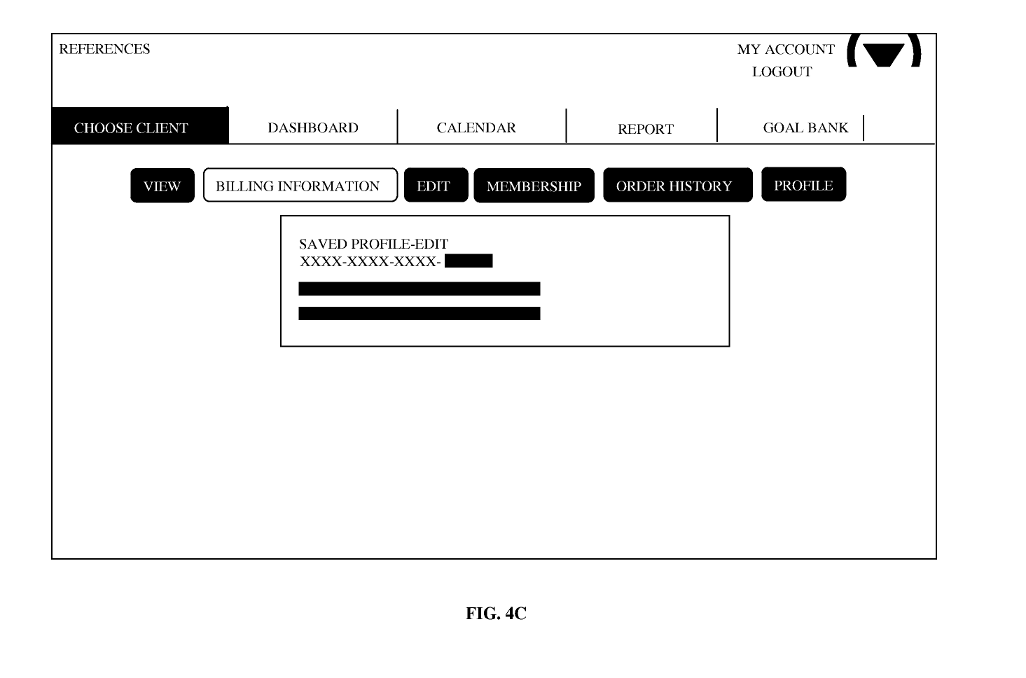

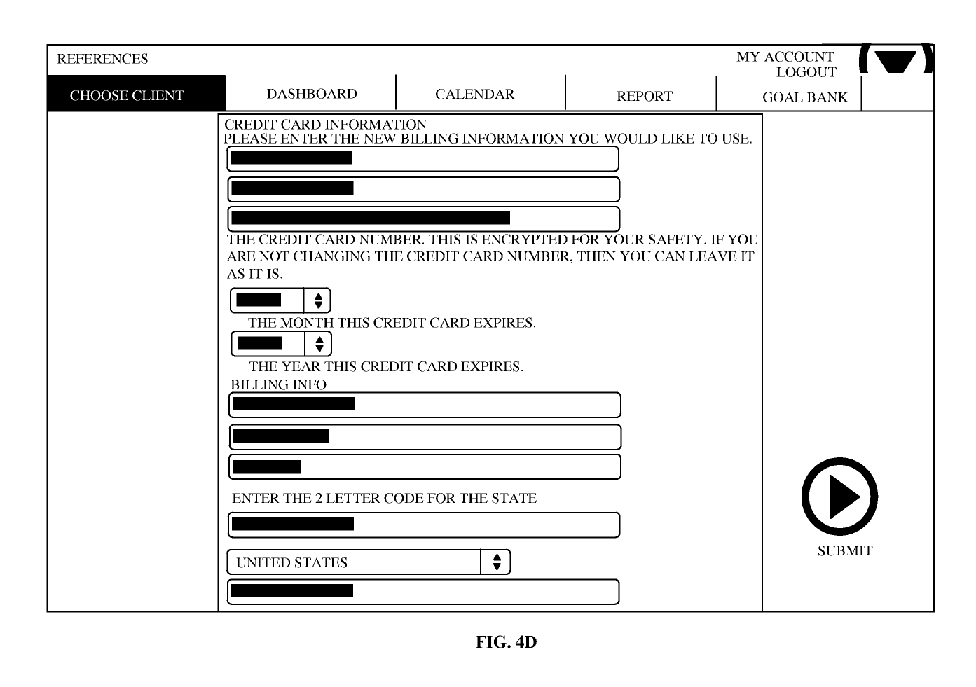

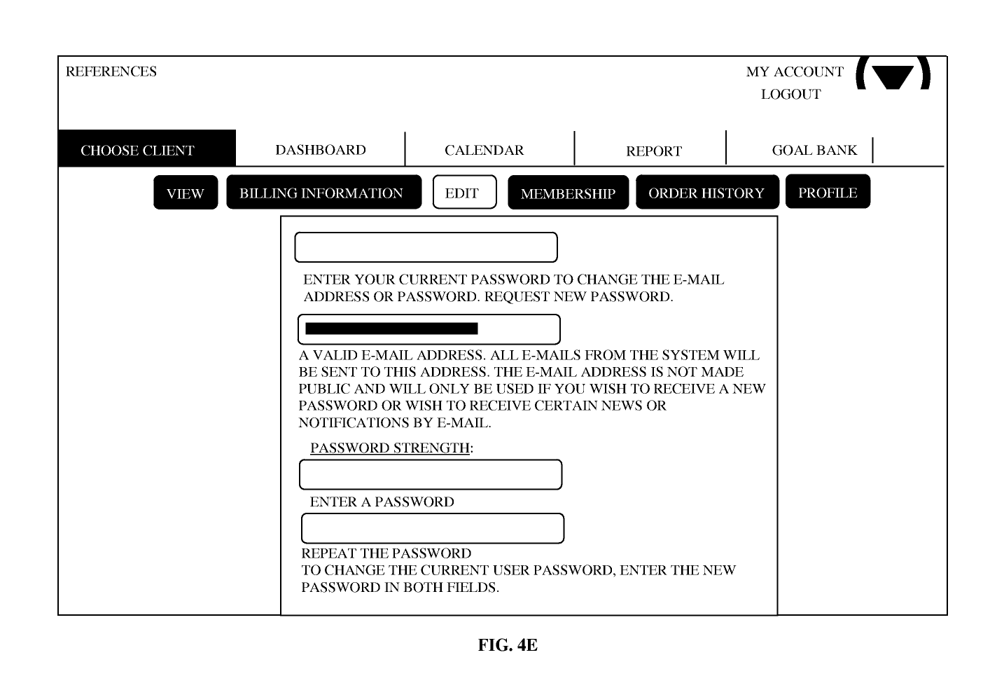

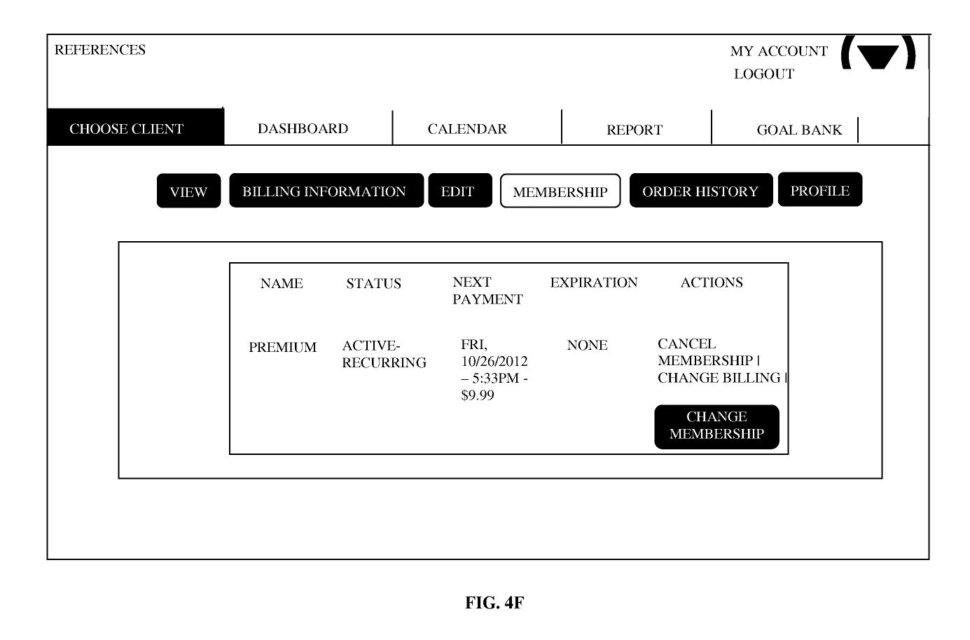

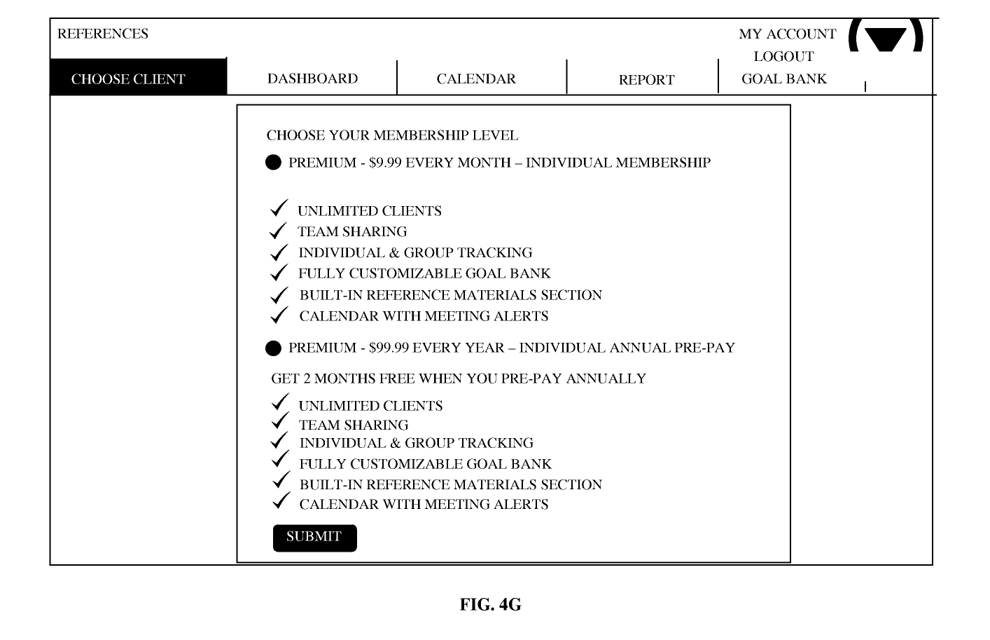

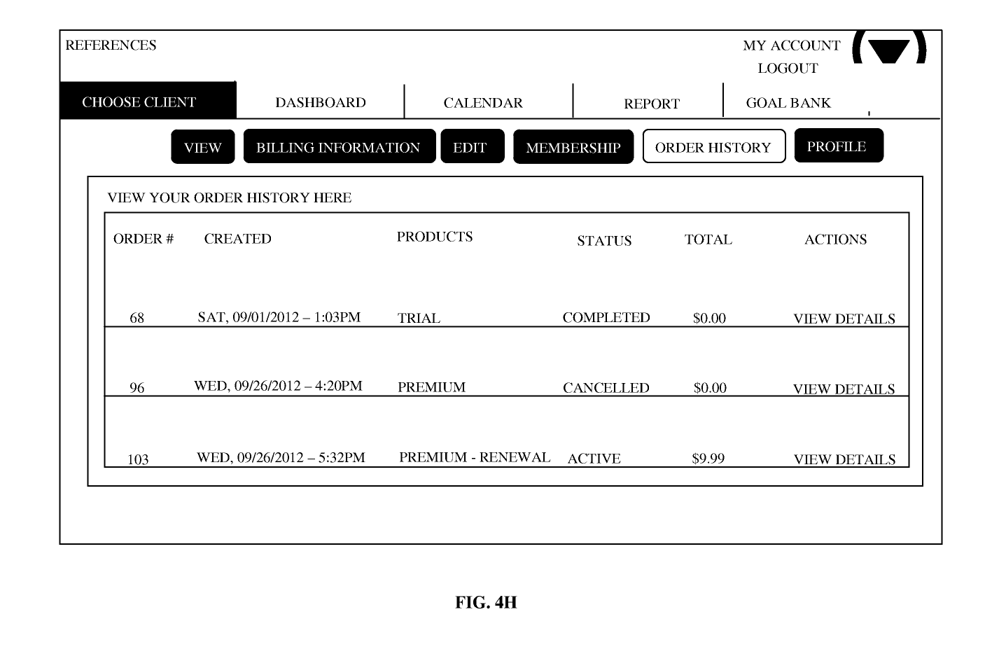

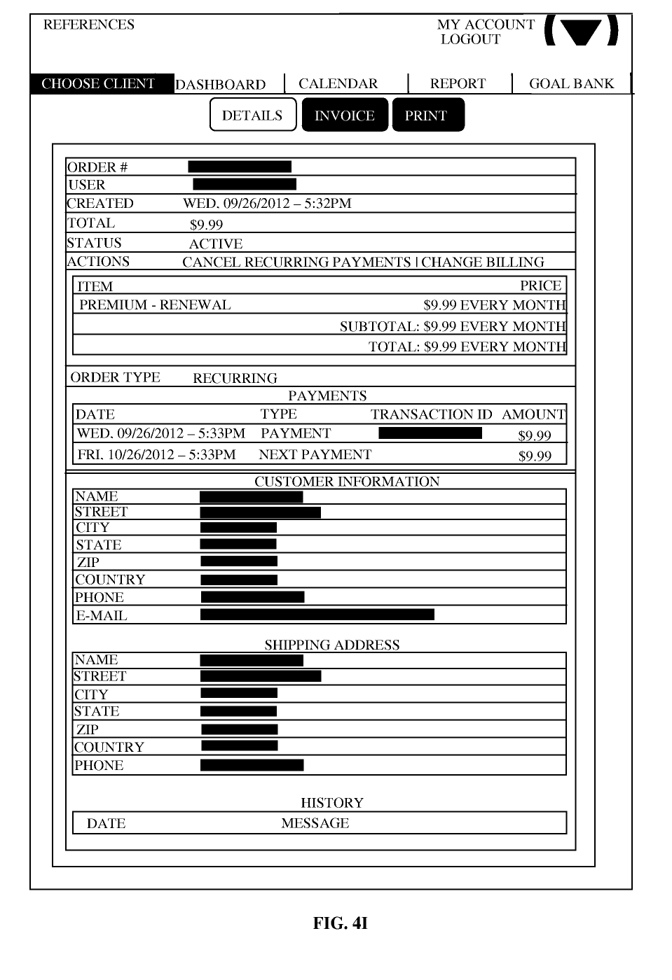

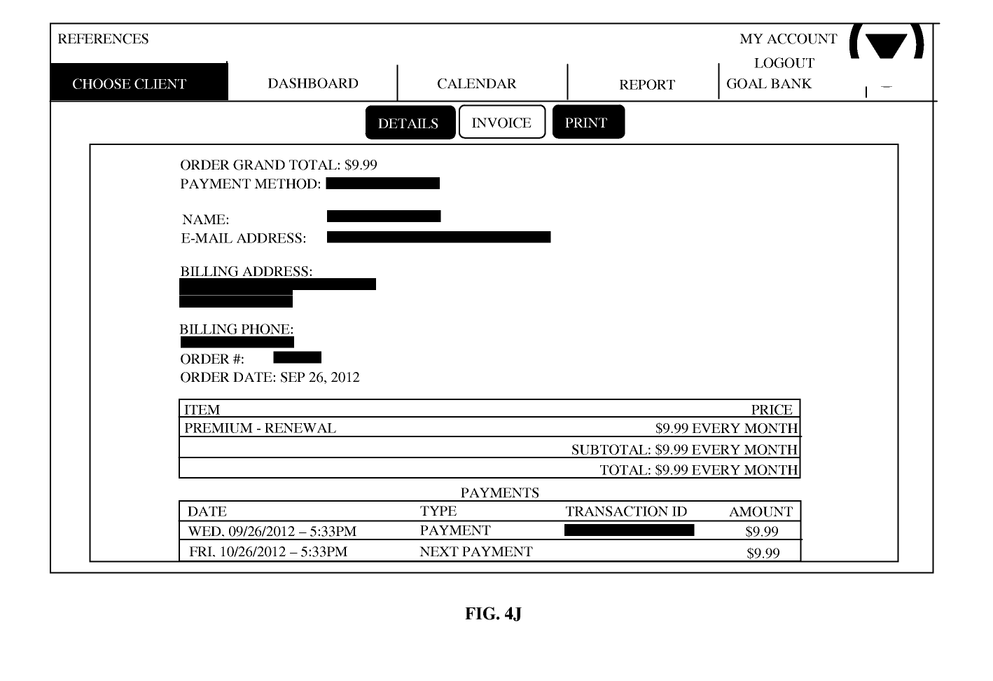

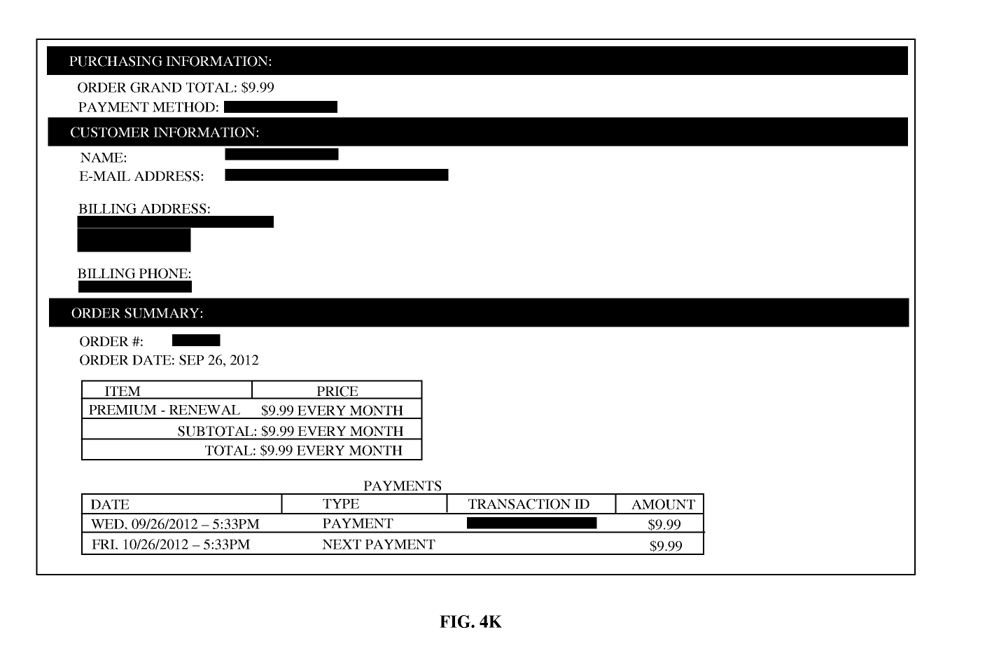

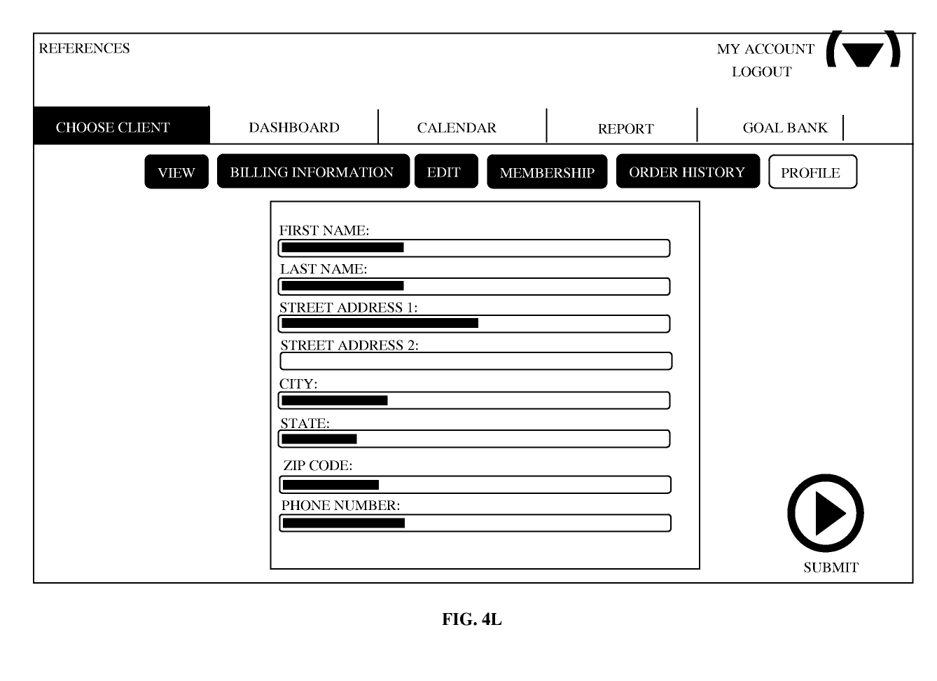

The therapy management application provides access to the therapist's user settings via a “My Account” section displayed on the GUI of the therapy management application. For example, the therapist can view membership history, change the user settings such as the therapist's electronic mail (email) address and password, edit profile information such as name, address, phone number, etc., change membership level from a free trial level to a monthly membership or an annual pre-pay membership, view membership order history, print and create invoices, edit billing information such as credit card information and billing address information, backup data, restore data, log out of the therapy management application, etc., via the “My Account” section as disclosed in the detailed description of FIGS. 4A-4L. When a therapist logs into the therapy management application, the therapy management application displays the “homepage” which provides access to multiple interfaces, for example, a “caseload” interface 201, a “calendar” interface 207, a “reports” interface 218, a “goal bank” interface 229, etc., as exemplarily illustrated in FIG. 4A. The “caseload” interface 201 enables a therapist to view the entire list of clients via an “A-Z list of clients” interface 202 and add a new client via an “add a new client” interface 203. The therapy management application acquires the client information provided by the therapist and saves the acquired client information in a database network. The client information is accessible on a “client dashboard” interface 204. The therapy management application enables the therapist to edit profile information of a client via the “profile information” interface 205. The therapist may mark important dates 206 associated with scheduled therapy sessions on the “calendar” interface 207 by providing an input in the blank area around the date.

The “calendar” interface 207 of the therapy management application also displays meeting alerts 208 and email alerts 209 if any prior meetings are fixed. The “calendar” interface 207 of the therapy management application enables a therapist to view the scheduled training sessions weekly, daily, or monthly by clicking a “Day/week/month” view interface 210. A “click a day” interface 212 enables the therapist to add a group therapy session or an individual therapy session by clicking on a “group session” interface 213 or an “individual session” interface 214 respectively. The therapist may then assign goals for an individual client or a group and view the assigned goals via an “assigned goals” interface 215. The therapy management application collects data associated with both individual and group therapy sessions and tracks the collected data via an “individual data tracking” interface 216 and a “group tracking” interface 217 respectively. The therapy management application generates progress reports using the collected and tracked data. The therapist may view progress reports via the “reports” interface 218. To allow the therapy management application to generate progress reports, the therapist needs to perform one or more actions, for example, assign 219 goals, select 220 goal measurements, select 221 a date range, etc. The therapy management application then generates 222 progress reports, for example, a bar graphical representation, a line graphical representation, etc., using the tracked data. The therapy management application allows the therapist to email and/or print 223 the generated progress reports.

The collected and tracked data and the generated progress reports are stored in a secure central database 224 configured as a network, exemplarily illustrated in FIG. 2B, which can be accessed by a therapist by logging into the therapy management application, for example, from a computing device such as a website computer 225 or a tablet computing device 227. In an embodiment, the therapy management application comprises a program synchronization layer 226 configured to synchronize the therapy management application with the website computer 225 and the tablet computing device 227. If a therapist creates a web account, the program synchronization layer 226 allows the therapist to synchronize the collected and tracked data from the web account with that stored by the therapy management application on the therapist's electronic device and vice versa. On logging into the therapy management application, the therapist may access the program homepage 228 which provides access to the “caseload” interface 201 exemplarily illustrated in FIG. 2A, the “reference” interface 233, and a member account settings interface 243 as exemplarily illustrated in FIG. 2B. The therapy management application provides a collection of reference documents which are typically scattered throughout publications, the internet, various state regulations, etc., via the “reference” interface 233. The therapy management application aggregates reference documents in the “reference” interface 233. The reference documents are crucial documents pertaining to the field of therapy that every therapist in the field is required to know and utilize while creating an individualized education program (IEP) for a client.

The “reference” interface 233 displays milestones 234 having sub-categories 235 and expectations 236 having sub-categories 237 assigned by the therapist for each of the clients. The “reference” interface 233 also comprises a glossary 238 section having sub-categories 239 where the details of a particular client's need for therapy are displayed. Moreover, the “reference” interface 233 also comprises a “states” interface 240 that provides access to general education expectations/standards, extended standards, etc., of multiple states. The “states” interface 240 possesses sub-categories 241 and links to web pages 242. The therapy management application provides access to the “goal bank” interface 229 via the “reference” interface 233, the “client dashboard” interface 204, and the “reports” interface 218. The “goal bank” interface 229 provides access to the goals generated by the therapy management application including the goals categorized into goal categories. The goal categories are further classified into meta-categories and sub-categories. The “goal bank” interface 229 allows a therapist to select 230 a meta-category, select 231 a sub-category, and assign 232 a goal to an opened client. An opened client is a client whose profile information, therapy data, etc., is currently being viewed, edited, updated, etc., by a therapist via the GUI of the therapy management application.

A “member account settings” interface 243, exemplarily illustrated in FIG. 2C, of the therapy management application displays membership information of the therapist. The “member account settings” interface 243 provides access to membership history 244 and allows a therapist to view the length or duration of the membership 245 associated with usage of the therapy management application. The “member account settings” interface 243 of the therapy management application also displays a billing portal 246 through which the therapist makes payments in order to continue the service provided by the therapy management application. The billing portal 246 of the “member account settings” interface 243 allows the therapist to edit 247 billing information. The “member account settings” interface 243 of the therapy management application also enables the therapist to edit 248 account information, for example, the profile information of the therapist and change 249 the password, email identity, etc., if necessary. The therapist can edit membership information 250 and choose the duration of the membership, for example, a trial membership, a monthly membership, or an annual membership with the therapy management application via the GUI of the therapy management application. The therapy management application enables the therapist to change 251 billing information, change 252 membership duration, for example, from either a monthly membership 253 to an annual membership 254 or from an annual membership 254 to a monthly membership 253, and cancel 255 a membership via the “member account settings” interface 243. The “member account settings” interface 243 of the therapy management application also enables the therapist to access membership order history 256 through which the therapist may view order history details 257 and change 258 billing, cancel 259 recurring payments, etc. The therapy management application enables the therapist to create 260 an invoice and to print 261 the invoice as a copy of reference.

The “member account settings” interface 243 of the therapy management application also enables the therapist to access the “profile” interface 262 in order to edit profile information 263, for example, name, email address, contact information such as a phone number, etc. Moreover, the “member account settings” interface 243 also provides access to a therapist sharing portal 264 of the therapy management application. The therapist sharing portal 264 of the therapy management application enables the therapist to selectively share 265 data associated with one or more clients with a team of therapists working along with the therapist. The therapy management application allows the therapist to control access to the data by allowing the therapist to set 266 permissions for the data. If the therapist sets 266 permissions for another therapist as “able to edit data” 267, the therapy management application provides complete access to the data and allows the other therapist to add, edit, or change the data. If the therapist sets 266 permissions for another therapist as “read-only data” access 268, the therapy management application provides read only access to the data and does not allow the other therapist to add, edit, or change the data. The therapist sharing portal 264 of the therapy management application also enables the therapist to securely transfer 269 the data associated with one or more clients to other evaluating therapists or team members via the network based on one or more transfer criteria, for example, unavailability of a treating therapist, relocation of a client, etc.

FIGS. 3A-3E exemplarily illustrate screenshots of a graphical user interface (GUI) of the therapy management application for registering and logging a therapist into the therapy management application. FIGS. 3A-3B exemplarily illustrate screenshots of a “login” interface on the GUI of the therapy management application for registering a therapist with the therapy management application. The “login” interface of the therapy management application displays multiple fields for entering login information. When the therapist launches the therapy management application on the electronic device, the therapy management application acquires the therapist's login information via the “login” interface. The therapist can enter the login information, for example, name, electronic mail (email) address, password, etc., in the respective fields for registering with the therapy management application. The therapy management application provides a “Submit” button on the “login” interface to enable the therapist to submit the login information to the therapy management application.

The therapy management application requests for a valid email address and password for registering a therapist as exemplarily illustrated in FIG. 3B. On successful registration, the therapy management application displays a successful registration message on the “login interface”. During login, the therapy management application validates the email address and password entered by the therapist to log into the therapy management application. The therapy management application performs field validation. That is, the therapy management application checks whether the login information entered by the therapist on the “login” interface is complete and correct. If the therapist enters incorrect or incomplete login information in any of the fields on the “login” interface, for example, if the therapist enters an incorrect password, the therapy management application displays an error message, for example, “Have you forgotten your password” on the “login” interface as exemplarily illustrated in FIG. 3C. The therapist can then re-enter the complete and correct login information on the “login interface”.

FIGS. 3C-3E exemplarily illustrate the screenshots for password recovery performed by the therapy management application. If the therapist enters an incorrect password, the therapy management application requests the therapist to enter the valid user password and displays a message, for example, “The password field is required. The email address is already registered. Have you forgotten your password?” on the “login” interface as exemplarily illustrated in FIG. 3C. The therapy management application requests the therapist to enter an email address for sending the password or a password reset message as exemplarily illustrated in FIG. 3D. The therapy management application transmits a password reset message or a password recovery email to the email address provided by the therapist when the therapist clicks on a “forgot password” link on the “login” interface. The therapy management application displays a message, for example, “A password reset message will be sent to your email address” as exemplarily illustrated in FIGS. 3D-3E. If the therapist enters an incorrect email address for password recovery, the therapy management application does not recognize the email address and displays an error message, for example, “Email address is not recognized as a username or an email address” on the login interface as exemplarily illustrated in FIG. 3E.

FIGS. 4A-4L exemplarily illustrate screenshots of a graphical user interface (GUI) of the therapy management application for configuring member settings and managing a membership of the therapist. After registration, a therapist is allowed to access the therapy management application as a member. When the therapist accesses the therapy management application for the first time, the therapy management application requests the therapist to add clients as exemplarily illustrated in FIG. 4A. The therapy management application requests the therapist to provide profile information and information associated with the membership, for example, billing information, membership options, membership duration, etc., via the GUI as exemplarily illustrated in FIG. 4B. The therapist can view his/her membership history, that is, the length of time he/she has been a member with the therapy management application as exemplarily illustrated in FIG. 4B. The therapist may edit and save profile information on the GUI as exemplarily illustrated in FIG. 4C. The therapist may access a “billing information” interface on the GUI to enter credit card and billing information as exemplarily illustrated in FIG. 4D.

The therapy management application enables the therapist to edit login information, for example, change a password as exemplarily illustrated in FIG. 4E. The therapy management application enables the therapist to edit membership information, cancel a membership, select a membership level, etc., as exemplarily illustrated in FIGS. 4F-4G. The therapist can select a “Membership” interface where the therapist can view their current membership level, for example, “30-day trial”, “Premium Monthly”, or “Premium Annual”, as exemplarily illustrated in FIGS. 4F-4G. On the “Membership” interface, the therapist can view when their next subscription payment is due, expiration date regarding the 30-day free trial period, etc. On the “Membership” interface, the therapist can performs actions such as cancel a membership, change billing, and change membership. When the therapist clicks on a “Cancel Membership” link, the therapy management application allows the therapist to cancel a membership or directs the therapist to a page that indicates “This action cannot be undone” with buttons to “Confirm” or “Cancel”. When the therapist clicks on a “Change Billing” link, the therapy management application directs the therapist to the “Billing Information” interface, where the therapist can update their credit card information and billing address as exemplarily illustrated in FIG. 4D. When the therapist clicks on a “Change Membership” link, the therapy management application directs the therapist, for example, to two subscription payment options available, for example, “Monthly Premium” or “Annual Premium” as exemplarily illustrated in FIG. 4G. The therapist can select “Monthly Premium” to subscribe to the therapy management application monthly recurring. The therapist can also select “Annual Premium” to subscribe to the therapy management application and pre-pay for an annual membership.

On completing the membership procedures as exemplarily illustrated in FIGS. 4A-4G, the therapy management application displays the “order history” on the “Membership” interface as exemplarily illustrated in FIG. 4H. The therapist can request for a detailed order history and an invoice via the GUI. The therapist can select the “Order History” interface to access his/her monthly recurring or annual payment orders that have been placed as exemplarily illustrated in FIG. 4H. The therapist can select “View Details” to see the details of their orders, create invoices, and print the invoices as exemplarily illustrated in FIGS. 4H-4K. The therapy management application displays the invoice on the GUI as exemplarily illustrated in FIG. 4I. FIGS. 4J-4K exemplarily illustrate the invoice copy of the orders made by the therapist. The therapy management application allows the therapist to email the invoice and/or print the copy of the invoice. The therapy management application further allows the therapist to edit profile information as exemplarily illustrated in FIG. 4L. The therapist can select “Profile” to edit or update their name, address, and phone number associated with their account as exemplarily illustrated in FIG. 4L.

FIGS. 5A-5H exemplarily illustrate screenshots of a graphical user interface (GUI) of the therapy management application for adding clients, providing information associated with the clients, and for managing the clients. The therapy management application enables the therapist to add a new client using a “Caseload” interface of the therapy management application exemplarily illustrated in FIGS. 5A-5D. If the therapist logs into the therapy management application for the first time, the therapy management application displays a button on the “homepage” that prompts the therapist to add a new client as exemplarily illustrated in FIG. 5A. If the therapist is not new, then the therapy management application displays a list of the therapist's clients in an alphabetical order on the “caseload/choose client” interface with an option to add a new client as exemplarily illustrated in FIGS. 5A-5D. The therapist may click on an “add” button on the “caseload/choose client” interface of the therapy management application to add a new client.

When the therapist accesses the “caseload/choose client” interface, the therapy management application allows the therapist to perform bulk operations, for example, change the status of multiple clients to active or inactive in a single iteration as exemplarily illustrated in FIG. 5B. When the therapist accesses the “caseload/choose client” interface, the therapy management application displays a list of the therapist's active clients and/or inactive clients in an alphabetical order based on a filter selection of “Show Active Clients” or “Show Inactive Clients” as exemplarily illustrated in FIG. 5C. The active clients are clients who are currently undergoing therapy sessions with the therapist. The inactive clients are clients who no longer take the therapy sessions. The therapist may view the inactive clients on the GUI by selecting the option “Show Inactive Clients” as exemplarily illustrated in FIG. 5D. Therapists can sort their caseload, for example, based on last name, first name, date of birth (DOB), service location, next individualized education program (IEP) date, next evaluation date, etc. The individualized education program (IEP) is a mandate designed to meet unique educational needs of a client, who may have a disability, as defined by federal regulations. When the therapist clicks on a client's name in the displayed list, the therapy management application directs the therapist to a page that displays that client's individual profile.

The therapy management application enables the therapist to create a unique client profile for each of the clients via the “caseload/choose client” interface as exemplarily illustrated in FIGS. 5E-5H, for example, by entering basic client information. The popup menus on a client's individual profile page show different values for different fields. For example, the values provided for a “Gender” field are male and female as exemplarily illustrated in FIG. 5E. The values provided for a “Grade” field are, for example, Pre-school, Kindergarten, 1, 2, 3, 4, 5, 6, 7, 8, 9, 10, 11, and 12 as exemplarily illustrated in FIG. 5F. The values provided for a “Country” field are, for example, United States, United Kingdom, etc., as exemplarily illustrated in FIG. 5F. The therapy management application prompts the therapist to set up a client profile for a new client by adding information, for example, a last individualized education program (IEP) date, a next IEP date, a last evaluation date, a next evaluation date, parental information, contact information, etc., as exemplarily illustrated in FIGS. 5E-5H. The therapy management application provides an “Add another item” button on a “Native Language(s)” field for adding an additional row for a native language field as exemplarily illustrated in FIG. 5E. The therapy management application provides an “Add another item” button on a “parental information” section of the profile page for adding an additional section for entering parental information as exemplarily illustrated in FIG. 5G.

In an embodiment, the therapy management application provides a “take a photo” button on the GUI, for example, on the iPad® application that enables the therapist to take a photo of the client by using the therapist's electronic device, for example, iPad2® of Apple Inc. The “take a photo” button is not available for iPad1® of Apple Inc. The therapist may also select a photo from a photo library on the web based therapy management application and the iPad® application of the therapy management application. The therapist can also select a photo from the photo library when accessing their account via a web program. Once the client profile is created, the therapy management application enables the therapist to view a “dashboard” interface that displays the profile information as exemplarily illustrated in FIG. 5H, assign the goals for the therapist's clients, view schedules of the therapy sessions, begin tracking data for the goals, and generate color-coded progress report graphs using the tracked data. The “dashboard” interface displays the clients' basic information, important dates, and contact information. The therapy management application enables the client to save, print, and/or email the progress reports. The therapy management application continually updates the client profile page as the client progresses in each therapy session.

FIGS. 6A-6S exemplarily illustrate screenshots of a “calendar” interface of the therapy management application for scheduling therapy sessions and enabling a therapist to record appointments with one or more clients. The therapy management application manages appointments and helps a therapist to create schedules for individual therapy sessions and group therapy sessions via the “calendar” interface exemplarily illustrated in FIGS. 6A-6S. The “calendar” interface of the therapy management application functions as a personal assistant for the therapist. The “calendar” interface of the therapy management application enables the therapist to access the upcoming therapy sessions and the completed therapy sessions of each of the clients, thereby allowing the therapist to block free dates on the calendar. The “calendar” interface also provides a section to set up a type of the therapy session, that is, an individual therapy session or a group therapy session, frequency of the therapy session, that is, once a week, biweekly, etc., length of the therapy session, for example, 45 minutes, 1 hour, etc., and recurrence of the therapy session, for example, 1 year, a school year, indefinite, etc., based on the client's therapy needs.

FIG. 6A exemplarily illustrates a screenshot of the “calendar” interface showing “Upcoming Sessions”. The therapist can add an appointment for a therapy session with a client to an empty time slot on the calendar by clicking a date on the calendar on the screen display of the therapist's electronic device. Clicking a date on the calendar prompts a popup as exemplarily illustrated in FIG. 6B. The therapist can view or edit an existing appointment by touching one of the time slots on the calendar as exemplarily illustrated in FIG. 6C. The therapy management application displays details of an appointment, when the therapist clicks on a corresponding time slot on the “Upcoming Sessions” menu or selects the session on the calendar. The therapy management application displays all the appointments scheduled for a particular month as exemplarily illustrated in FIG. 6D.

FIGS. 6E-6S exemplarily illustrate screenshots of the “calendar” interface of the therapy management application for adding a new appointment. The therapist can enter the start time and end time for the appointment by clicking on a “start time” button and an “end time” button respectively as exemplarily illustrated in FIG. 6E. The therapist may select a date for the therapy session using a pop up calendar exemplarily illustrated in FIG. 6F. Upon selecting “Set Recurring” on the “Add Session” interface as exemplarily illustrated in FIG. 6G, the therapist is given the option to select one or more days of the week for the recurring session, for example, “Monday”, “Tuesday”, “Wednesday”, “Thursday”, “Friday”, “Saturday”, and “Sunday” as exemplarily illustrated in FIG. 6H. As exemplarily illustrated in FIG. 6I, the therapist selects Tuesday and Thursday for a recurring session. The therapist may then click on a “Generate” button provided on the “calendar” interface to create the recurring session. The therapy management application provides an option to review the recurring sessions that the therapist is about to create as exemplarily illustrated in FIG. 6J. The therapist can select “submit” to confirm and create the selected recurring sessions or the therapist can select “cancel” if the information is incorrect. The therapist is required to confirm the dates, as the therapy management application may not be able to undo the action of generating the recurring session.

The therapist also selects when a therapy session will recur, for example, the date can be up to 6 months in the future. When the therapist selects the option “Every day, every 2 weeks, etc.” on the “calendar interface” exemplarily illustrated in FIG. 6K, the therapy management application displays menu options, for example, “Every 2”, “Every 3”, “Every 4”, “Every 5”, “Every 6”, “Every 7”, “Every 8”, “Every 9”, “Every 10”, etc., for repeating the session as exemplarily illustrated in FIG. 6L. The therapist may then select the value, for example, “Day(s)”, “Week(s)”, or “Month(s)” on the calendar interface as exemplarily illustrated in FIG. 6M. The therapist can check a box to exclude weekends for the recurring sessions. The therapist must also select when the recurring session will recur until, for example, up to 6 months in the future. The therapy management application specifies that undoing the action may not be possible as exemplarily illustrated in FIG. 6N. The therapy management application allows a therapist to view a session, set a session as a recurring session, and edit or cancel the session as exemplarily illustrated in FIGS. 6O-6Q.

In an embodiment, the therapy management application provides an option to select a client to add to an appointment from the therapist's clients, for example, for creating a group therapy session. The therapy management application provides a “Client Reference” drop down menu exemplarily illustrated in FIG. 6R, for enabling the therapist to select one or more clients to add to the appointment. In an embodiment, the therapy management application provides a search field that automatically completes the name of the client as the therapist types in the letters of the client's name on the GUI. The therapy management application then displays the result of the search in a list under the search field. In an embodiment, the therapy management application displays the clients who have already been added to the appointment. If the therapist taps the “X” icon adjacent to the client's name as exemplarily illustrated in FIG. 6R, the therapy management application removes that client from the appointment. The therapy management application allows a therapist to edit a session as exemplarily illustrated in FIG. 6S. When the therapist selects a group therapy session from the calendar, the therapy management application pulls up client information of each client in the group therapy session. In an embodiment, the therapy management application provides an option to cancel a session as exemplarily illustrated in FIG. 6Q, for allowing the therapist to cancel a session and provide a written comment as to why the session is canceled. In another embodiment, the therapy management application provides an option to “delete a session” that is selected as exemplarily illustrated in FIG. 6S.

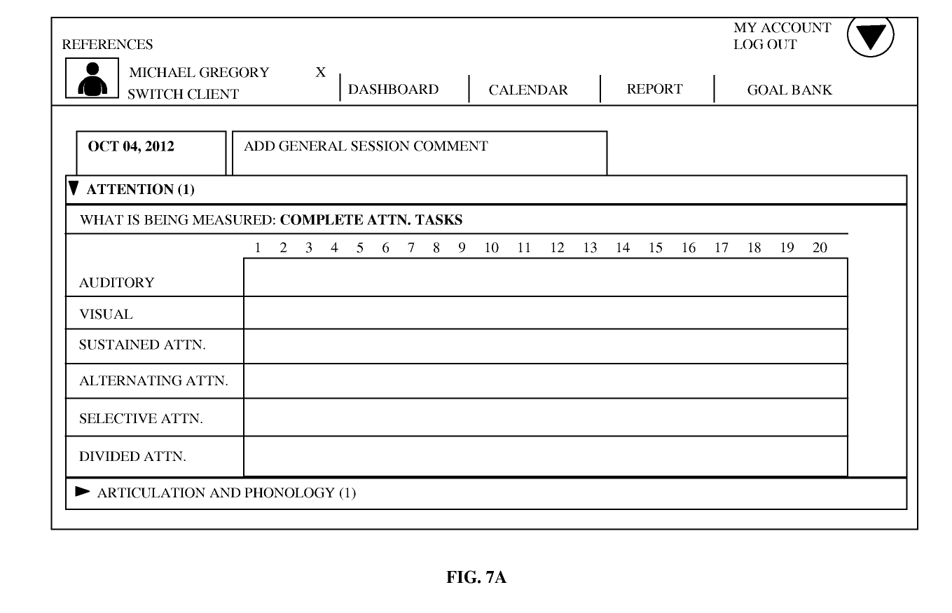

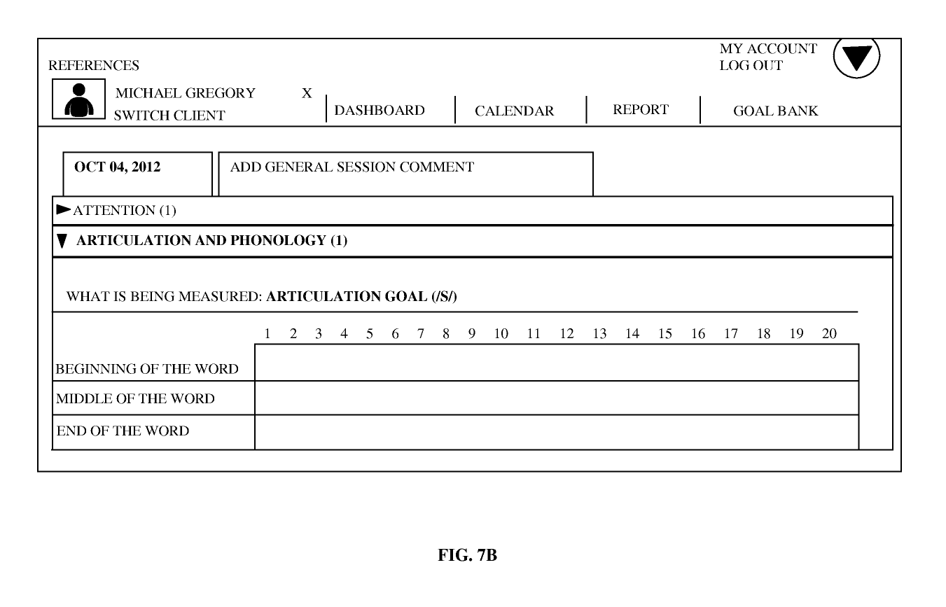

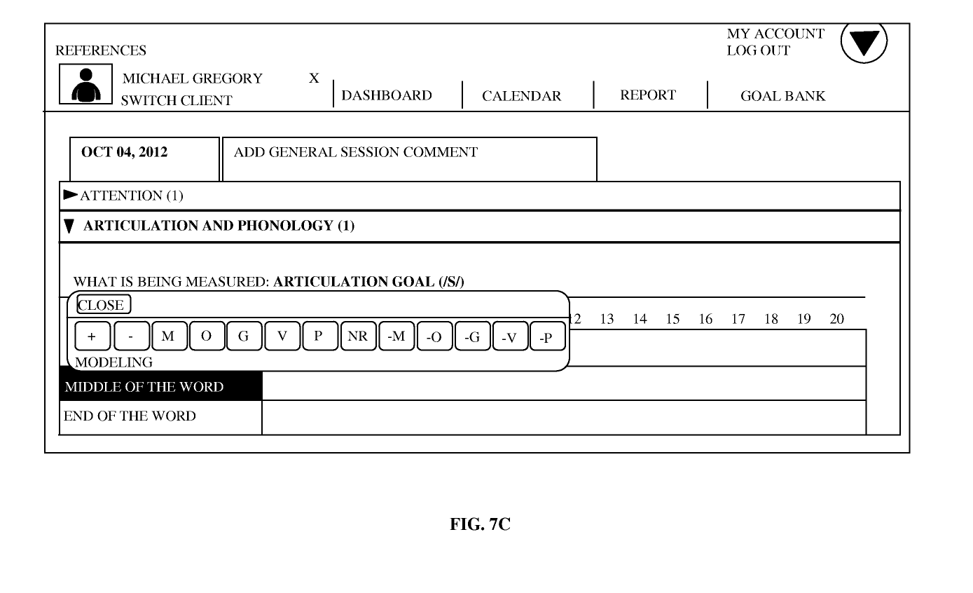

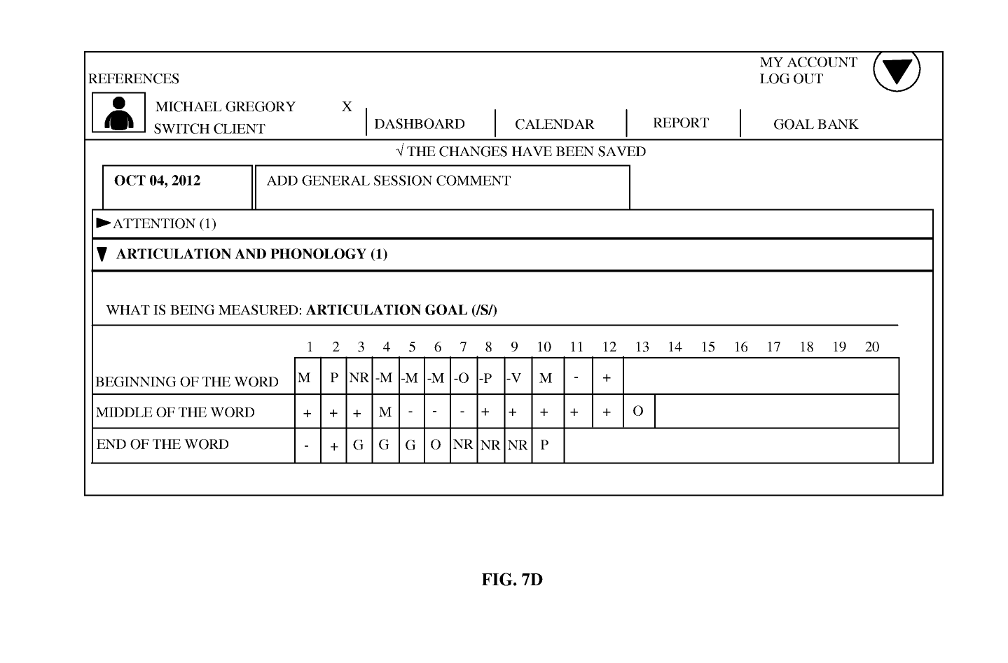

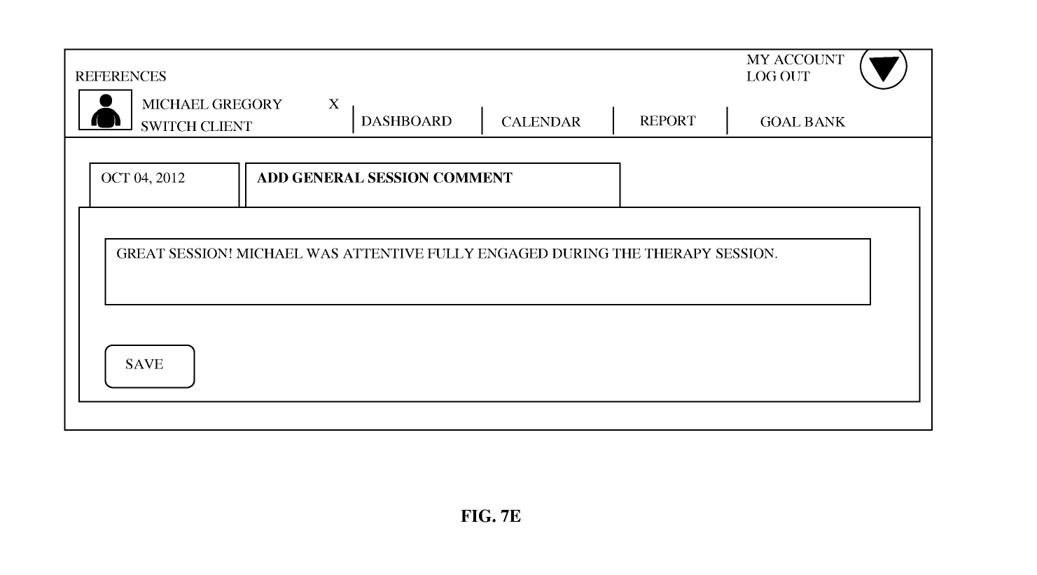

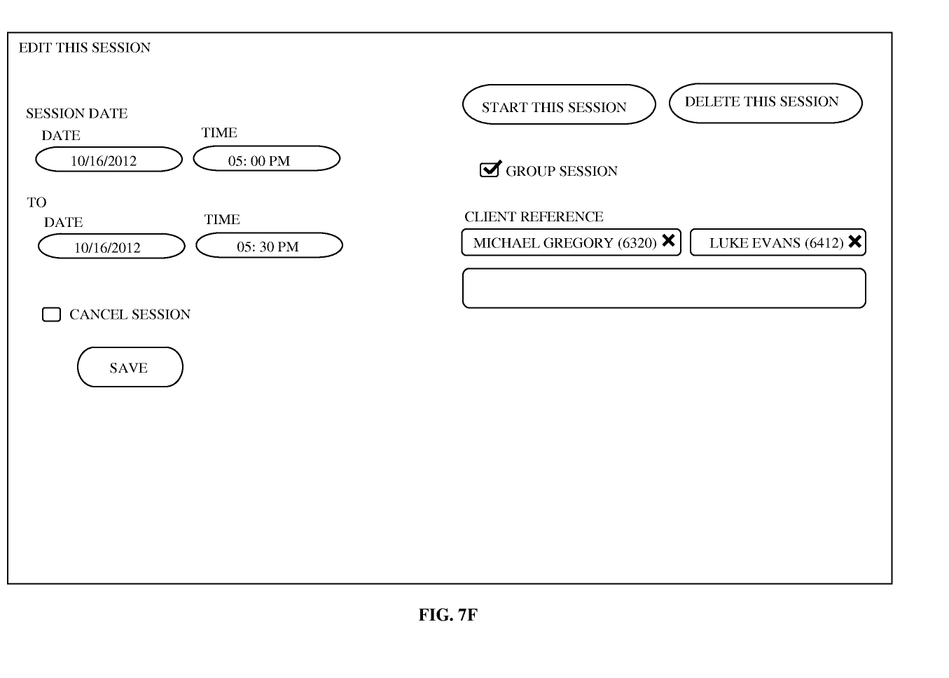

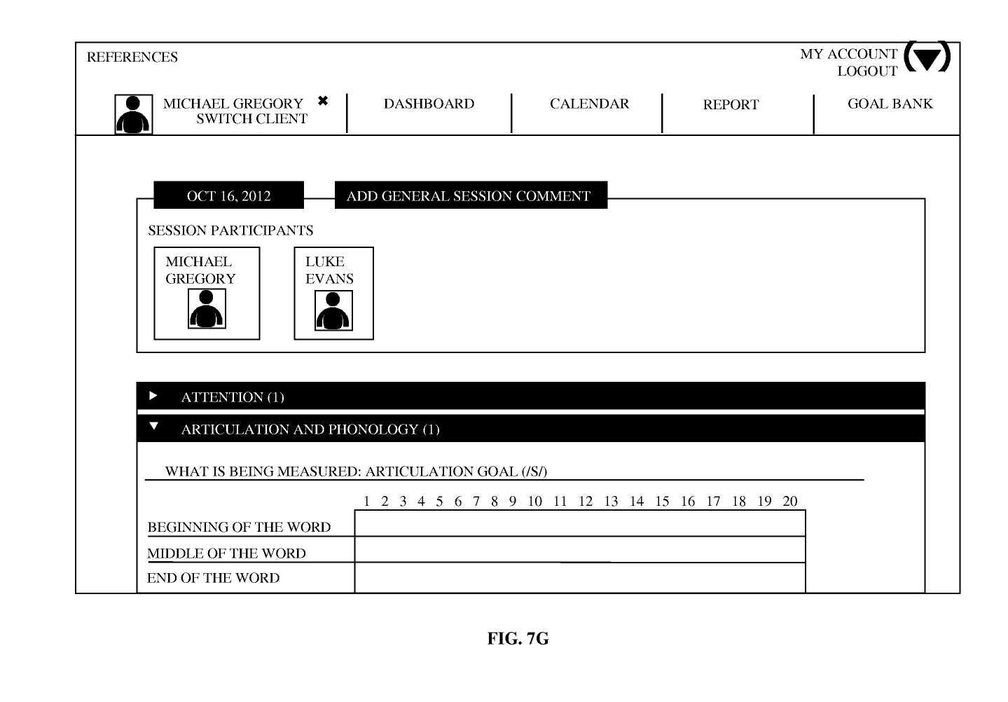

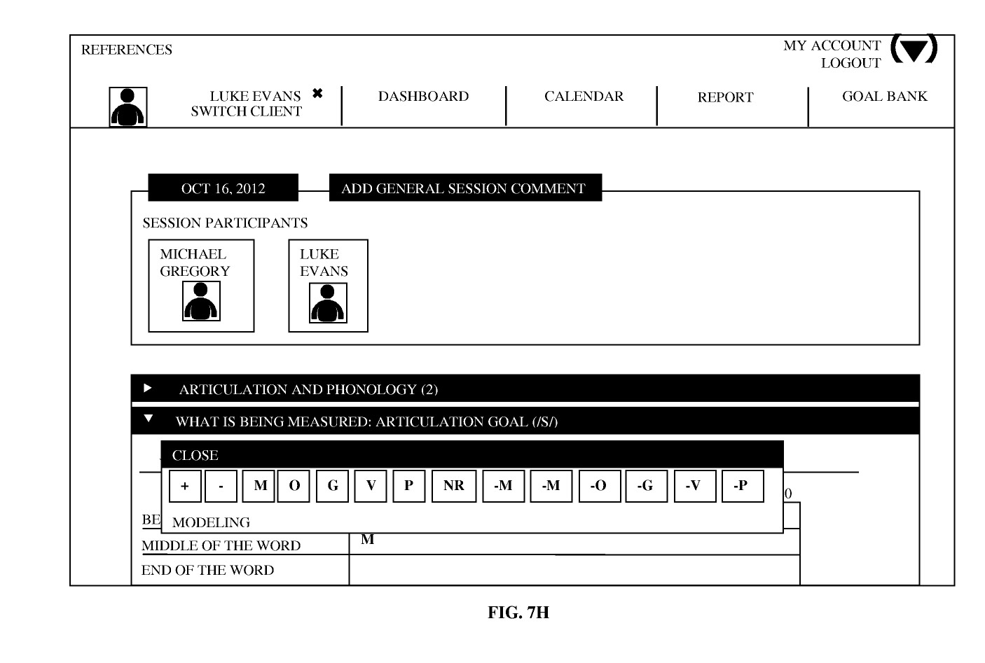

FIGS. 7A-7H exemplarily illustrate screenshots of a graphical user interface (GUI) of the therapy management application for acquiring data from scheduled therapy sessions of a client, for goal measurements defined by the therapy management application for goals to be achieved by the client. FIGS. 7A-7H exemplarily illustrate screenshots of the “caseload” interface for enabling the therapist to manage the client's goals. The therapy management application directs the therapist to a data tracking page of the “caseload” interface, when the therapist starts a therapy session. The therapy management application displays the goals generated for each of the therapist's clients on the data tracking page. In an embodiment, the therapy management application provides prewritten goals to the therapist. The prewritten goals allow the therapist to immediately begin assigning the prewritten goals to the client without the therapist having to start from scratch and create all the goals. The therapist can add a new goal via the “caseload” interface. The therapist can also customize a pre-written or pre-formatted goal using the therapy management application. The therapy management application enables the therapist to generate one or more goals for each of the clients using pre-formatted goals via a “goal bank” interface exemplarily illustrated in FIGS. 8F-8O. On selection of a goal by the therapist, the therapy management application assigns the selected goal to the client. The therapist can assign the selected goal to the client, for example, by clicking a “Save” button on the “caseload” interface on the open, selected client.

In an embodiment, the therapy management application assigns a goal to a client by first enabling the therapist to select the client and next by allowing the therapist to select a goal and add goal measurements to the goal type. The goal measurements are prewritten measurements for each goal which can be kept or deleted based on the therapist's discretion. On clicking a “Save” button on the “caseload” interface by the therapist, the therapy management application saves the goals within the individual client's profile and displays the goals in the “goals” section of the client's profile page when the therapist starts a therapy session. In an embodiment, the therapy management application enables the therapist to add new goal measurements and delete undesired goal measurements.

In an embodiment, the therapy management application provides an option to archive and restore goals that are assigned to a client from an archive. When the client has reached a specific goal, that is, when the client has achieved success with that goal, the therapy management application enables the therapist to archive the goal so that the archived goal no longer appears on the data tracking page of the client's profile. Although the goal is archived, the therapy management application stores all the past data and notes within the client's profile page for future access by the therapist.

The therapy management application displays performance indicators, for example, “+”, “O”, “M”, etc., for each of the goal categories used for tracking the progress of the client as exemplarily illustrated in FIGS. 7C-7D and FIG. 7H. When the therapist selects a row of a goal category, the therapy management application expands the row to reveal the different goal measurements and corresponding performance indicators in a particular goal category. The therapy management application then closes all other open goal categories. The therapy management application provides an unlimited number of columns on the data tracking page. The therapist can scroll left or right on the data tracking page if the therapist requires additional columns.

FIGS. 7C-7D exemplarily illustrates a screenshot of the data tracking page of the “caseload” interface displaying the performance indicators provided for goal measurements. When quick record buttons displayed on the data tracking page are open, the therapy management application highlights the next available cell. Upon selection of a performance indicator by the therapist, the therapy management application populates the highlighted cell with the selection, removes the highlight on the highlighted cell, and highlights the next cell. When the therapist selects a performance indicator, the therapy management application displays the definition of the selected performance indicator on the “caseload” interface. Moreover, the therapy management application allows the therapist to select a group therapy session and track data from the selected group.

In an example, the therapy management application defines goal measurements, for example, “auditory”, “visual”, “sustained attention”, “alternating attention”, “selective attention”, “divided attention”, etc., within a sub-category “Attention”, as exemplarily illustrated in FIG. 7A, for evaluating different levels of a client's attention span. During a therapy session with a client, the therapist may enter data for each of the defined goal measurements via the GUI. In another example, the therapy management application defines goal measurements, for example, “beginning of the word”, middle of the word”, “end of the word”, etc., within a sub-category “articulation and phonology”, as exemplarily illustrated in FIG. 7B, for evaluating a client's articulation. The therapist may then assign performance indicators, for example, “+”, “−”, “M”, “O”, “G”, “V”, “P”, “NR”, “−M”, “−O”, “−G”, “−V”, “−P”, etc., as exemplarily illustrated in FIGS. 7C-7D, for each of the defined goal measurements. The assigned performance indicators allow the therapy management application to track the performance of each of the clients for each of the assigned goals. At the end of a therapy session, the therapist may save the data entered during the therapy session using a “Save” button as exemplarily illustrated in FIG. 7E. The therapist may also edit details of the therapy session, enter additional clients for a group therapy session as exemplarily illustrated in FIG. 7F.

FIGS. 7F-7H exemplarily illustrates screenshots of the “caseload” interface for toggling between different clients of the therapist. For example, the therapy management application enables the therapist to toggle between client profiles in a group therapy session and enter data, assign performance indicators to goal measurements, etc., for respective clients via the “caseload” interface.

FIGS. 8A-8O exemplarily illustrate screenshots of a graphical user interface (GUI) of the therapy management application for assigning goals, editing goals, adding new goals based on therapy sessions scheduled and conducted for clients. FIGS. 8A-8E exemplarily illustrate screenshots of a “reference” interface provided by the therapy management application. In an embodiment, the therapy management application provides a collection of reference documents via the “reference” interface as disclosed in the detailed description of FIG. 2. FIG. 8A exemplarily illustrates a screenshot of the “reference” interface displaying milestones under the category “Milestones by Age”. The sub-categories for the category “Milestones by Age” comprise, for example, “first 3 months”, “4-6 months”, “6-12 months”, “12-18 months”, “18-24 months”, “2-3 years”, etc. A therapist may select the sub-category “first 3 months” and view reference data, for example, “becomes startled at loud noises”, “is soothed by calm gentle noises”, etc., for the sub-category “first 3 months” via the “reference” interface as exemplarily illustrated in FIG. 8A.

FIG. 8B exemplarily illustrates a screenshot of the “reference” interface displaying expectations under the category “Expectations by Grade”. The sub-categories for the category “Expectations by Grade” comprise, for example, “kindergarten”, “first grade”, “second grade”, “third grade”, “fourth grade”, “fifth grade”, etc. A therapist may select the sub-category “kindergarten” and view reference data, for example, “By the end of kindergarten, children should be able to performance 1-2 simple directions in a sequence, be understood by most people, know how a book works, etc.” via the “reference” interface as exemplarily illustrated in FIG. 8B. FIG. 8C exemplarily illustrates a screenshot of the “reference” interface displaying a glossary of terms under the category “Glossary of Terms”. The sub-categories for the category “Glossary of Terms” comprise, for example, “alaryngeal voice”, “alternative augmentative communication”, “aphasia”, “aphonia”, etc. A therapist may select the sub-category “aphasia” and view the definition of the term “aphasia” via the “reference” interface as exemplarily illustrated in FIG. 8C. FIG. 8D exemplarily illustrates a screenshot of the “reference” interface displaying states of a country, for example, the United States of America (USA) under a category “Select your State”. A therapist may select the sub-category “California” and view reference data, for example, expectations and standards of general education, extended standards, speech and language information, etc., associated with California via the “reference” interface as exemplarily illustrated in FIG. 8D. FIG. 8E exemplarily illustrates a screenshot of the “reference” interface displaying a web link that provides information, for example, on content standards defined by the California State Board of Education.

FIGS. 8F-8O exemplarily illustrate screenshots of a “goal bank” interface of the therapy management application. The therapy management application displays the goal categories and corresponding goal measurements via the “goal bank” interface. For example, when the therapist selects one of the goal categories, the therapy management application displays a sub-menu that displays the “goal types” or sub-categories. The goal types are pre-written and are customizable. The therapy management application displays fields, for example, “Annual Goals”, “Benchmarks”, “Goal measurements”, etc., for each of the goal types as exemplarily illustrated in FIG. 8F. As used herein, the term “annual goals” refer to goals set for a client that are to be achieved within a year. The annual goals field comprises pre-formatted goals that include form fields that allow the therapist to populate the pre-formatted goals with the therapist's own needs. The therapy management application pre-formats every common goal and is configured to make it as quick as possible for the therapist to input the client's needs and begin tracking data. Also, as used herein, the term “benchmarks” refer to sub goals set within a year, designed to help a client achieve incremental success as the client works towards the client's annual goal. The benchmarks field comprises pre-formatted goals that include form fields that allow the therapist to populate the pre-formatted goal with the therapist's own needs. In an example, the therapist may select a goal category “Autism spectrum” and a goal type or sub-category “communication on repair” and then set up an annual goal, benchmarks, and define goal measurements on the “goal bank” interface as exemplarily illustrated in FIG. 8F.

The variables and logic of the pre-formatted goals are contained, for example, in a Microsoft Excel® spreadsheet. The goal measurements refer to specific items that the therapist is measuring within the goal. For example, if the meta-category is “semantics”, and the sub-category is “use new vocabulary words”, then the therapist may choose to add the goal measurements of “household items”, “animals”, “body parts”, etc. These goal measurements are what the therapist will track data on to determine how the client is progressing within a given goal. The therapist can choose to add more benchmarks if there are more than one benchmark necessary to meet the annual goal by clicking on an “Add more benchmarks” button provided on the “goal bank” interface as exemplarily illustrated in FIGS. 8F-8H and FIGS. 8J-8O. Furthermore, the therapist can define more goal measurements by clicking on an “Add more measurements” button provided on the “goal bank” interface as exemplarily illustrated in FIGS. 8F-8H and FIGS. 8J-8O.

In an embodiment, the therapy management application determines variables for the pre-formatted goals that each of the goals need to contain. Moreover, the therapy management application determines the values of the variables for the pre-formatted goals, as exemplarily illustrated in FIGS. 8G-8H. Consider an example of a pre-formatted goal created by the therapy management application as, “By [Date], [Name] will recognize when communication has been misinterpreted, persist, and provide clarification, and/or request clarification of a partner's message, in [Minimum] out of [Maximum] trials, with [Accuracy %], with [Level of Cues], as measured by data collection.” When the therapist clicks on the bracketed information, the therapist is prompted to choose from a popup menu of predetermined variables, for example, “independently (no cues)”, “minimal cues”, “mild cues”, “moderate cues”, “maximum cues”, etc., for the [Level of Cues] field as exemplarily illustrated in FIG. 8G, or input a date for the [Date] field using a pop-up calendar, or input a number “20” for 20% for the [Accuracy %] field as exemplarily illustrated in FIG. 8H. FIG. 8I exemplarily illustrates a preformatted goal generated by the therapy management application for the goal category “autism spectrum”.

Consider another example of a pre-formatted goal created by the therapy management application as, “By [Date], [Name] will increase overall intelligibility by producing [Target sounds] at [Context] in [Minimum] out of [Maximum] trials, with [Accuracy %], with [Level of Cues], during [Setting] activities, as measured by the therapist data collection.” When the therapist clicks on the bracketed information, the therapist is prompted to either input a free-form value such as a number “80” for 80% or choose from a popup menu of predetermined variables such as “Conversation” from a “Context” field whose choices are “Isolation”, “Single Words”, “Phrases”, “Sentences”, and “Conversation”. The therapy management application thus makes the generation of the goals simpler, faster, and more standardized.

FIGS. 8F-8L exemplarily illustrate screenshots of the “goal bank” interface of the therapy management application for assigning a goal to a client, by customizing the drop-down fields and clicking “Save”. In an embodiment, the therapist can select “Show assigned goals only” from the “goal bank” interface as exemplarily illustrated in FIG. 8L for displaying each of the selected goals, benchmarks, and goal measurements of the opened client. FIGS. 8K-8L exemplarily illustrate screenshots of the “goal bank” interface for enabling the therapist to generate customized goals. The therapy management application provides a “+custom goal” button, for example, at the top of each submenu as exemplarily illustrated in FIG. 8K, that enables the therapist to add a custom goal. The therapy management application provides a “Goal Title” field on the goal bank” interface as exemplarily illustrated in FIGS. 8K-8L, for enabling the therapist to enter the title of the goal. The therapist may then enter a description of the annual goal, a benchmark, and goal measurements in text fields provided on the goal bank” interface as exemplarily illustrated in FIG. 8L. The therapy management application provides a “Delete Goal Title” field on the “goal bank” interface for enabling the therapist to delete a goal. In an example, for the goal categories “Attention” and “Articulation And Phonology”, the therapist sets up an annual goal, benchmarks, and defines goal measurements as exemplarily illustrated in FIG. 8M and FIG. 8N respectively. The therapy management application provides an option to archive goals using an “Archive this” button provided on the “goal bank” interface as exemplarily illustrated in FIG. 8N. The therapy management application provides a “restore from archive” button on the “goal bank” interface as exemplarily illustrated in FIG. 8O, for restoring the data acquired from the scheduled training sessions from an archive.

FIG. 8N exemplarily illustrates a pre-formatted benchmark generated by the therapy management application for the goal category “articulation and phonology” and the sub-category “articulation”. The pre-formatted benchmark comprises form fields that allow the therapist to populate a benchmark based on the client's needs. The pre-formatted benchmark is prewritten and designed to allow the therapist to input the client's needs and begin tracking data quickly and easily. The therapy management application enables the therapist to generate a benchmark using the pre-formatted benchmark, for example, by entering custom values and variables in the blank spaces of the pre-formatted benchmark. The therapist can enter the custom values and the variables in custom fields for an assigned annual benchmark for a given client by selecting values from a popup menu. For example, the therapist may create a benchmark that recites the client will improve speech intelligibility in “4” out of “5” trials with “80%” accuracy with “moderate cues (50-79%) of the time” as exemplarily illustrated in FIGS. 8N-8O. The therapist may select “Show all goals” generated by the therapy management application from the “goal bank” interface as exemplarily illustrated in FIGS. 8M-8O for displaying all the generated goals, benchmarks, and goal measurements defined by the therapy management application.

FIGS. 9A-9G exemplarily illustrate screenshots of a graphical user interface (GUI) of the therapy management application, showing generation and display of progress reports. FIG. 9A exemplarily illustrates a screenshot of a progress report for one date of data generated by the therapy management application in the form of a stacked bar graph. FIG. 9B, FIG. 9D, and FIG. 9F exemplarily illustrate screenshots of progress reports generated by the therapy management application in the form of line graphs, when a therapist selects a range of dates, for example, “Last Week”, “Last Month”, “Last 6-Months”, “All”, or a custom range of dates. FIG. 9C, FIG. 9E, and FIG. 9G represent the line representations of performance indicators in the line graphs exemplarily illustrated in FIG. 9B, FIG. 9D, and FIG. 9F respectively, along with data accuracies. FIGS. 9A-9B, FIG. 9D, and FIG. 9F exemplarily illustrate screenshots of a “reports” interface for enabling the therapist to generate and manage progress reports of the clients. When the therapist selects a goal category, the therapy management application displays progress reports based on the goal category and the goal type on the “reports” interface as exemplarily illustrated in FIGS. 9A-9B, FIG. 9D, and FIG. 9F. The therapy management application displays the progress reports, for example, as color bar graphs generated from the collected data and the performance indicators, for example, +, −, M, G, O, V, P, etc., for a particular goal. The therapy management application allows the therapist to choose between a stacked bar graph, an itemized bar graph, or a line graph, input the date range for which the therapist wishes to generate the progress report, enlarge the bar graph or the line graph for easier viewing, etc. The annual goals that are assigned to the client appear, for example, at the top of the progress report. The therapist can also check boxes, for example, “benchmarks” and “comments” to include the goal benchmarks and comments associated with the goals in the progress reports.

In an embodiment, the therapy management application provides options, for example, “Save”, “Email/Export”, “Print”, etc., on the “reports” interface. When the therapist clicks on the “Save” option, the therapy management application saves the progress report, for example, in a memory unit of the therapist's electronic device. When the therapist clicks on the “Email/Export” option, the therapy management application exports an image of the progress report along with comma separated values (CSV) to an email composing interface of the therapy management application. The email composing interface of the therapy management application enables the therapist to email the progress report from the therapy management application. When the therapist clicks on the “Print” option, the therapy management application prints a copy of the progress report, for example, via an output device. In an embodiment, the therapy management application displays a popup with a corresponding value when the therapist touches a graph in the progress report, for example, on a touch screen display unit of the therapist's electronic device.

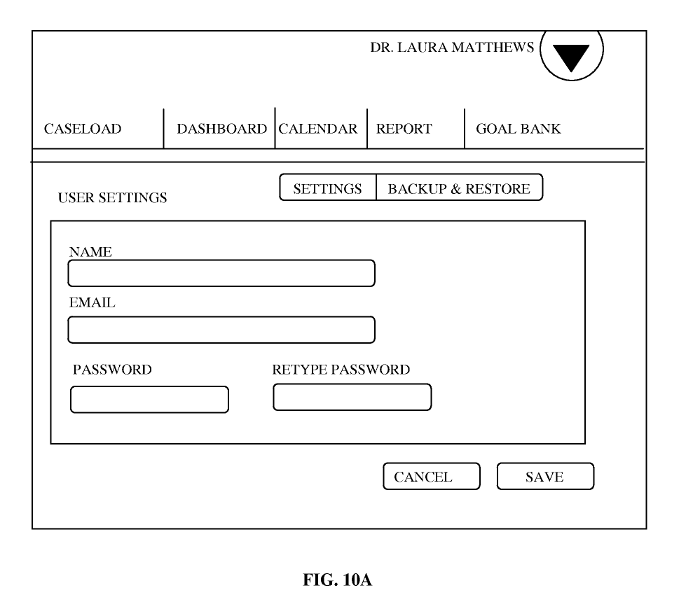

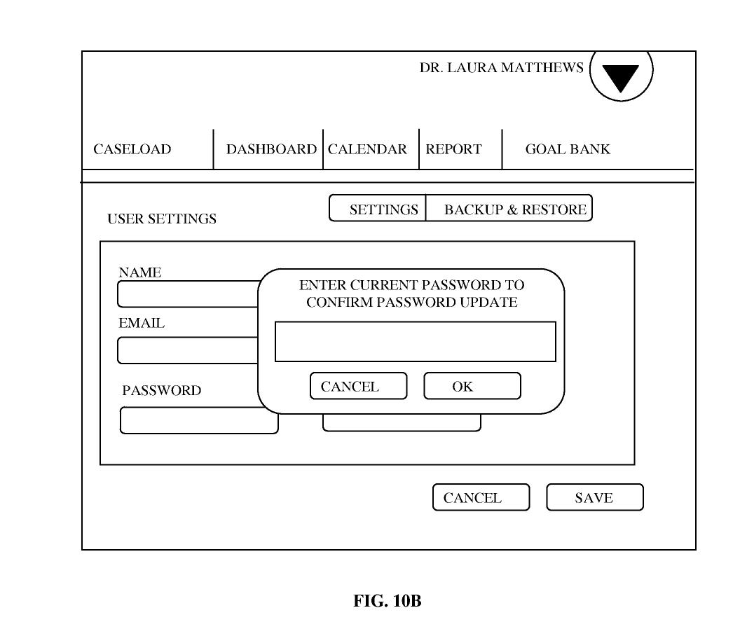

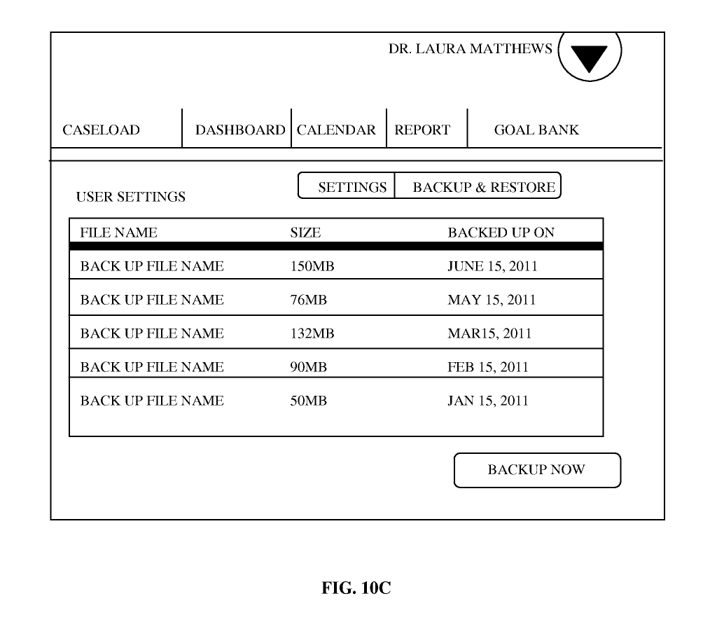

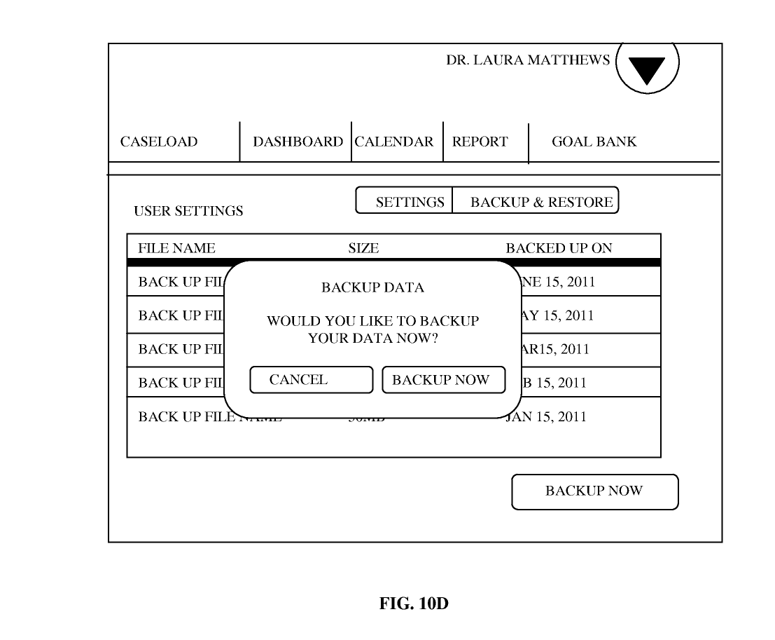

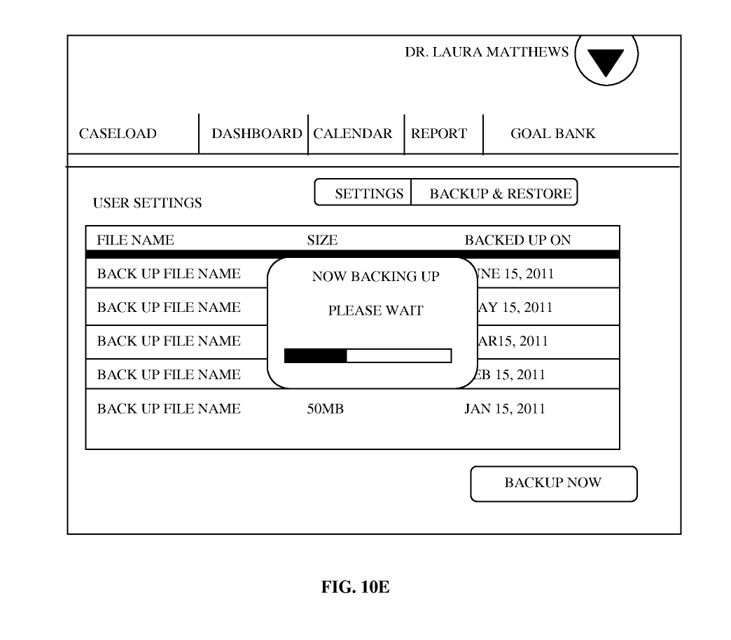

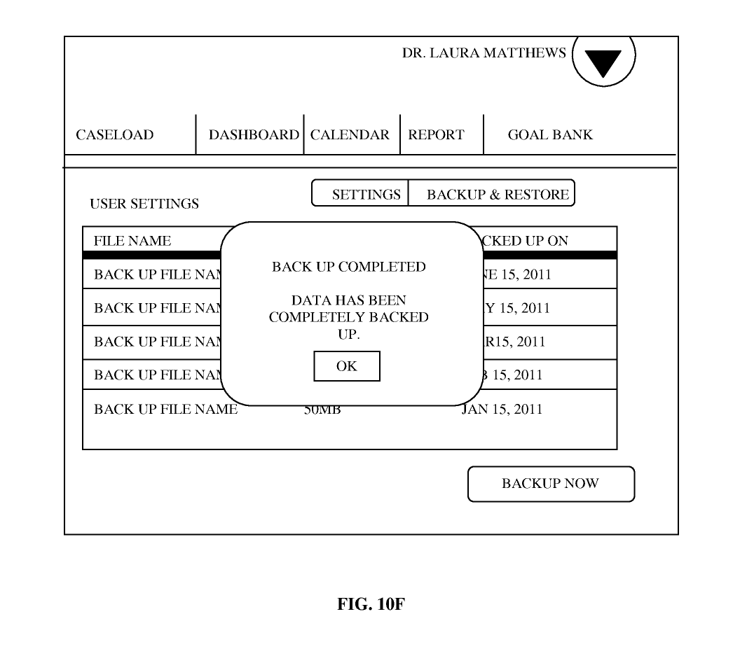

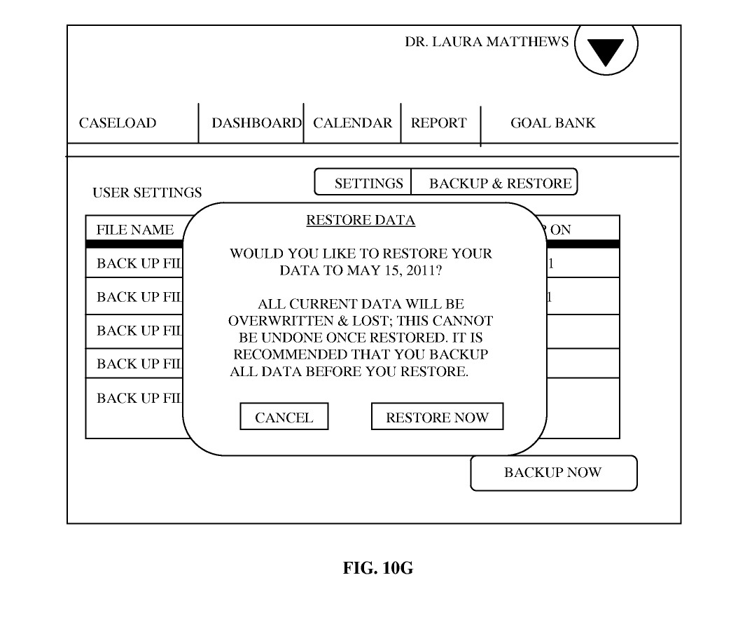

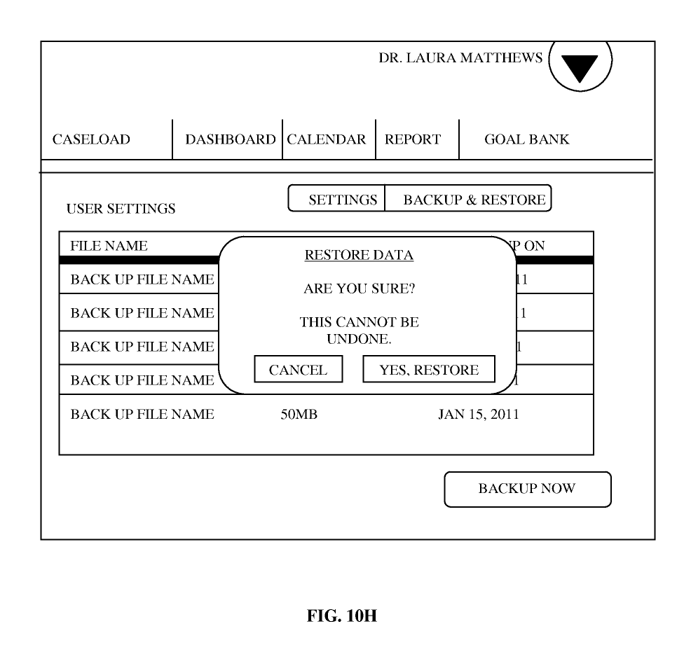

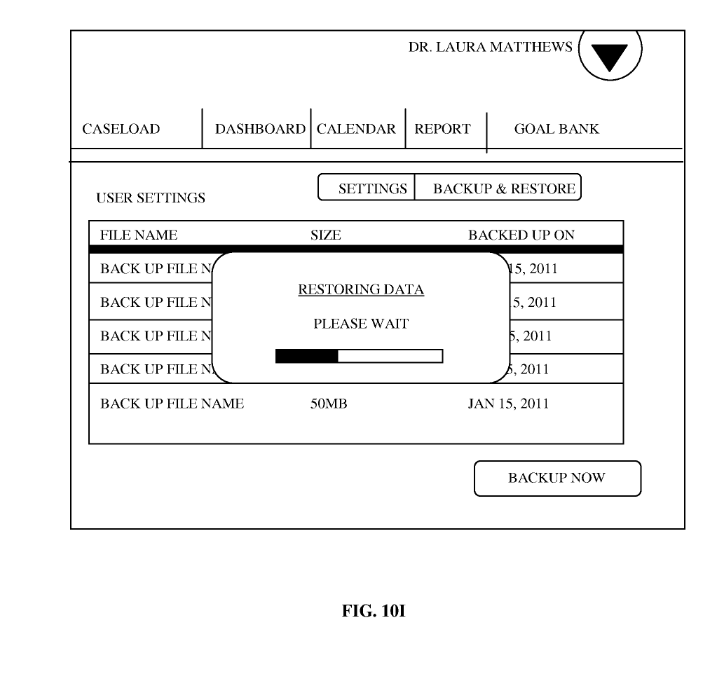

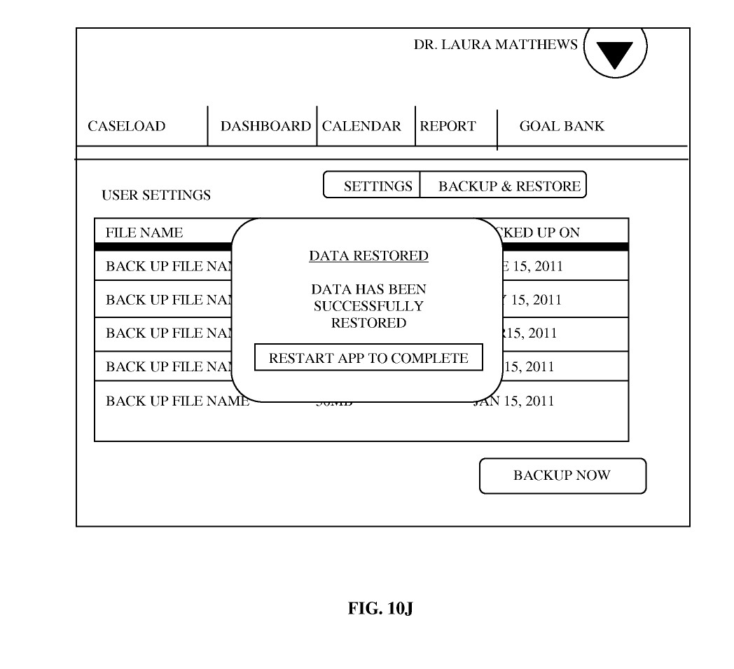

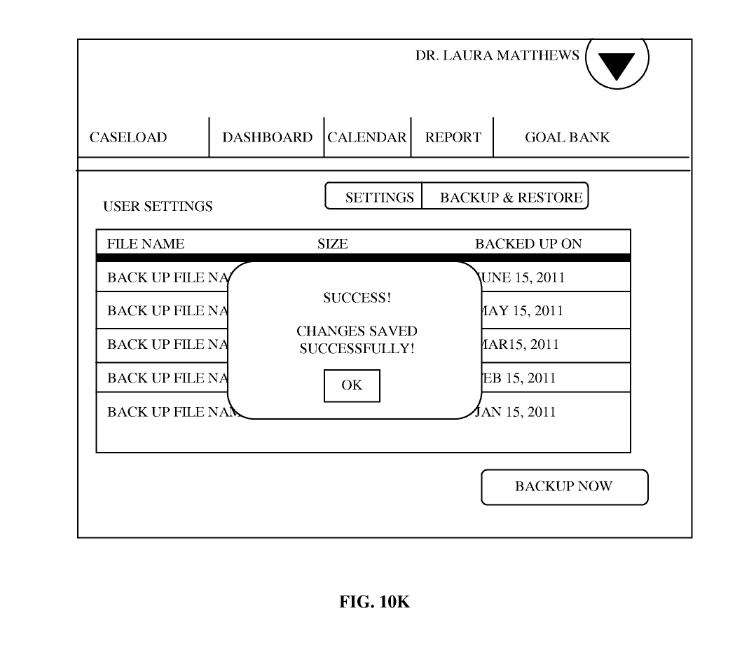

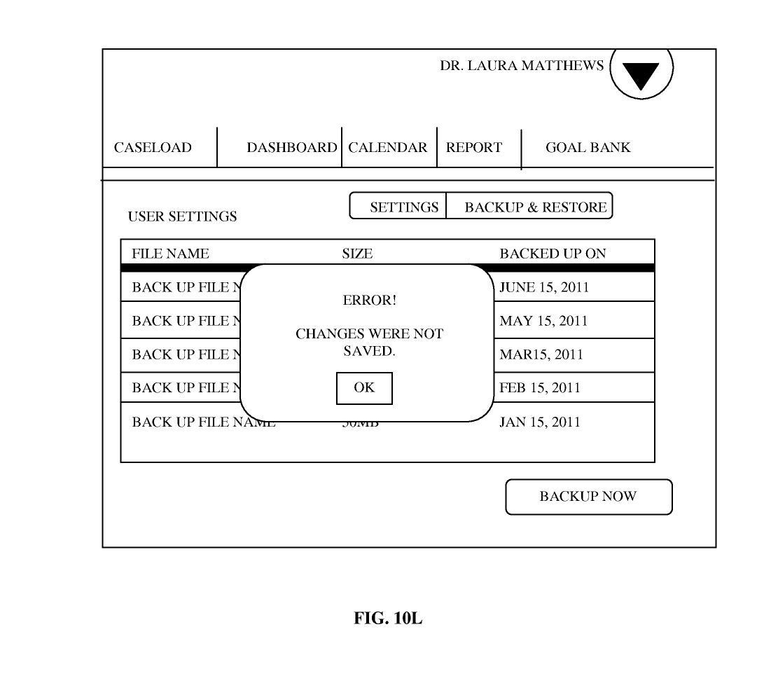

FIGS. 10A-10L exemplarily illustrate screenshots of a graphical user interface (GUI) of the therapy management application for backing up and restoring collected and tracked data acquired from scheduled therapy sessions. FIG. 10A exemplarily illustrates a screenshot of the GUI displaying a “user settings” page for updating the therapist's login information. A “settings” link and a “backup and restore” link are also provided on the “user settings” page. The therapist can change the login information, for example, the password by clicking the “settings” link on the “user settings” page. For updating the password, the therapy management application displays a field for entering a current password on the “user settings” page as exemplarily illustrated in FIG. 10B, to confirm the password update.

In an embodiment, the therapy management application provides an option to backup data required by the therapist. The therapist may backup and restore data, for example, by clicking the “backup and restore” link on the “user settings” page as exemplarily illustrated in FIG. 10C. The therapy management application backs up data, for example, by making copies of the data which may be used to restore the original data after a data loss event. The therapist can instruct the therapy management application to back up the data by clicking on a “Backup Now” button provided on the “user settings” page exemplarily illustrated in FIGS. 10C-10D. When the therapist clicks the “Backup Now” button, the therapy management application creates a backup of the therapist's data. The therapy management application displays a message, for example, “Now Backing Up” as exemplarily illustrated in FIG. 10E, while the therapy management application backs up the data, for example, by storing a back up copy of the data in a secure database network. Upon completion of backing up the data, the therapy management application displays, for example, a “Backup Completed” message as exemplarily illustrated in FIG. 10F.

In an embodiment, the therapy management application provides an option to restore the data required by the therapist. The therapy management application displays, for example, a “Restore Data” popup menu exemplarily illustrated in FIG. 10G, for restoring the data. The therapy management application restores all the settings and the therapist's clients from a particular date. The therapy management application then confirms whether the therapist wants to restore the data by displaying a confirmation message as exemplarily illustrated in FIG. 10H. On receiving confirmation from the therapist to restore the data, the therapy management application restores the data. The therapy management application displays a message, for example, “Restoring Data” as exemplarily illustrated in FIG. 10I, during the process of restoring the data. The therapy management application displays messages as exemplarily illustrated in FIGS. 10J-10K on successfully restoring the data. For an unsuccessful data restore process, the therapy management application displays an error message as exemplarily illustrated in FIG. 10L.

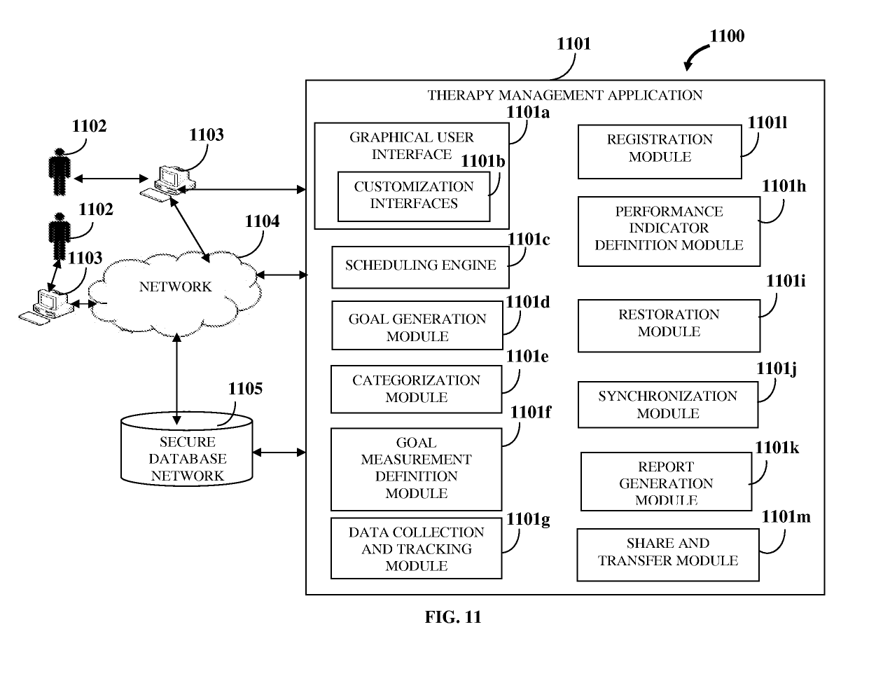

FIG. 11 exemplarily illustrates a computer implemented system 1100 for managing and tracking therapy sessions. The computer implemented system 1100 disclosed herein comprises a therapy management application 1101 accessible to an electronic device 1103 of an evaluator 1102, herein referred to as a “therapist” in multiple access modes, for example, a wireless access mode via a network 1104, a wired access mode, an online access mode via the network 1104, an offline access mode, etc. The network 1104 is, for example, the internet, an intranet, a local area network, a wide area network, a communication network implementing Wi-Fi® of the Wireless Ethernet Compatibility Alliance, Inc., a cellular network, a mobile communication network, etc. The mobile communication network is, for example, a global system for mobile communications (GSM) network, a general packet radio service (GPRS) network, a third generation (3G) mobile communication network, a fourth generation (4G) mobile communication network, etc. The therapy management application 1101 is accessible on an electronic device 1103 by downloading the therapy management application 1101 on the electronic device 1103 or by accessing a web platform that hosts the therapy management application 1101. The therapy management application 1101 is executable by at least one processor configured to execute modules 1101a, 1101b, 1101c, 1101d, 1101e, 1101f, 1101g, 1101h, 1101i, 1101j, 1101k, 1101l, and 1101m of the therapy management application 1101. A non-transitory computer readable storage medium is communicatively coupled to the processor. The non-transitory computer readable storage medium is configured to store the modules 1101a, 1101b, 1101c, 1101d, 1101e, 1101f, 1101g, 1101h, 1101i, 1101j, 1101k, 1101l, and 1101m of the therapy management application 1101. The therapy management application 1101 comprises a graphical user interface (GUI) 1101a, a registration module 1101l, a scheduling engine 1101c, a goal generation module 1101d, a categorization module 1101e, a goal measurement definition module 1101f, a data collection and tracking module 1101g, a performance indicator definition module 1101h, a restoration module 1101i, a synchronization module 1101j, a report generation module 1101k, and a share and transfer module 1101m. The computer implemented system 1100 disclosed herein further comprises a secure database network 1105 with advanced encryption standard (AES) 256-bit encryption, regular backups, and firewall protection, in compliance with the Health Insurance Portability and Accountability Act (HIPAA) of 1996. The GUI 1101a comprises, for example, a set of a web pages hosted on a server or a network of servers associated with the therapy management application 1101.

The registration module 1101l, registers a therapist 1102 via the GUI 1101a. When a therapist 1102 accesses the therapy management application 1101, the registration module 1101l prompts the therapist 1102 to register with the therapy management application 1101 via the GUI 1101a if the therapist 1102 is unregistered. When the therapist 1102 wishes to register, the registration module 1101l displays a form to be filled by the therapist 1102, requesting for information, for example, a name, an email address, a password, a unique user name, etc. The registration module 1101l also displays forms for acquiring membership details associated with registering the therapist 1102 as a member of the therapy management application 1101. On successful registration of the therapist 1102, the data collection and tracking module 1101g prompts the therapist 1102 to provide information associated with one or more clients. The data collection and tracking module 1101g collects information associated with each of the clients and stores the client information in the secure database network 1105.

The scheduling engine 1101c schedules therapy sessions on behalf of the therapist 1102 with multiple clients and manages the therapist's 1102 appointments with multiple clients. The scheduling engine 1101c creates schedules for individual therapy sessions and group therapy sessions. The scheduling engine 1101c enables the therapist 1102 to modify previously entered appointments, add a new appointment in an empty time slot on the calendar, reschedule an appointment, etc. The goal generation module 1101d generates one or more goals for each of the clients based on an evaluation of each of the clients during the therapy sessions carried out by the therapist 1102.

The categorization module 1101e categorizes each of the generated goals associated with each of the clients into one or more of multiple goal categories. The categorization module 1101e defines the goal categories based on goals in a field of therapy. The categorization module 1101e categorizes and organizes goals in the field of therapy into multiple goal categories or meta-categories. The meta-categories are commonly used, for example, in the field of speech and language therapy, physical therapy, occupational therapy, behavioral therapy, special education, etc. The meta-categories are, for example, articulation and phonology, syntax and morphology, semantics, pragmatics, fluency, voice, preschool goals: expressive, preschool goals: receptive, attention, autism spectrum, orientation, dysphagia, problem solving, reading, motor speech, memory, occupational therapy, physical therapy, behavioral therapy, augmentative and alternative communication (AAC), executive function, social, emotional, special education, etc. The categorization module 1101e further categorizes the meta-categories into sub-categories. For example, if a meta-category is “semantics”, then “increasing vocabulary” is a sub-category within the area of semantics.

The goal measurement definition module 1101f defines one or more goal measurements for each of the generated goals within each of the goal categories. The performance indicator definition module 1101h defines multiple performance indicators for tracking the performance of each of the clients for each of the generated goals and goal measurements defined by the goal measurement definition module 1101f. The performance indicators are, for example, benchmarks against which the progress or the performance of clients is measured. The data collection and tracking module 1101g collects data acquired from the scheduled therapy sessions, for example, an individual therapy session or a group therapy session of each of the clients for each of the defined goal measurements via the GUI 1101a. The data collection and tracking module 1101g tracks the collected data for each of the defined goal measurements for each of the clients using multiple performance indicators defined by the performance indicator definition module 1101h. The data collection and tracking module 1101g controls access to the collected and tracked data acquired from the scheduled therapy sessions of each of the clients for each of the defined goal measurements.

The GUI 1101a comprises one or more customization interfaces 1101b configured to acquire inputs from the therapist 1102, for example, for addition of one or more goal categories, addition of one or more goal measurements within the goal categories, customization of one or more performance indicators, and the collection of the data associated with the scheduled therapy sessions. The customization interfaces 1101b of the therapy management application 1101 enable the therapist 1102 to customize goals and goal measurements within various goal categories for each of the clients.

The synchronization module 1101j is configured to automatically synchronize the collected and tracked data acquired from the scheduled therapy sessions of each of the clients for each of the defined goal measurements in an offline access mode, with the collected and tracked data acquired from the scheduled therapy sessions of each of the clients for each of the defined goal measurements in an online access mode. The data collected and tracked when the therapy management application 1101 is used in an offline access mode is stored in the database network 1105. The therapy management application 1101 communicates with the database network 1105 via a wired mode of communication or a wireless mode of communication via the network 1104. When the therapy management application 1101 is accessed in an online access mode the synchronization module 1101j synchronizes the data collected and tracked in the offline access mode with the data collected and tracked in the online access mode in order to maintain continuity with regard to the therapy sessions associated with each of the clients.

The report generation module 1101k generates progress reports based on performance of each of the clients for each of the generated goals using the collected and tracked data. The report generation module 1101k is configured to generate the progress reports in one or more of multiple graphical representations, for example, in the form of bar graphs, line graphs, etc., based on time criteria. The generated progress reports are stored in the database network 1105 for future reference. The database network 1105 is configured to store and dynamically update the data acquired from the scheduled therapy sessions and the generated progress reports of each of the clients for each of the generated goals based on a preconfigured time interval. The therapist 1102 can choose a particular date to view a progress report based on the scheduled therapy session carried out on the particular date or wish to generate progress reports based on therapy sessions conducted over a period of time.

The restoration module 1101i restores data that is collected and tracked and backed up and stored in the database network 1105. The restoration module 1101i is configured to restore the data acquired from the scheduled therapy sessions of each of the clients for a preconfigured time interval, on receiving an indication from the therapist 1102 via the GUI 1101a. The restoration module 1101i restores the data belonging to a particular time interval as configured by the therapist 1102. The share and transfer module 1101m is configured to selectively share and transfer one or more of profile information of one or more clients, the generated goals of one or more clients, the collected and tracked data acquired from the scheduled therapy sessions of one or more clients, and the generated progress reports of one or more of the clients for each of the generated goals among one or more evaluators 1102 via the network 1104.

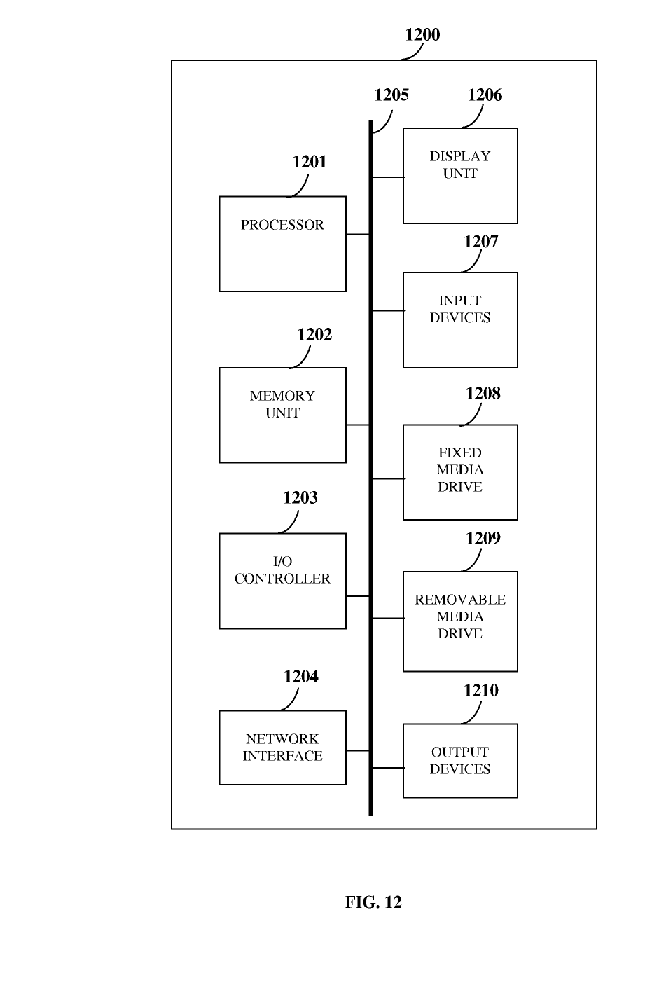

FIG. 12 exemplarily illustrates the architecture of a computer system 1200 employed by the therapy management application 1101 for managing and tracking therapy sessions. The therapy management application 1101 of the computer implemented system 1100 exemplarily illustrated in FIG. 11 employs the architecture of the computer system 1200 exemplarily illustrated in FIG. 12 for managing and tracking therapy sessions.

The therapy management application 1101 is executable on an electronic device 1103 via a network 1104, for example, a short range network or a long range network. The computer system 1200 of the electronic device 1103 comprises a processor 1201, a memory unit 1202 for storing programs and data, an input/output (I/O) controller 1203, a network interface 1204, a data bus 1205, a display unit 1206, input devices 1207, a fixed media drive 1208, a removable media drive 1209 for receiving removable media, output devices 1210, etc. The processor 1201 is an electronic circuit that executes computer programs. The memory unit 1202 is used for storing programs, applications, and data. For example, the registration module 1101l, the scheduling engine 1101c, the goal generation module 1101d, the categorization module 1101e, the goal measurement definition module 1101f, the data collection and tracking module 1101g, the performance indicator definition module 1101h, the restoration module 1101i, the synchronization module 1101j, the report generation module 1101k, the share and transfer module 1101m, etc., are stored in the memory unit 1202 of the computer system 1200 of the electronic device 1103. The memory unit 1202 is, for example, a random access memory (RAM) or another type of dynamic storage device that stores information and instructions for execution by the processor 1201. The memory unit 1202 also stores temporary variables and other intermediate information used during execution of the instructions by the processor 1201. The computer system 1200 further comprises a read only memory (ROM) or another type of static storage device that stores static information and instructions for the processor 1201.

The network interface 1204 enables connection of the computer system 1200 to the network 1104. For example, the electronic device 1103 hosting the therapy management application 1101 connects to the network 1104 via the network interface 1204. The network interface 1204 comprises, for example, an infrared (IR) interface, an interface implementing Wi-Fi® of the Wireless Ethernet Compatibility Alliance, Inc., a universal serial bus (USB) interface, a local area network (LAN) interface, a wide area network (WAN) interface, etc. The I/O controller 1203 controls input actions and output actions performed by the therapy management application 1101. The data bus 1205 permits communications between the modules, for example, 1101a, 1101b, 1101c, 1101d, 1101e, 1101f, 1101g, 1101h, 1101i, 1101j, 1101k, 1101l, 1101m, etc., of the therapy management application 1101.

The display unit 1206 of the electronic device 1103, via the GUI 1101a, displays, for example, displays interfaces, icons, user interface elements such as text fields, checkboxes, text boxes, popup menus, etc., for allowing the therapist 1102 to enter information associated with the therapy sessions and the clients, to customize goals, to define goal measurements, etc., and for prompting the therapist 1102 to provide information, etc. The input devices 1207 are used for inputting data into the computer system 1200. The therapist 1102 uses the input devices 1207 to provide inputs to the therapy management application 1101. For example, a therapist 1102 enters information associated with the therapy sessions and the clients, customizes goals and goal measurements, assigns performance indicators to the goal measurements, etc., on the therapy management application 1101 via the GUI 1101a using the input devices 1207. The input devices 1207 are, for example, a keyboard such as an alphanumeric keyboard, a joystick, a pointing device such as a computer mouse, a touch pad, a light pen, etc. The output devices 1210 output the results of operations performed by the therapy management application 1101. For example, the therapy management application 1101 displays a prompt window through the output devices 1210 to prompt the therapist 1102 to provide information associated with the therapy sessions and the clients, to prompt the therapist 1102 to update information associated with the clients, etc.

Computer applications and programs are used for operating the computer system 1200. The programs are loaded onto the fixed media drive 1208 and into the memory unit 1202 of the computer system 1200 via the removable media drive 1209. In an embodiment, the computer applications and programs may be loaded directly via the network 1104. Computer applications and programs are executed by double clicking a related icon displayed on the display unit 1206 using one of the input devices 1207.

The computer system 1200 employs an operating system for performing multiple tasks. The operating system is responsible for management and coordination of activities, and sharing of resources of the computer system 1200. The operating system further manages security of the computer system 1200, peripheral devices connected to the computer system 1200, and network connections. The operating system employed on the computer system 1200 recognizes, for example, inputs provided by the user using one of the input devices 1207, the output display, files, and directories stored locally on the fixed media drive 1208, for example, a hard drive. The operating system on the computer system 1200 executes different programs using the processor 1201. The processor 1201 retrieves instructions for executing the modules, for example, 1101b, 1101c, 1101d, 1101e, 1101f, 1101g, 1101h, 1101i, 1101j, 1101k, 1101l, 1101m, etc., of the therapy management application 1101 from the memory unit 1202. A program counter determines the location of the instructions in the memory unit 1202. The program counter stores a number that identifies the current position in the program of each of the modules, for example, 1101b, 1101c, 1101d, 1101e, 1101f, 1101g, 1101h, 1101i, 1101j, 1101k, 1101l, 1101m, etc., of the therapy management application 1101.

The instructions fetched by the processor 1201 from the memory unit 1202 after being processed are decoded. The instructions are stored in an instruction register in the processor 1201. After processing and decoding, the processor 1201 executes the instructions. For example, the registration module 1101l defines instructions for registering a therapist 1102 as a member with the therapy management application 1101. The scheduling engine 1101c defines instructions for scheduling therapy sessions with one or more clients. The goal generation module 1101d defines instructions for generating one or more goals for each of the clients based on an evaluation of each of the clients in the scheduled therapy sessions performed by the therapist 1102. The categorization module 1101e defines instructions for categorizing the generated goals for each of the clients into one or more of multiple goal categories. The categorization module 1101e defines instructions for defining the goal categories based on goals in a field of therapy. The goal measurement definition module 1101f defines instructions for defining one or more goal measurements for each of the generated goals within each of the goal categories. The data collection and tracking module 1101g defines instructions for collecting data acquired from the scheduled therapy sessions of each of the clients for each of the defined goal measurements via the GUI 1101a. The performance indicator definition module 1101h defines instructions for defining multiple performance indicators for tracking the performance of each of the clients for each of the generated goals and goal measurements. The data collection and tracking module 1101g defines instructions for tracking the collected data for each of the defined goal measurements using multiple performance indicators defined by the performance indicator definition module 1101h. The data collection and tracking module 1101g defines instructions for controlling access to the collected and tracked data acquired from the scheduled therapy sessions of each of the clients for each of the defined goal measurements.

The synchronization module 1101j defines instructions for automatically synchronizing the collected and tracked data acquired from the scheduled therapy sessions of each of the clients for each of the defined goal measurements in an offline access mode, with the collected and tracked data acquired from the scheduled therapy sessions of each of the clients for each of the defined goal measurements in an online access mode. The report generation module 1101k defines instructions for generating progress reports based on performance of each of the clients for each of the generated goals using the collected and tracked data. The report generation module 1101k defines instructions for generating the progress reports in one or more of multiple graphical representations, for example, in the form of bar graphs, line graphs, etc., based on time criteria. The restoration module 1101i defines instructions for restoring the data acquired from the scheduled therapy sessions of each of the clients for a preconfigured time interval, on receiving an indication from a therapist 1102 via the GUI 1101a. The share and transfer module 1101m defines instructions for selectively sharing and transferring one or more of the profile information of one or more clients, the generated goals of one or more clients, the collected and tracked data acquired from the scheduled therapy sessions of one or more clients, and the generated progress reports of one or more of the clients for each of the generated goals among one or more evaluators 1102 via the network 1104.

The processor 1201 of the computer system 1200 employed by the therapy management application 1101 retrieves the instructions defined by the registration module 1101l, the scheduling engine 1101c, the goal generation module 1101d, the categorization module 1101e, the goal measurement definition module 1101f, the data collection and tracking module 1101g, the performance indicator definition module 1101h, the restoration module 1101i, the synchronization module 1101j, the report generation module 1101k, and the share and transfer module 1101m of the therapy management application 1101, and executes the instructions for managing and tracking therapy sessions. At the time of execution, the instructions stored in the instruction register are examined to determine the operations to be performed. The processor 1201 then performs the specified operations. The operations comprise arithmetic operations and logic operations. The operating system performs multiple routines for performing a number of tasks required to assign the input devices 1207, the output devices 1210, and memory for execution of the modules, for example, 1101b, 1101c, 1101d, 1101e, 1101f, 1101g, 1101h, 1101i, 1101j, 1101k, 1101l, 1101m, etc., of the therapy management application 1101. The tasks performed by the operating system comprise, for example, assigning memory to the modules, for example, 1101b, 1101c, 1101d, 1101e, 1101f, 1101g, 1101h, 1101i, 1101j, 1101k, 1101l, 1101m, etc., of the therapy management application 1101, and to data used by the therapy management application 1101, moving data between the memory unit 1202 and disk units, and handling input/output operations. The operating system performs the tasks on request by the operations and after performing the tasks, the operating system transfers the execution control back to the processor 1201. The processor 1201 continues the execution to obtain one or more outputs. The outputs of the execution of the modules, for example, 1101b, 1101c, 1101d, 1101e, 1101f, 1101g, 1101h, 1101i, 1101j, 1101k, 1101l, 1101m, etc., of the therapy management application 1101 are displayed to the therapist 1102 on the display unit 1206.

For purposes of illustration, the detailed description refers to the therapy management application 1101 being run locally on a computer system 1200; however the scope of the computer implemented method and system 1100 disclosed herein is not limited to the therapy management application 1101 being run locally on the computer system 1200 via the operating system and the processor 1201, but may be extended to run remotely over the network 1104 by employing a web browser and a remote server, a mobile phone, or other electronic devices.

Disclosed herein is also a computer program product comprising a non-transitory computer readable storage medium that stores computer program codes comprising instructions executable by at least one processor 1201 for managing and tracking therapy sessions. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 1201, except for a transitory, propagating signal.

The computer program codes comprise a first computer program code for scheduling therapy sessions with multiple clients; a second computer program code for generating one or more goals for each of the clients based on an evaluation of each of the clients in the scheduled therapy sessions; a third computer program code for categorizing the generated goals for each of the clients into one or more of multiple goal categories; a fourth computer program code for defining one or more goal measurements for each of the generated goals within each of the goal categories; a fifth computer program code for collecting and tracking data acquired from the scheduled therapy sessions of each of the clients for each of the defined goal measurements via the GUI 1101a; a sixth computer program code for generating progress reports based on performance of each of the clients for each of the generated goals using the collected and tracked data; and a seventh computer program code for selectively sharing and transferring one or more of profile information of one or more clients, the generated goals of those clients, the collected and tracked data acquired from the scheduled therapy sessions of those clients for each of the defined goal measurements, and the generated progress reports of one or more of the clients for each of the generated goals among one or more evaluators 1102 via the network 1104. The computer program product disclosed herein further comprises one or more additional computer program codes for performing additional steps that may be required and contemplated for managing and tracking therapy sessions. In an embodiment, a single piece of computer program code comprising computer executable instructions performs one or more steps of the computer implemented method disclosed herein for generating managing and tracking therapy sessions.

The computer program codes comprising computer executable instructions are embodied on the non-transitory computer readable storage medium. The processor 1201 of the computer system 1200 retrieves these computer executable instructions and executes them. When the computer executable instructions are executed by the processor 1201, the computer executable instructions cause the processor 1201 to perform the steps of the computer implemented method for managing and tracking therapy sessions.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises one or more computer program codes for implementing the processes of various embodiments.

Where databases are described such as the secure database network 1105, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, processors of Apple Inc., etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for tracking and managing therapy sessions, comprising:
providing a therapy management application executable by at least one processor configured to track and manage said therapy sessions, wherein said therapy management application is accessible by an electronic device in a plurality of access modes;
scheduling said therapy sessions with a plurality of clients by said therapy management application;
generating one or more goals for each of said clients by said therapy management application based on an evaluation of said each of said clients in said scheduled therapy sessions;
categorizing said generated one or more goals for said each of said clients into one or more of a plurality of goal categories by said therapy management application;
defining one or more goal measurements for each of said generated one or more goals within each of said one or more of said goal categories by said therapy management application;
collecting and tracking data acquired from said scheduled therapy sessions of said each of said clients for each of said defined one or more goal measurements by said therapy management application via a graphical user interface provided by said therapy management application; and
generating progress reports based on performance of said each of said clients for said each of said generated one or more goals by said therapy management application using said collected and tracked data.

2. The computer implemented method of claim 1, further comprising selectively sharing profile information of one or more of said clients, said generated one or more goals of each of said one or more of said clients, said collected and tracked data acquired from said scheduled therapy sessions of said each of said one or more of said clients for said each of said defined one or more goal measurements, and said generated progress reports of said each of said one or more of said clients among evaluators by said therapy management application.

3. The computer implemented method of claim 1, further comprising securely transferring one or more of profile information of one or more of said clients, said generated one or more goals of each of said one or more of said clients, said collected and tracked data acquired from said scheduled therapy sessions of said each of said one or more of said clients for said each of said defined one or more goal measurements, and said generated progress reports of said each of said one or more of said clients for each of said generated one or more goals to one or more evaluators by said therapy management application via a network for subsequent said evaluation of said one or more of said clients based on transfer criteria.

4. The computer implemented method of claim 1, wherein said therapy management application is configured to define said goal categories based on goals in a field of therapy.

5. The computer implemented method of claim 1, further comprising defining a plurality of performance indicators by said therapy management application for tracking said performance of said each of said clients for said each of said generated one or more goals.

6. The computer implemented method of claim 1, further comprising providing one or more customization interfaces by said therapy management application, wherein said one or more customization interfaces are configured to acquire inputs for one or more of addition of one or more goal categories, addition of one or more goal measurements within said one or more goal categories, customization of one or more performance indicators, and said collection of said data associated with said scheduled therapy sessions.

7. The computer implemented method of claim 1, further comprising registering an evaluator via said graphical user interface of said therapy management application.

8. The computer implemented method of claim 1, further comprising providing a database network in communication with said therapy management application, wherein said database network is configured to store and dynamically update said data acquired from said scheduled therapy sessions and said generated progress reports of said each of said clients for said each of said generated one or more goals based on a preconfigured time interval.

9. The computer implemented method of claim 1, further comprising restoring said data acquired from said scheduled therapy sessions of said each of said clients for a preconfigured time interval by said therapy management application, on receiving an indication from an evaluator via said graphical user interface.

10. The computer implemented method of claim 1, wherein said therapy management application is configured to generate said progress reports in one or more of a plurality of graphical representations based on time criteria.

11. The computer implemented method of claim 1, further comprising controlling access to said collected and tracked data acquired from said scheduled therapy sessions of said each of said clients for said each of said defined one or more goal measurements by said therapy management application.

12. The computer implemented method of claim 1, wherein said access modes for accessing said therapy management application comprise a wireless access mode, a wired access mode, an online access mode, and an offline access mode.

13. The computer implemented method of claim 1, further comprising automatically synchronizing said collected and tracked data acquired from said scheduled therapy sessions of said each of said clients for said each of said defined one or more goal measurements in an offline access mode, with said collected and tracked data acquired from said scheduled therapy sessions of said each of said clients for said each of said defined one or more goal measurements in an online access mode by said therapy management application.

14. A computer implemented system for tracking and managing therapy sessions, comprising:
at least one processor;
a non-transitory computer readable storage medium communicatively coupled to said at least one processor, said non-transitory computer readable storage medium configured to store modules of a therapy management application, said at least one processor configured to execute said modules of said therapy management application;
said therapy management application accessible by an electronic device in a plurality of access modes, wherein said modules of said therapy management application comprise:
a scheduling engine configured to schedule said therapy sessions with a plurality of clients;
a goal generation module configured to generate one or more goals for each of said clients based on an evaluation of said each of said clients in said scheduled therapy sessions;
a categorization module configured to categorize said generated one or more goals for said each of said clients into one or more of a plurality of goal categories;
a goal measurement definition module configured to define one or more goal measurements for each of said generated one or more goals within each of said one or more of said goal categories;
a data collection and tracking module configured to collect and track data acquired from said scheduled therapy sessions of said each of said clients for each of said defined one or more goal measurements via a graphical user interface provided by said therapy management application; and
a report generation module configured to generate progress reports based on performance of said each of said clients for said each of said generated one or more goals using said collected and tracked data.

15. The computer implemented system of claim 14, wherein said modules of said therapy management application further comprise a share and transfer module configured to selectively share and transfer one or more of profile information of one or more of said clients, said generated one or more goals of each of said one or more of said clients, said collected and tracked data acquired from said scheduled therapy sessions of said each of said one or more of said clients for said each of said defined one or more goal measurements, and said generated progress reports of said each of said one or more of said clients for said each of said generated one or more goals among one or more evaluators via a network.

16. The computer implemented system of claim 14, wherein said categorization module is configured to define said goal categories based on goals in a field of therapy.

17. The computer implemented system of claim 14, wherein said modules of said therapy management application further comprise a performance indicator definition module configured to define a plurality of performance indicators for tracking said performance of said each of said clients for said each of said generated one or more goals.

18. The computer implemented system of claim 14, wherein said graphical user interface of said therapy management application comprises one or more customization interfaces configured to acquire inputs for one or more of addition of one or more goal categories, addition of one or more goal measurements within said one or more goal categories, customization of one or more performance indicators, and said collection of said data associated with said scheduled therapy sessions.

19. The computer implemented system of claim 14, wherein said modules of said therapy management application further comprise a registration module configured to register an evaluator via said graphical user interface.

20. The computer implemented system of claim 14, further comprising a database network in communication with said therapy management application, wherein said database network is configured to store and dynamically update said data acquired from said scheduled therapy sessions and said generated progress reports of said each of said clients for said each of said generated one or more goals based on a preconfigured time interval.

21. The computer implemented system of claim 14, wherein said modules of said therapy management application further comprise a restoration module configured to restore said data acquired from said scheduled therapy sessions of said each of said clients for a preconfigured time interval, on receiving an indication from an evaluator via said graphical user interface.

22. The computer implemented system of claim 14, wherein said report generation module is configured to generate said progress reports in one or more of a plurality of graphical representations based on time criteria.

23. The computer implemented system of claim 14, wherein said data collection and tracking module is configured to control access to said collected and tracked data acquired from said scheduled therapy sessions of said each of said clients for said each of said defined one or more goal measurements.

24. The computer implemented system of claim 14, wherein said modules of said therapy management application further comprise a synchronization module configured to automatically synchronize said collected and tracked data acquired from said scheduled therapy sessions of said each of said clients for said each of said defined one or more goal measurements in an offline access mode, with said collected and tracked data acquired from said scheduled therapy sessions of said each of said clients for said each of said defined one or more goal measurements in an online access mode.

25. A computer program product comprising a non-transitory computer readable storage medium, said non-transitory computer readable storage medium storing computer program codes comprising instructions executable by at least one processor, said computer program codes comprising:
a first computer program code for scheduling therapy sessions with a plurality of clients;
a second computer program code for generating one or more goals for each of said clients based on an evaluation of said each of said clients in said scheduled therapy sessions;
a third computer program code for categorizing said generated one or more goals for said each of said clients into one or more of a plurality of goal categories;
a fourth computer program code for defining one or more goal measurements for each of said generated one or more goals within each of said one or more of said goal categories;
a fifth computer program code for collecting and tracking data acquired from said scheduled therapy sessions of said each of said clients for each of said defined one or more goal measurements via a graphical user interface;
a sixth computer program code for generating progress reports based on performance of said each of said clients for said each of said generated one or more goals using said collected and tracked data; and
a seventh computer program code for selectively sharing and transferring one or more of profile information of one or more of said clients, said generated one or more goals of each of said one or more of said clients, said collected and tracked data acquired from said scheduled therapy sessions of said each of said one or more of said clients for said each of said defined one or more goal measurements, and said generated progress reports of said each of said one or more of said clients for said each of said generated one or more goals among one or more evaluators via a network.
